(19) United States
(12) Patent Application Publication
(10) Pub. No.: US 2026/0031875 A1
(43) Pub. Date: Jan. 29, 2026

(54) UE-INITIATED EARLY TRIGGERING FOR CSI ACQUISITION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/256,038

(22) Filed: Jun. 30, 2025

Related U.S. Application Data
(60) Provisional application No. 63/674,606, filed on Jul. 23, 2024.
(60) Provisional application No. 63/674,656, filed on Jul. 23, 2024.

(51) Int. Cl. H04B 7/06; H04W 72/21; H04W 74/0833

(52) U.S. Cl. CPC H04B 7/0626; H04W 72/21; H04W 74/0833

(57) ABSTRACT

Methods and apparatuses for user equipment (UE)-initiated early triggering of channel state information (CSI) acquisition. A method performed by a UE includes receiving, in a system information block (SIB), a first uplink (UL) channel resource configuration and a channel state information (CSI) report configuration for early CSI acquisition and determining, from the first UL channel resource configuration, a first UL channel resource associated with the CSI report configuration. The method further includes transmitting, in a first UL channel based on the first UL channel resource, a first indicator and receiving, in a first downlink (DL) channel, a second indicator indicating the CSI report configuration. The method further includes determining a second UL channel resource based on the CSI report configuration and transmitting, in a second UL channel based on the second UL channel resource, a CSI report.

### CROSS-REFERENCE TO RELATED AND CLAIM OF PRIORITY

The present application claims priority under 35 U.S.C. § 119(e) to U.S. Provisional Patent Application No. 63/674,606 filed on Jul. 23, 2024 and U.S. Provisional Patent Application No. 63/674,656 filed on Jul. 23, 2024, which are hereby incorporated by reference in their entirety.

### TECHNICAL FIELD

The present disclosure relates generally to wireless communication systems and, more specifically, the present disclosure relates to methods and apparatuses for user equipment (UE)-initiated early triggering for channel state information (CSI) acquisition.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated early triggering for CSI acquisition.

In one embodiment, a user equipment (UE) is provided. The UE includes a transceiver configured to receive, in a system information block (SIB), a first uplink (UL) channel resource configuration and a channel state information (CSI) report configuration for early CSI acquisition and a processor operably coupled with the transceiver. The processor configured to determine, from the first UL channel resource configuration, a first UL channel resource associated with the CSI report configuration. The transceiver is further configured to transmit, in a first UL channel based on the first UL channel resource, a first indicator; and receive, in a first downlink (DL) channel, a second indicator indicating the CSI report configuration. The processor is further configured to determine a second UL channel resource based on the CSI report configuration. The transceiver is further configured to transmit, in a second UL channel based on the second UL channel resource, a CSI report.

In another embodiment, a base station (BS) is provided. The BS includes a transceiver configured to transmit, in a SIB, a first UL channel resource configuration and a CSI report configuration for early CSI acquisition and a processor operably coupled with the transceiver. The processor is configured to determine, based on the first UL channel resource configuration, a first UL channel resource associated with the CSI report configuration. The transceiver is further configured to receive, in a first UL channel based on the first UL channel resource, a first indicator and transmit, in a first DL channel, a second indicator indicating the CSI report configuration. The processor is further configured to determine a second UL channel resource based on the CSI report configuration. The transceiver is further configured to receive, in a second UL channel based on the second UL channel resource, a CSI report.

In yet another embodiment, a method performed by a UE is provided. The method includes receiving, in a SIB, a first UL channel resource configuration and a CSI report configuration for early CSI acquisition and determining, from the first UL channel resource configuration, a first UL channel resource associated with the CSI report configuration. The method further includes transmitting, in a first UL channel based on the first UL channel resource, a first indicator and receiving, in a first DL channel, a second indicator indicating the CSI report configuration. The method further includes determining a second UL channel resource based on the CSI report configuration and transmitting, in a second UL channel based on the second UL channel resource, a CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates a signal flow of an example procedure for early triggering of SRS transmission according to embodiments of the present disclosure;

FIGS. 11A and 11B illustrate signal flows of example procedures for first and second channels/signals according to embodiments of the present disclosure;

FIG. 12 illustrates a signal flow of an example procedure for early triggering of SRS transmission according to embodiments of the present disclosure;

FIG. 13 illustrates a signal flow of an example procedure for early triggering of SRS transmission according to embodiments of the present disclosure;

FIG. 14 illustrates a signal flow of an example procedure for early triggering of channel state information (CSI) measurement and reporting according to embodiments of the present disclosure;

FIG. 15 illustrates a signal flow of an example procedure for early triggering of CSI measurement and reporting according to embodiments of the present disclosure;

FIG. 16 illustrates a signal flow of an example procedure for early triggering of CSI measurement and reporting according to embodiments of the present disclosure; and

FIG. 17 illustrates an example method performed by a UE in a wireless communication system according to embodiments of the present disclosure.

### DETAILED DESCRIPTION

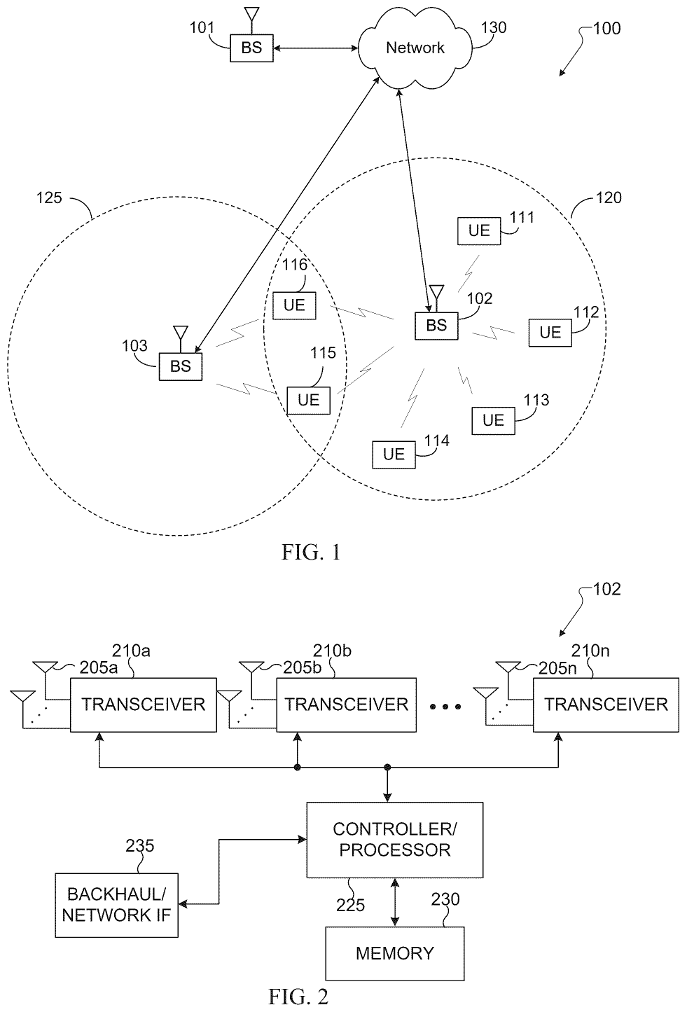

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UE-initiated early triggering for CSI acquisition. In certain embodiments, one or more of the gNBs 101-103 include circuitry, programing, or a combination thereof to support UE-initiated early triggering for CSI acquisition.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UE-initiated early triggering for CSI acquisition. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

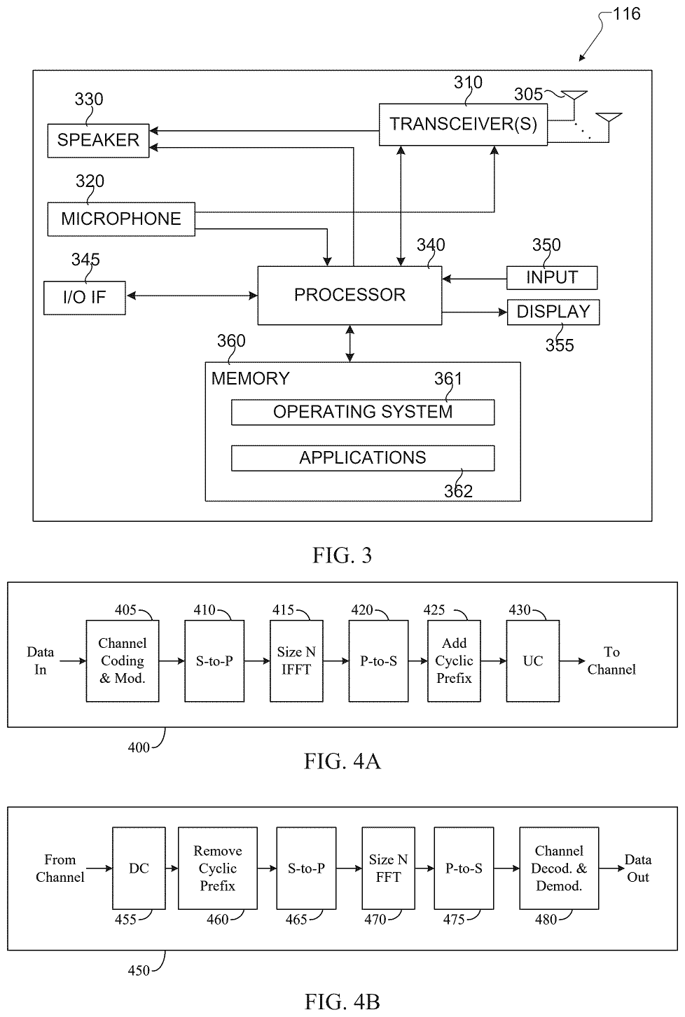

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify UE-initiated early triggering for CSI acquisition as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to perform actions for UE-initiated early triggering for CSI acquisition as described in embodiments of the present disclosure. In some embodiments, the receive path 450 is configured to perform actions for UE-initiated early triggering for CSI acquisition as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

The TCI state and/or the spatial relation reference RS can determine a spatial Rx filter for reception of downlink channels at the UE, or a spatial TX filter for transmission of uplink channels from the UE.

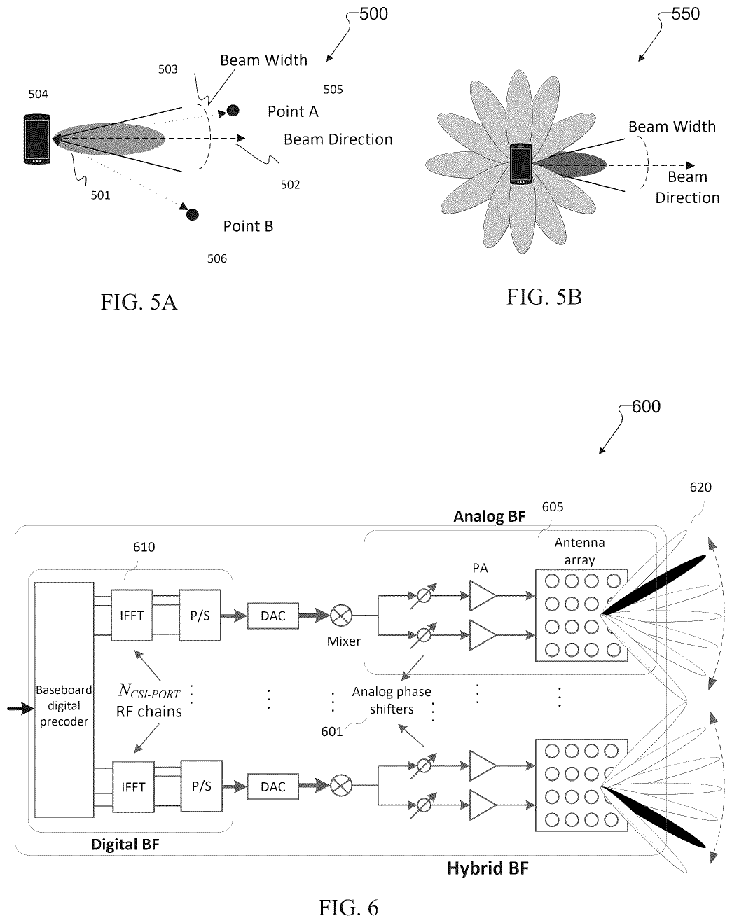

As illustrated in FIG. 5A, in a wireless system 500, a beam 501 for a device 504 can be characterized by abeam direction 502 and abeam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [[REF 4]—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE (e.g., the UE 116) is indicated a TCI state by MAC CE when the CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

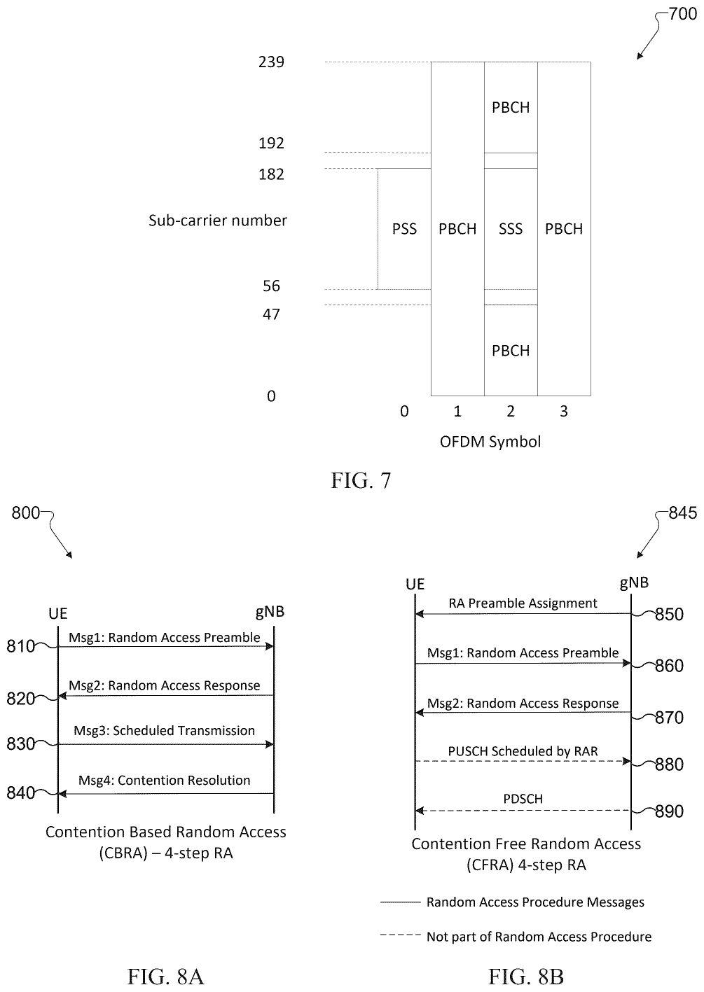

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). With reference to FIG. 7, a primary synchronization signal (PSS)/secondary synchronization signal (SSS)/PBCH block (SS/PBCH block) is referred to as SSB and includes 4 consecutive symbols, and 20 physical resource blocks (240 subcarriers), as illustrated in FIG. 7.

SSBs are organized in groups (or bursts) of up to N SSBs, transmitted within half a frame (5 ms), each SSB within the group has an index i, where i=0, 1, . . . , N−1, within each group of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz, and 120 kHz with unrestricted sets.
Sequence length 571 used with sub-carrier spacing 30 kHz with unrestricted sets.
Sequence length 1151 used with sub-carrier spacing 15 kHz with unrestricted sets.

Random access channel (RACH) preambles are transmitted in time-frequency resources PRACH Occasions (ROs). Each RO determines the time and frequency resources in which a preamble is transmitted, the resources allocated to an RO in the frequency domain (e.g., number of physical resource blocks (PRBs)) and the resource allocated to an RO in the time domain (e.g., number of OFDMA symbols or number of slots), depend on the preamble sequence length, sub-carrier spacing of the preamble, sub-carrier spacing of the PUSCH in the UL bandwidth part (BWP), and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1]v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [[REF 3]v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

With reference to FIG. 8, Type-1 random access procedure also known as four-step random access procedure (4-step RACH) is shown;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

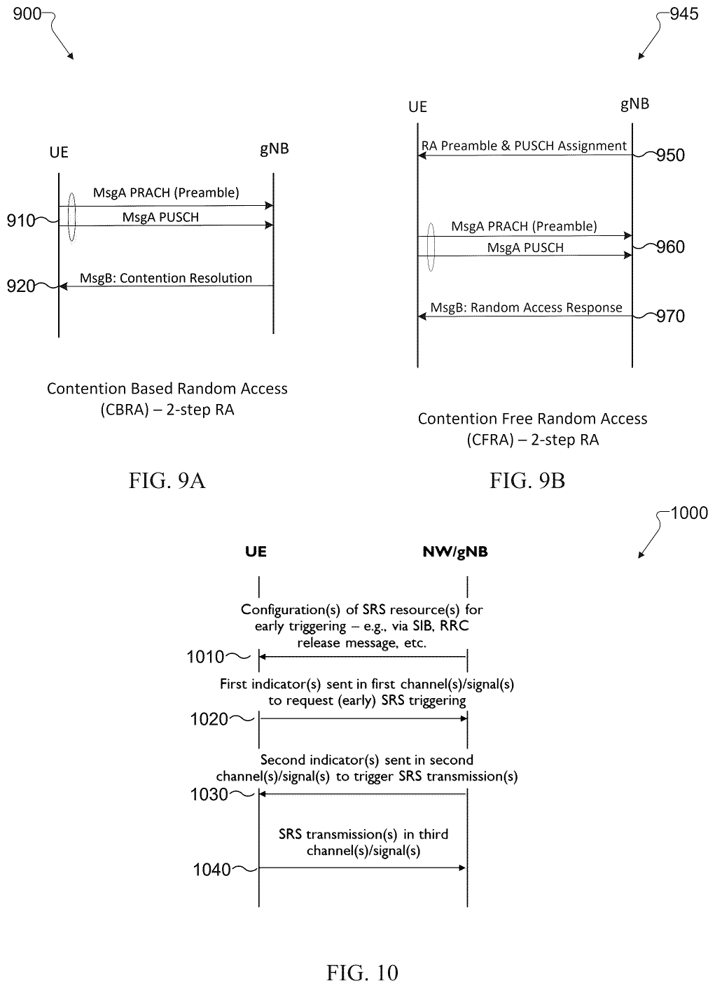

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16 introduced a new random access procedure; Type-2 random access procedure, also known as 2-step random access procedure (2-step RACH), with reference to FIG. 9, that combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC_IDLE state. During this procedure, a UE (e.g., the UE 116) identifies an SS/PBCH block with index i and with an reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding random access radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a cell RNTI (C-RNTI), the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Channel state information reference signal is a downlink reference signal that is used for obtaining the downlink channel condition between the gNB (e.g., the BS 102) and the UE. CSI-RS can be transmitted independent of data transmissions on the downlink. The CSI-RS usage can be CSI-RS of beam management, CSI-RS for tracking, CSI-RS for CSI and etc.

In NR, CSI-RS resources including SSB(s) and/or nonzero power (NZP) CSI-RS resource(s) are configured by the network for example as part of RRC setup or RRC reconfiguration. CSI-RS resources are configured in a CSI resource set provided/configured in a CSI resource setting, which could also be linked/associated/specific to a CSI reporting setting. The configuration of the CSI-RS resource includes at least the following: (1) information related to the time-frequency resource mapping of the CSI-RS resource, (2) information related to resource type of the CSI-RS resource including ‘periodic’, ‘aperiodic’, and ‘semi-persistent’, (3) information related to usage of the CSI-RS resource (e.g., for beam management, tracking, CSI and etc.), (4) information related to transmit power control parameter(s)/setting(s), (5) scrambling ID, and (7) information related to the TCI state.

Sounding reference signal is an uplink reference signal that is used for sounding (i.e., channel quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR, SRS resources are configured by the network for example, as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic, (2) usage, which can be one of: beamManagement, codebook, nonCodebook or antennaSwitching, and (3) information related to power control and TCI state.

The configuration of the SRS resource includes the following: (1) information related to the transmission comb, including comb size, comb offset and cyclic shift, (2) information related to domain resource mapping including starting symbol within a slot, number of SRS symbols and repetition factor, (3) information related to frequency domain including freqDomainPosition N_RRC, freqDomainShift n_shift, and frequency hopping parameters c-SRS, b-SRS, and b-hop, (4) information related to group or sequence hopping, whether one of them or neither is enabled, (5) for periodic and semi-persistent SRS, the periodicity and offset of the SRS resource, (6) sequence ID, and (7) information related to the TCI state or spatial relation info.

In 5G NR, a UE can transmit a sounding reference signal (SRS). A SRS resource is configured by higher layer IE SRS-Resource.

The SRS sequence is a low peak-to-average power ratio (PAPR) sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC}$$

where

$${M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}∈{2,4,8}. l′ is the SRS symbol within a SRS resource of a slot,

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and {n}_{SRS}^{cs , i} = ( {n}_{SRS}^{cs} + \frac{{n}_{SRS}^{cs , max} ( {p}_{i} - 1000 )}{{n}_{ap}^{SRS}} ) mod {n}_{SRS}^{cs , max}$$

with

$${n}_{SRS}^{cs}$$

being provided by higher layer in IE transmissionComb,

$${n}_{SRS}^{cs , max}$$

depends on K_{TC} as illustrated in Table 1.

TABLE 1

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and ∈{0}, if 60<N_{ZC}. The base sequence, r̅_{u,v}(n), is generated as follows:
1. For N_{ZC}∈{6,12,18,24}, r̅_{u,v}(n)=e^{jϕ(u)π/4}, with 0≤n<M_{ZC}−1. ϕ(n) is given by Tables 5.2.2.2-1 to 5.2.2.2-4 of [REF 1].
2. For

$${N}_{ZC} = 30 , {\overline{r}}_{u , v} ( n ) = {e}^{- j \frac{π ( u + 1 ) ( n + 1 ) ( n + 2 )}{31}} ,$$

with 0≤n<M_{ZC}−1.
3. For

$${N}_{ZC} \geq 30 , {\overline{r}}_{u , v} ( n ) = {x}_{q} ( n mod {N}_{ZC} ) , {x}_{q} ( n ) = {e}^{- j \frac{π qm ( m + 1 )}{{N}_{ZC}}} .$$

N_{ZC} is the largest prime number less than

$${M}_{ZC} . q = ⌊ \overline{q} + 1 / 2 ⌋ + v \cdot {( - 1 )}^{⌊ 2 \overline{q} ⌋} . \overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 , {N}_{symb}^{slot}$$

is the number of symbols in a slots, l₀ is the first SRS symbols in the slot, and c(n) a length-31 Gold sequence defined asc(n)=(x₁(n+N_{c})+x₂(n+N_{c}))mod 2, with N_{c}=1600, x₁(n+31)=(x₁(n+3)+x₁(n))mod 2, x₁(n+31)=(x₂(n+3)+x₂(n+2)+x₂(n+1)+x₂(n))mod 2, the first m-sequence is initialized with x₁(0)=1, and x₂(n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{μ} , {l}^{′} ) = 0 and v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix} {N}_{symb}^{slot}$$

is the number of symbols in a slots, l₀ is the first SRS symbols in the slot, and c(n) a length-31 Gold sequence as previously defined.

The SRS sequence, r^{(p)}(n,l′), is mapped to resource elements

$${a}_{k , l}^{( p )}$$

within a slot, where k is the sub-carrier frequency, l is the symbol number within the slot and p is the antenna port, where for SRS there is one antenna port, by

$${a}_{k , l}^{( p )} = {β}_{SRS} {r}^{( p )} ( {k}^{′} , {l}^{′} )$$

$$l = {l}^{′} + {l}_{0}$$

Where,
β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} ,$$

m_{SRS,b} is provided by Table 6.4.14.3-1 of [REF 1], and

$${l}^{′} = 0 , 1 , … , {N}_{symb}^{SRS} - 1.$$

l=l′+l₀, with l₀ the first SRS symbols in the slot, where l₀∈{0,1, . . . , 13}.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} ,$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC} ,$$

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ \frac{{n}_{SRS}^{cs , max}}{2} , … , {n}_{SRS}^{cs , max} - 1 \} \\ and {N}_{ap}^{SRS} = 4 and {p}_{i} ∈ \{ 1001 , 1003 \}\end{matrix} \\ {\overline{k}}_{TC} & otherwise\end{matrix}$$

k̅_{TC} is the transmission comb offset included within higher layer IE transmissionComb, with k̅_{TC}∈{0,1, . . . , K_{TC}−1},

$${k}_{offset}^{{l}^{′}}$$

is a symbol dependent sub-carrier offset given by Table 3, n_{shift} is given by higher layer parameter freqDomainShift and it adjust the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of [REF 1] with b=B_{SRS} and the configured value of C_{SRS}.

TABLE 2

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | | 0, 4, 2, 6 | 0, 4, 2, 6, 1, 5, 3, 7 | 0, 4, 2, 6, 1, 5, 3, 7, 0, 4, 2, 6 |

In NR paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a temporary mobile subscriber identity (TMSI) or an information RNTI (I-RNTI). The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-MessageType |

}

| | |
|---|---|
| PCCH-MessageType ::= | CHOICE { |
| c1 | CHOICE { |
| paging | Paging, |

```
    spare1 NULL
  },
```

| | |
|---|---|
| messageClassExtension | SEQUENCE { } |

}

| Paging ::= | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| | |
|---|---|
| PagingRecordList ::= | SEQUENCE (SIZE(1..maxNrofPageRec)) OF PagingRecord |
| PagingRecord ::= | SEQUENCE { |
| ue-Identity | PagingUE-Identity, |
| accessType | ENUMERATED {non3GPP} OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can include multiple time slots where paging DCI can be sent. A Paging Frame (PF) is one Radio Frame and may contain one or multiple PO(s) or starting point of a PO.

The PF and PO for paging are determined by the following equations:
single frequency network (SFN) of the PF is determined by: (SFN+PF_offset)mod T=(T div N)*(UE_ID mod N)
The index i_s of the PO is determined by: i_s=floor(UE_ID/N)mod Ns

### Where,

T is the DRX cycle of the UE, determined by the shortest of the UE specific DRX value(s) and a default DRX value included in SIB1. (1) For core network (CN)-initiated paging, a default cycle is broadcast in system information. (2) For CN-initiated paging, a UE specific cycle can be configured via non access stratum (NAS) signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE_ID: 5G-S-TMSI mod 1024

To minimize the probability of paging false alarms, which occur when a UE decodes the PCH due to another UE assigned to the same PO being paged, UEs assigned to the same PO are divided into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and tracking reference signal (TRS) availability indication for one or more UEs. DCI Format 2_7 has a CRC scrambled by PEI_RNTI. DCI Format 2_7 includes: (1) a paging indication field of size

$${N}_{PO}^{PEI} \cdot {N}_{SG}^{PO} , where , {N}_{PO}^{PEI}$$

is the number of paging occasions configured by higher layer parameter po-NumPerPEI, and

$${N}_{SG}^{PO}$$

is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of the indBitID(s) provided by the trs-ResourceSetConfig if configured; 0 bits otherwise. Each TRS resource set is configured with an ID i for the association with (i+1)-th indication bit.

This disclosure provides early triggering of CSI measurement/reporting and/or SRS for UEs in RRC_IDLE or RRC_INACTIVE states when the network (e.g., the network 130) has data to send to the UE or the UE has data to send to network. Early CSI measurement/reporting and/or early SRS transmission can assist in determining the channel conditions and better link adaptation and better precoding for downlink and uplink transmissions. Embodiments of the present disclosure recognize that means of providing configuration(s) of CSI-RS resource(s) for early triggering of CSI measurement/reporting, means of providing configuration(s) of SRS resource(s) for early triggering of SRS transmission, signaling medium(s)/container(s) to carry the configuration(s) and the corresponding UE's behaviors/assumptions are needed.

When a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger CSI measurement/reporting and/or trigger SRS transmission from the UE for channel quality estimation and the UE can start transmitting and receiving data. For instance, in terms of uplink channel estimation/acquisition, the SRS triggered can be wideband SRS or sub-band SRS, which would require several SRS transmission instances to provide an estimate of the channel quality of the full bandwidth. This process, i.e., the estimation of the channel quality, can take tens of milliseconds, and even longer with sub-band SRS. Data transmission/reception can be delayed until the channel quality has been estimated using CSI-RS and/or SRS, hence increasing latency. Alternatively, data transmission/reception can proceed in parallel with the CSI measurement/reporting and/or SRS transmission, and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB for the UE.

To mitigate this issue, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. Hence, there is a benefit for performing CSI measurement/reporting and/or transmitting SRS in parallel with RRC setup procedure, or RRC reconfiguration procedure to reduce latency.

When the network initiates a communication session, the UE is first paged, and this is then followed by a random access (RA), or also referred to as RACH, procedure. When the UE initiates a communication session, a RACH procedure is used. The early triggered CSI measurement/reporting and/or early SRS triggering and/or transmission mentioned herein can occur during paging, and/or can be associated with the paging procedure. Alternatively, the early triggered CSI measurement/reporting and/or early SRS triggering and/or transmission mentioned herein can occur during a RACH procedure or can be associated with a RACH procedure. This disclosure discusses means of providing configuration(s) of CSI-RS resource(s) for early triggering of CSI measurement/reporting, means of providing configuration(s) of SRS resource(s) for early triggering of SRS transmission, signaling medium(s)/container(s) to carry the configuration(s) and the corresponding UE's behaviors/assumptions. This disclosure additionally presents UE-initiated early triggering(s) of SRS transmission(s) and/or CSI measurement/reporting, and the corresponding design procedure(s).

This disclosure covers various design examples, aspects and means of providing configuration(s) of SRS resource(s) for early triggering of SRS transmission, including
Signaling medium(s)/container(s) to carry the configuration(s), which includes SIB, RRC setup, RRC reconfiguration, RRC release message and/or etc.
Detailed configuration(s) and setting(s) for the SRS resource(s) for early SRS transmission triggering
Selection and indication of SRS resource configuration(s) by the UE for the early triggering of SRS transmission
Selection and indication of SRS resource configuration(s) by the network for the early triggering of SRS transmission

The corresponding/related design procedure(s), signaling flow(s)/method(s), UE's assumption(s)/behavior(s) and/or etc. herein are also presented in this disclosure.

Furthermore, this disclosure also presents detailed UE-initiated early triggering(s) of SRS transmission(s) and/or CSI measurement/reporting, wherein various design examples, aspects and means of providing configuration(s) of CSI-RS resource(s) for the early triggering of the CSI measurement/reporting are also provided in this disclosure, similar to those for the SRS resource(s) for the early triggering of the SRS transmission(s).

Throughout the present disclosure, aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings. Furthermore, both frequency division duplexing (FDD) and time division duplexing (TDD) are regarded as a duplex method for DL and UL signaling. Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM). This disclosure provides several components that can be used in conjunction or in combination with one another, or can operate as standalone schemes.

In the present disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE (e.g., the UE 116) or (3) UE-group RRC signaling. In addition, MAC CE signaling can be UE-specific e.g., to one UE and can be UE common (e.g., to a group of UEs). MAC CE signaling can be DL MAC CE signaling or UL MAC CE signaling. Furthermore, L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE and can be UE common (e.g., to a group of UEs).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used. A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-signal-to-interference-plus-noise ratio (SINR) accompanied by at least one CRI or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In the present disclosure, DCI Format is used for L1 control information in the DL direction from gNB (e.g., the BS 102) to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). Furthermore, a higher layer message (e.g., SIB-based or RRC-based or MAC CE-based) can be carried by a physical downlink shared channel (PDSCH). In one example, the PDSCH can be scheduled by a DCI format.

In the present disclosure, the configuration(s) of SRS resource(s) may include, contain or comprise at least one or more of the following parameters/settings/components:
SRS resource ID/index, SRS resource set ID/index, SRS resource configuration/setting ID/index.
Resource type and corresponding parameter(s) for the corresponding SRS resource(s) including ‘aperiodic’, ‘periodic’, and/or ‘semi-persistent’; the parameter(s) corresponding to the resource type of ‘aperiodic’ could also comprise or include or contain an aperiodic SRS resource trigger state list provided by aperiodicSRS-ResourceTrigger or aperiodicSRS-ResourceTriggerList.
Usage for the corresponding SRS resource(s) including ‘beamManagement’, ‘codebook’, ‘nonCodebook’ and/or ‘antennaSwitching’.
Time and frequency resources (e.g., symbols within a slot for SRS, starting symbol for SRS, time slot for SRS, periodicity and offset of SRS (e.g., in case of periodic or semi-persistent SRS), starting PRB for SRS, number of PRBs for SRS, whether frequency hopping is enabled and if enabled frequency hopping pattern, etc.).
Number of instances, K, of SRS transmitted when SRS is triggered.
Comb size, comb offset and cycle shift.
Sequence for generating the corresponding reference signal.
Transmit power control parameter(s)/setting(s) for the corresponding reference signal.
TCI state(s) and/or reference signal(s) used for determining the spatial filter(s) for transmitting the corresponding SRS(s).

In particular, a UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, the configuration(s) of the SRS resource(s) for the early triggering of the SRS transmission(s). For instance, the UE could be provided by the network via/in a higher layer parameter EarlySRS-Config providing or configuring or indicating
At least one or more of the parameters/settings/components mentioned herein for the configuration(s) of the corresponding SRS resource(s)
At least one or more of parameters/settings/components provided or configured by/in higher layer parameter(s) including at least SRS-Config, SRS-ResourceSet, SRS-Resource, and/or etc. for the corresponding SRS resource(s) defined/specified in [REF 6] for 5G NR.

In one example, the UE could be provided or configured by the network, in system information block including SIB1, SIB2 and/or other SIBs, the discussed/specified SRS resource configuration(s) herein for early triggering of the SRS transmission (e.g., provided by EarlySRS-Config). Examples of providing or configuring the EarlySRS-Config as defined/specified herein in the higher layer parameters SIB1 and SIB2 are respectively presented herein.

| SIB1 ::= | SEQUENCE { |
|---|---|
| ..., | |
| earlySrs-Config | SetupRelease {EarlySRS-Config} |

OPTIONAL, -- Need M
...
}

| SIB2 ::= | SEQUENCE { |
|---|---|
| ..., | |
| earlySrs-Config | SetupRelease {EarlySRS-Config} |

OPTIONAL, -- Need M
...
}

In one example, the UE could be provided or configured by the network, in RRC release message, the discussed/specified SRS resource configuration(s) herein for early triggering of the SRS transmission (e.g., provided by EarlySRS-Config). One of providing or configuring the EarlySRS-Config as defined/specified herein in the higher layer parameters RRCRelease-IEs is presented herein.

| RRCRelease-IEs ::= | SEQUENCE { | |
|---|---|---|
| redirectedCarrierInfo | RedirectedCarrierInfo | OPTIONAL, |

-- Need N,

| | |
|---|---|
| cellReselectionPriorities | CellReselectionPriorities |

OPTIONAL, -- Need R,

| | | |
|---|---|---|
| suspendConfig | SuspendConfig | OPTIONAL, -- Need R, |

...,

| | |
|---|---|
| earlySrs-Config | SetupRelease {EarlySRS-Config} |

OPTIONAL, -- Need M
...
}

According to those specified herein in the present disclosure, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, which RRC signaling(s)/parameter(s)—e.g., RRCRelease-IEs and/or SIB1 and/or SIB2 as specified/defined herein—to use/apply for determine the SRS resource configuration(s) for the early SRS transmission triggering(s). Furthermore, the SRS resource configuration(s) for the early triggering of the SRS transmission(s), e.g., provided by EarlySRS-Config, can be (configured to be) present or absent/not present in the corresponding RRC signaling(s)/parameter(s)—e.g., RRCRelease-IEs and/or SIB1 and/or SIB2 as specified/defined herein. When/if there are multiple or more than one RRC signalings/parameters, e.g., both SIB1 and RRCRelease-IEs, providing or configuring the SRS resource configurations for the early triggering, the UE could determine or identify which of the SRS resource configurations, provided/configured in the multiple RRC signalings/parameters as specified/defined herein in the present disclosure, to use/apply for the early SRS transmission triggering(s), according to or based on
Fixed rule(s) in system specification(s) and/or per RRC (re-)configuration/setup: for example, the UE could determine or identify the SRS resource configuration(s), e.g., EarlySRS-Config, provided/configured in SIB1 to use/apply for the early SRS transmission triggering(s); for another example, the UE could determine or identify the SRS resource configuration(s), e.g., EarlySRS-Config, provided/configured in SIB1 to use/apply for the early SRS transmission triggering(s); for another example, the UE could determine or identify the SRS resource configuration(s), e.g., EarlySRS-Config, provided/configured in the higher layer parameter(s)/signaling(s) that is provided/received the latest (or earlies) in time to use/apply for the early SRS transmission triggering(s); for another example, association(s)/mapping(s) between one or more of the higher layer signalings/parameters that provide or configure the SRS resource configurations for early triggering of the SRS transmission and one or more of signaling mediums/containers that could carry or provide actual indicator(s) to trigger the early SRS transmission(s) according to or following those specified/described herein in the present disclosure could be fixed in system specification(s) and/or per RRC (re-)configuration/setup; for this design example, when/if the UE has received an indicator to trigger the early SRS transmission(s) as specified/defined herein in the present disclosure, the UE could then determine or identify the SRS resource configuration for the early SRS transmission triggering based on or according to the association/mapping relationship between the higher layer parameter/signaling that provides/configures the SRS resource configuration and the signaling medium/container that carries or provides or indicates the indicator; for another example, the UE could determine or identify the SRS resource configuration(s) for the early triggering of the SRS transmission(s) according to or based on priority orders of the higher layer parameters/signalings that provide or configure the SRS resource configurations for early SRS transmission triggering(s) from high to low (or from low to high), wherein the priority orders could be fixed in system specification(s) and/or per RRC (re-)configuration/setup.
Network's configuration(s)/indication(s), e.g., via/by higher layer RRC signaling(s)/parameter(s) and/or MAC CE command(s) and/or dynamic DCI based L1 signaling(s) based on or according to a corresponding UE's capability or capability signaling: for example, the network's configuration(s)/indication(s) can be in form of a bitmap with each entry/bit position of the bitmap corresponding/specific to a higher layer parameter/signaling that provides the SRS resource configuration(s) for the early triggering; for this design example, when/if an entry/bit position of the bitmap is set to ‘1’ (or ‘0’), the higher layer parameter/signaling that is corresponding/specific to the entry/bit position is enabled for providing or configuring the SRS resource configuration for the early triggering of the SRS transmission(s); for another example, the network's configuration(s)/indication(s) can be in form of one-bit flag indicator(s), provided/configured in or associated/specific to the higher layer parameter(s)/signaling(s) that provides the SRS resource configuration(s) for the early triggering of the SRS transmission(s); for this design example, when/if an one-bit flag indicator, provided/configured in or associated/specific to a higher layer parameter/signaling that provides the SRS resource configuration(s) for the early triggering, is set to ‘1’ (or ‘0’) or ‘enabled’, the higher layer parameter/signaling is enabled for providing or configuring the SRS resource configuration for the early triggering of the SRS transmission(s); for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, association(s)/mapping(s) between one or more of the higher layer signalings/parameters that provide or configure the SRS resource configurations for early triggering of the SRS transmission and one or more of signaling mediums/containers that could carry or provide actual indicator(s) to trigger the early SRS transmission(s) according to or following those specified/described herein in the present disclosure; for this design example, when/if the UE has received an indicator to trigger the early SRS transmission(s) as specified/defined herein in the present disclosure, the UE could then determine or identify the SRS resource configuration for the early SRS transmission triggering based on or according to the association/mapping relationship between the higher layer parameter/signaling that provides/configures the SRS resource configuration and the signaling medium/container that carries or provides or indicates the indicator; for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, priority order(s) for the higher layer signalings/parameters that provide or indicate the SRS resource configurations for the early triggering of the SRS transmission(s); for this design example, the UE could determine or identify the SRS resource configuration(s) for the early triggering of the SRS transmission(s) according to or based on priority orders of the higher layer parameters/signalings that provide or configure the SRS resource configurations for early SRS transmission triggering(s) from high to low (or from low to high).

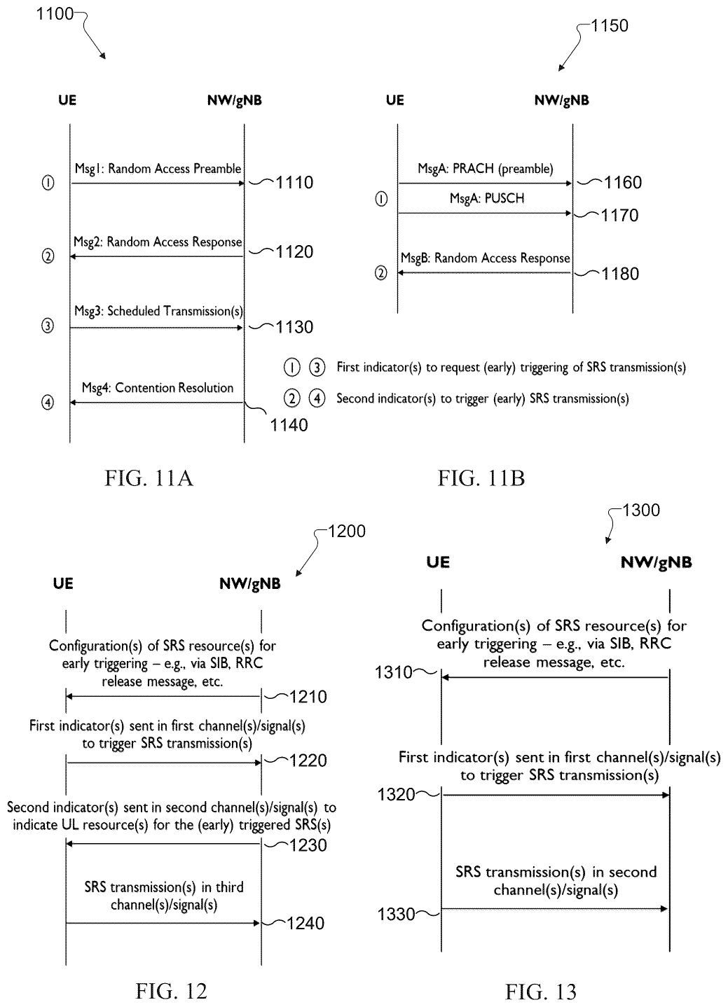

FIG. 10 illustrates a signal flow of an example procedure 1000 for early triggering of SRS transmission according to embodiments of the present disclosure. For example, procedure 1000 can be performed by the UE 116 and the gNB 102 and/or network 130 in the wireless network 100 of FIG. 1. This example is for illustration only and other embodiments can be used without departing from the scope of the present disclosure.

The procedure begins in 1010, a NW/gNB transmits configuration(s) of SRS resource(s) for early triggering to a UE, e.g., via SIB, RRC release message, etc. In 1020, the UE transmits first indicator(s) sent in first channel(s)/signal(s) to request (early) SRS triggering to the NW/gNB. In 1030, the NW/gNB transmits second indicator(s) sent in second channel(s)/signal(s) to the UE to trigger SRS transmission(s). In 1040, the UE transmits SRS transmission(s) in third channel(s)/signal(s) to the NW/gNB.

According to those specified herein in the present disclosure, a UE could be provided or configured or indicated by the network, e.g., via higher layer RRC signaling(s)/parameter(s)—e.g., via/by/in SIB1, SIB2, RRCRelease-IEs, and/or etc.—and/or MAC CE command(s) and/or dynamic DCI based L1 signaling(s) based on or according to a corresponding UE's capability or capability signaling, one or more SRS resource configurations (e.g., each provided by EarlySRS-Config) for the early triggering of the SRS transmission(s). For instance, a UE could be provided or configured by the network, e.g., via/by/in a/the same RRC signaling/parameter (e.g., SIB1, SIB2 or RRCRelease-IEs as specified/described herein in the present disclosure) and/or different or separate RRC signalings/parameters (e.g., via/by/in both SIB1 and RRCRelease-IEs), one or more (denoted by K_early≥1) SRS resource configurations for the early triggering of the SRS transmission(s)—each provided by EarlySRS-Config as defined herein in the present disclosure. Optionally, a UE could be provided or configured by the network, e.g., via/by/in a/the same RRC signaling/parameter (e.g., SIB1, SIB2 or RRCRelease-IEs as specified/described herein in the present disclosure) and/or different or separate RRC signalings/parameters (e.g., via/by/in both SIB1 and RRCRelease-IEs), multiple or more than one (denoted by K_early>1) SRS resource configurations for the early triggering of the SRS transmission(s)—each provided by EarlySRS-Config as defined herein in the present disclosure.

In one example (Mode-A), after a UE has received from the network the SRS resource configuration(s) for the early triggering of the SRS transmission(s) according to or following those specified herein in the present disclosure, the UE could send or indicate or transmit to the network, via/in/by one or more first channels/signals, a first indicator to request (early) triggering of SRS transmission(s). For this design example, the UE could expect to receive from the network, in/via/by one or more second triggering channels/signals, one or more second indicators to indicate and/or trigger and/or enable the (early) transmission(s) of the SRS(s). Upon detection and/or reception of the one or more second indicators, the UE could determine or identify, based on or according to the SRS resource configuration(s), the SRS(s) along with the corresponding parameter(s)/setting(s) to transmit. In this case, the UE could then transmit or send to the network, in/via/by one or more third channels/signals, the (early) triggered SRS(s). In FIG. 10, an example signaling flow between a UE and a gNB/network for Mode-A is presented. The UE could determine or identify the third channel(s)/signal(s)—e.g., in form/terms of time and/or frequency resource(s)—to transmit the SRS(s) according to or based on: (a) fixed rule(s) in system specification(s) and/or per RRC (re-)configuration/setup such as association(s)/mapping(s) between (resource(s) of) the third channel(s)/signal(s) and (resource(s) of) the second triggering channel(s)/signal(s), wherein the association(s)/mapping(s) could be in form/terms of timing relationship(s) or timeline(s), configuration(s), time-frequency resource allocation(s) and/or etc. according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s), (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network via various UL channels/signals e.g. via/in part of beam/CSI report(s) and/or UE's capability signaling(s).

FIGS. 11A and 11B illustrate signal flows of example procedures 1100 and 1150 for first and second channels/signals according to embodiments of the present disclosure. For example, procedures 1100 and 1150 can be performed by the UE 116 and the gNB 103 and/or network 130 in the wireless network 100 of FIG. 1. This example is for illustration only and other embodiments can be used without departing from the scope of the present disclosure.

The procedure 1100 begins in 1110, a UE transmits Msg 1: Random Access Preamble to a NW/gNB. In 1120, the NW/gNB transmits Msg2: Random Access Response to the UE. In 1130, the UE transmits Msg3: Scheduled transmission(s) to the NW/gNB. In 1140, the NW/gNB transmits Msg4: Contention Resolution to the UE.

The procedure 1150 begins in 1160, a UE transmits MsgA: PRACH (preamble) to a NW/gNB. In 1170, the UE transmits MsgA: PUSCH to the NW/gNB. In 1180, the NW/gNB transmits MsgB: Random Access Response to the UE.

For Mode-A, the one or more first indicators could correspond to a one-bit indicator (e.g., a one-bit UCI or a one-bit scheduling request (SR) provided by a SR configuration) or a multi-bit indicator. For instance, when/if the one or more first indicators correspond to a one-bit indicator, and/or when/if the UE has sent or indicated or transmitted to the network (e.g., the network 130), the one or more first indicators set to ‘1’ or ‘positive’ or ‘on’ or etc., the UE could request the network to (early) trigger the SRS transmission(s). Furthermore, the one or more first channels/signals could correspond to or could be associated/specific to:
Alt-1—(periodic or periodically configured) PUCCH(s) or PUCCH resource(s), wherein the corresponding PUCCH resource configuration(s) including time-frequency resource allocation(s) for the PUCCH(s)/PUCCH resource(s) provided by PUCCH-Config, PUCCH-Resource, PUCCH-ResourceSet, and/or etc. could be provided or indicated in the higher layer parameter(s) including SIB1, SIB2, RRCRelease-IEs and/or etc. that provides or indicates the SRS resource configuration(s) for the early triggering of the SRS transmission(s) as specified/defined herein in the present disclosure.
Alt-2—(periodic or periodically configured) PUSCH(s) or PUSCH resource(s)—e.g., Type1/2 CG PUSCH(s), wherein the corresponding PUSCH resource configuration(s) including time-frequency resource allocation(s) for the PUSCH(s)/PUSCH resource(s) provided by PUSCH-Config and/or etc. could be provided or indicated in the higher layer parameter(s) including SIB1, SIB2, RRCRelease-IEs and/or etc. that provides or indicates the SRS resource configuration(s) for the early triggering of the SRS transmission(s) as specified/defined herein in the present disclosure.
Alt-3—one or more PUSCH(s) or PUSCH resource(s) scheduled or activated by a DCI format (e.g., a DL DCI format of 1_0/1_1/1_2/1_3 or a UL DCI format of 0_0/0_1/0_2/0_3 or a DCI format of 2_3 or a new DL/UL DCI format, e.g., dedicated for the early triggering of the SRS transmission(s)). For instance, the DCI format could indicate or comprise or provide a one-bit indicator—e.g., via/by/in a new DCI field or a repurposed existing DCI field—with ‘1’ (or ‘0’) indicating that the correspondingly scheduled/activated PUSCH(s)/PUSCH resource(s) could be for carrying, conveying, sending or transmitting the first indicator(s) as specified/defined herein in the present disclosure. Furthermore, the CRC of the DCI format(s) could be scrambled with a RNTI, wherein the RNTI could be associated with the early triggered SRS(s).
Alt-4—UL channel(s)/signal(s) including PUCCH(s)/PUSCH(s)/PRACH(s)/SRS(s) and/or etc. corresponding/associated/specific to one or more higher layer messages carried by/in PDSCH(s). Here, the higher layer message(s) could be a SIB message (e.g., SIB1, SIB2 or other SIB message(s)), a RRC message (e.g., a RRC reconfiguration message, a RRC setup message, a RRC release message, and/or etc.), a MAC CE message/signaling, and/or etc.; furthermore, the PDSCH(s) could be scheduled/activated by a corresponding DCI format. The CRC of the higher layer message(s) and/or the corresponding DCI format could be scrambled with a RNTI, wherein the RNTI could be associated with the early triggered SRS(s). For instance, the UL channel(s)/signal(s) herein could be associated with or after a PRACH preamble transmission as indicated or configured or provided by the higher layer message(s). Optionally, the UL channel(s)/signal(s) herein could be associated with or after a RACH scheduled transmission or a Msg3 as indicated or configured or provided by the higher layer message(s). Furthermore, the UL channel(s)/signal(s) herein could be associated with or after a MsgA as indicated or configured or provided by the higher layer message(s).
Alt-5—UL channel(s)/signal(s) including PUCCH(s)/PUSCH(s)/PRACH(s)/SRS(s) and/or etc. corresponding/associated/specific to one or more paging early indications (PEIs) or paging messages, e.g., corresponding to/for one or more paging occasions. Here, a PEI could include an indication for each subgroup of a PO whether there is a corresponding paging message for the UEs of that subgroup. In addition, a PEI could be carried or conveyed using a DCI format (e.g., DCI format 27). For instance, the UL channel(s)/signal(s) herein could be associated with or after a PRACH preamble transmission as indicated or configured or provided by the PEI(s)/paging message(s). Optionally, the UL channel(s)/signal(s) herein could be associated with or after a RACH scheduled transmission or a Msg3 as indicated or configured or provided by the PEI(s)/paging message(s). Furthermore, the UL channel(s)/signal(s) herein could be associated with or after a MsgA as indicated or configured or provided by the PEI(s)/paging message(s).
Alt-6—a PRACH transmission or a RACH preamble transmission—e.g., Msg1; in this case, a PRACH preamble of Msg1 could also indicate the one or more first indicators as specified/defined herein in the present disclosure.
Alt-7—a RACH scheduled transmission—e.g., Msg3; in this case, the PUSCH transmission providing Msg3 and/or scheduled by RAR could also include, comprise, carry or convey the one or more first indicators as specified/defined herein in the present disclosure.
Alt-8—a MsgA of Type-2 random access procedure; in this case, the PRACH (preamble) or PUSCH transmission providing MsgA could also include, comprise, carry or convey the one or more first indicators as specified/defined herein in the present disclosure.
Alt-9—UL channel(s)/signal(s) including PUCCH(s)/PUSCH(s)/PRACH(s)/SRS(s) and/or etc. associated with or after a RACH scheduled (PUSCH) transmission or a Msg3 as indicated or configured or provided by a RAR. Here, the RAR could be a Msg2 corresponding to a preamble transmission for a contention based or a contention free random access procedure, or a MsgB of a Type-2 random access procedure as a success RAR (e.g., of a contention based random access procedure) or a fall back RAR (e.g., of a contention free random access procedure).
Alt-10—an uplink wake-up signal (UL WUS). The UL WUS is received by a low power radio (low power receiver) in the gNB (e.g., the BS 102). In one example, an UL WUS is OOK-1 (on off keying type 1) as described in TR 38.869. In another example, an UL WUS is OOK-2 [TR 38.869]. In another example, an UL WUS is OOK-3 [TR 38.869]. In another example, an UL WUS is OOK-4 [TR 38.869].

According to those specified/defined herein in the present disclosure, the UE (e.g., the UE 116) could be provided or configured or indicated by the network, e.g., via higher layer RRC signaling(s) and/or MAC CE command(s) and/or dynamic DCI based L1 signaling(s) based on or according to a corresponding UE's capability or capability signaling, resource configuration(s)—or denoted by first UL resource(s)/resource configuration(s)—for the one or more first channels/signals as specified/defined herein in the present disclosure.
For PUCCH(s) or PUCCH resource(s) in Alt-1, the resource configuration(s) could be provided by PUCCH-Config, PUCCH-Resource, PUCCH-ResourceSet and/or etc., and/or could comprise or provide or contain or include one or more of:
   Time domain resources, including symbols (e.g., OFDM symbols) within a slot or sub-frame or frame to transmit the PUCCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUCCH(s) and/or PUCCH resource(s). Frequency domain resources can include one or more of number of resources, starting resource and/or ending resource.
   ID of code or sequence for PUCCH(s) and/or PUCCH resource(s).
   Cyclic shift for PUCCH(s) and/or PUCCH resource(s).
   PUCCH configuration index, wherein the PUCCH configuration index points to a PUCCH configuration in a set or list of configured PUCCH resources.
   PUCCH format (e.g., PUCCH Format 0 or PUCCH Format 1 or PUCCH Format 2 or PUCCH Format 3 or PUCCH Format 4).
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUCCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUCCH associated with the determined CSI-RS.
For PUSCH(s) or PUSCH resource(s) in Alt-2 and/or Alt-3, the resource configuration(s) could be provided by PUSCH-Config and/or etc., and/or could comprise or provide or contain or include one or more of:
   Time domain resources, including symbols (e.g., OFDM symbols) within a slot or sub-frame or frame to transmit the PUSCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure. In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUSCH(s) and/or PUSCH resource(s). Frequency domain resources can include one or more of number of resources, starting resource and/or ending resource.
   ID of code or sequence for PUSCH(s) and/or PUSCH resource(s).
   PUSCH configuration index, wherein the PUSCH configuration index points to a PUSCH configuration in a set or list of configured PUSCH resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUSCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUSCH associated with the determined CSI-RS.
For PRACH transmission(s) in Alt-4, Alt-5, Alt-6, Alt-7, Alt-8 and/or Alt-9, the resource configuration(s) could be provided by RACH-Config, RACH-ConfigCommon and/or RACH-ConfigDedicated, and/or could comprise or provide or contain or include one or more of:
   Time domain resources, including symbols (e.g., OFDM symbols) within a slot or sub-frame or frame to transmit the PRACH(s), including one or more of the number of symbols, the starting symbol and/or the ending symbol.
   Time domain resources including PRACH occasions.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group of PRBs) and/or interlaces for transmission of PRACH(s) and/or PRACH resource(s) and/or PRACH occasion(s). Frequency domain resources can include one or more of number of resources, starting resource and/or ending resource.
   Root sequence and/or cyclic shift.
   PRACH configuration index.
   Preamble format.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PRACH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PRACH associated with the determined CSI-RS.
For UL WUS in Alt-10, the corresponding resource configuration(s) could comprise or provide or contain or include one or more of:
   Time domain resources, including symbols (e.g., OFDM symbols) within a slot or sub-frame or frame to transmit the UL WUS(s), including one or more of the number of symbols, the starting symbol and/or the ending symbol.
   Time domain resources including periodicity and offset within the periodicity, wherein the periodicity and/or offset within a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group or number of PRBs) and/or interlaces for transmission of the UL WUS(s). Frequency domain resources can include one or more of number of resources, starting resource and/or ending resource.
   Comb size and comb offset if a comb structure is used for the frequency resources. For example, a comb of size M, transmits every M-th frequency resource starting from an offset (comb offset).
   ID of code or sequence. For example, this can be an overlaid sequence on the UL WUS(s).
   UL WUS configuration index, wherein the UL WUS configuration index points to a UL WUS configuration in a set or list of configured UL WUS resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the UL WUS associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the UL WUS associated the determined CSI-RS.

In the present disclosure, the UE could determine or identify the one or more second triggering channels/signals based on or according to:
In one example (Option-1), the second triggering channel(s)/signal(s) could correspond to or could be associated/specific to a DCI format (e.g., a DL DCI format of 1_0/1_1/1_2/1_3 or a UL DCI format of 0_0/0_1/0_2/0_3 or a DCI format of 2_3 or a new DL/UL DCI format, e.g., dedicated for the early triggering of the SRS transmission(s)), wherein the one or more second indicators could correspond to or could be provided/indicated in/by one or more new DCI fields in the DCI format(s), or one or more existing DCI fields (e.g., SRS request field in DCI format 0_1/1_1/2_3) in the DCI format(s) repurposed for the early triggering of the SRS transmission(s). Furthermore, the CRC of the DCI format(s) could be scrambled with a RNTI, wherein the RNTI could be associated with the early triggered SRS(s).
In another example (Option-2), the second triggering channel(s)/signal(s) could correspond to or could be associated/specific to a higher layer message carried by/in a PDSCH, wherein the higher layer message could be a SIB message (e.g., SIB1, SIB2 or other SIB message(s)), a RRC message (e.g., a RRC reconfiguration message, a RRC setup message, a RRC release message, and/or etc.), a MAC CE message/signaling, and/or etc.; furthermore, the PDSCH could be scheduled/activated by a corresponding DCI format. The CRC of the higher layer message and/or the corresponding DCI format could be scrambled with a RNTI, wherein the RNTI could be associated with the early triggered SRS(s). In this case, the higher layer message could carry, convey, include or comprise the one or more second indicators as specified/defined herein in the present disclosure.
In another example (Option-3), the second triggering channel(s)/signal(s) could correspond to or could be associated/specific to one or more paging occasions (POs) or a paging early indication (PEI) associated with a PO, wherein the PEI could include an indication for each subgroup of a PO whether there is a corresponding paging message for the UEs of that subgroup. In this case, the PO(s)/PEI could comprise, contain, include, convey or carry the one or more second indicators as specified/defined herein in the present disclosure. In addition, the PEI could be carried or conveyed using a DCI format (e.g., DCI format 2_7).
In another example (Option-4), the second triggering channel(s)/signal(s) could correspond to or could be associated/specific to a random access response (RAR)—e.g., Msg2—to a preamble transmission for a contention based or a contention free random access procedure; in this case, the RAR (e.g., Msg2) could also include, comprise, carry or convey the one or more second indicators as specified/defined herein in the present disclosure. Optionally, the second triggering channel(s)/signal(s) could correspond to or could be associated/specific to a contention resolution message (e.g., a MAC CE) providing a C-RNTI for the UE, or in Msg4, of a contention based random access procedure; in this case, the contention resolution message (e.g., Msg4) could also include, comprise, carry or convey the one or more second indicators as specified/defined herein in the present disclosure. Alternatively, the second triggering channel(s)/signal(s) could correspond to or could be associated/specific to a MsgB of a Type-2 random access procedure, wherein the MsgB could be for success RAR (e.g., of a contention based random access procedure) or a fall back RAR (e.g., of a contention free random access procedure); in this case, the MsgB (or the success RAR or fall back RAR) could also include, comprise, carry or convey the one or more second indicators as specified/defined herein in the present disclosure.

The UE could determine or identify which one or more of the Option-1, Option-2, Option-3 and Option-4 to use or follow or apply to determine or identify the second triggering channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more second indicators could correspond to or comprise, or could be in form/terms of one or more of:
A one-bit flag indicator (e.g., a new one-bit DCI field in the DCI format(s) as specified/defined in Option-1) with ‘1’ (or ‘0’) indicating or enabling or triggering (early) SRS transmission(s)
A (higher layer) parameter set to ‘enabled’ or ‘on’ indicating or enabling or triggering (early) SRS transmission(s)
A message indicating ACK or negative ACK (NACK) in response to the first indicator(s) transmitted/sent in the first channel(s)/signal(s); for instance, the message could be a one-bit indicator with ‘1’ (or ‘0’) indicating ACK in response to the first indicator(s) transmitted/sent in the first channel(s)/signal(s), and ‘0’ (or ‘1’) indicating NACK in response to the first indicator(s) transmitted/sent in the first channel(s)/signal(s)

The one or more second indicators could be present or absent in their corresponding second triggering channel(s)/signal(s) according to network's configuration or indication (e.g., via RRC signaling(s)/configuration(s)). For instance, the UE could be provided or indicated or configured by the network a higher layer parameter/signaling denoted by earlySRSTrigger_PresentInDCI. In this case, when/if the higher layer parameter/signaling earlySRSTrigger_PresentInDCI is provided/configured and/or set to ‘enabled’ or ‘on’, the second indicator(s) as specified/defined herein in the present disclosure could be present in the corresponding DCI format(s) as specified/defined in Option-1 following those specified herein in the present disclosure; otherwise, i.e., when/if the higher layer parameter/signaling earlySRSTrigger_PresentInDCI is not provided/configured and/or set to ‘disabled’ or ‘off’, the second indicator(s) as specified/defined herein in the present disclosure may not be present or could be absent in the corresponding DCI format(s) as specified/defined in Option-1 according to those specified herein in the present disclosure.

In FIG. 11, conceptual examples of first and second channels/signals to carry, convey, provide or indicate the first and second indicators respectively in RACH procedure(s) are presented according to or following those specified herein in the present disclosure.

Furthermore, as illustrated in FIG. 10 (Mode-A), after the UE has detected/received the second indicator(s) transmitted/sent from the network in the second channel(s)/signal(s), the UE could transmit, in one or more third channels/signals, the (early) triggered SRS(s). According to those specified herein in the present disclosure, the UE could determine or identify the one or more third channels/signals to transmit or send the (early) triggered SRS(s) based on or according to:
In one example (Alt-A), the one or more third channels/signals could correspond to or could be associated/specific to (periodic or periodically configured) PUCCH(s) or PUCCH resource(s), wherein the corresponding PUCCH resource configuration(s) including time-frequency resource allocation(s) for the PUCCH(s)/PUCCH resource(s) provided by PUCCH-Config, PUCCH-Resource, PUCCH-ResourceSet, and/or etc. could be provided or indicated in the higher layer parameter(s) including SIB1, SIB2, RRCRelease-IEs and/or etc. that provides or indicates the SRS resource configuration(s) for the early triggering of the SRS transmission(s) as specified/defined herein in the present disclosure.
In another example (Alt-B), the one or more third channels/signals could correspond to or could be associated/specific to (periodic or periodically configured) PUSCH(s) or PUSCH resource(s)—e.g., Type1/2 CG PUSCH(s), wherein the corresponding PUSCH resource configuration(s) including time-frequency resource allocation(s) for the PUSCH(s)/PUSCH resource(s) provided by PUSCH-Config and/or etc. could be provided or indicated in the higher layer parameter(s) including SIB1, SIB2, RRCRelease-IEs and/or etc. that provides or indicates the SRS resource configuration(s) for the early triggering of the SRS transmission(s) as specified/defined herein in the present disclosure.
In another example (Alt-C), the one or more third channels/signals could correspond to or could be associated/specific to one or more PUSCH(s) or PUSCH resource(s) scheduled or activated by a DCI format(s), wherein the DCI format(s) could correspond to the one or more second triggering channels/signals as specified/defined in Option-1 in the present disclosure.
In another example (Alt-D), the third channel(s)/signal(s) could correspond to the UL channel(s)/signal(s) including PUCCH(s)/PUSCH(s)/PRACH(s)/SRS(s) and/or etc. corresponding/associated/specific to the higher layer message(s) as specified/defined in Option-2 in the present disclosure. For instance, the UL channel(s)/signal(s) herein could be associated with or after a PRACH preamble transmission as indicated or configured or provided by the higher layer message(s) as specified/defined in Option-2 in the present disclosure. Optionally, the UL channel(s)/signal(s) herein could be associated with or after a RACH scheduled transmission or a Msg3 as indicated or configured or provided by the higher layer message(s) as specified/defined in Option-2 in the present disclosure. Furthermore, the UL channel(s)/signal(s) herein could be associated with or after a MsgA as indicated or configured or provided by the higher layer message(s) as specified/defined in Option-2 in the present disclosure.
In another example (Alt-E), the third channel(s)/signal(s) could correspond to the UL channel(s)/signal(s) including PUCCH(s)/PUSCH(s)/PRACH(s)/SRS(s) and/or etc. corresponding/associated/specific to the PEI(s) or paging message(s), e.g., corresponding to/for one or more POs, as specified/defined in Option-3 in the present disclosure. For instance, the UL channel(s)/signal(s) herein could be associated with or after a PRACH preamble transmission as indicated or configured or provided by the PEI(s)/paging message(s) as specified/defined in Option-3 in the present disclosure. Optionally, the UL channel(s)/signal(s) herein could be associated with or after a RACH scheduled transmission or a Msg3 as indicated or configured or provided by the PEI(s)/paging message(s) as specified/defined in Option-3 in the present disclosure. Furthermore, the UL channel(s)/signal(s) herein could be associated with or after a MsgA as indicated or configured or provided by the PEI(s)/paging message(s) as specified/defined in Option-3 in the present disclosure.
In another example (Alt-F), the third channel(s)/signal(s) could correspond to or could be associated/specific to a PRACH transmission or a RACH preamble transmission—e.g., Msg1; in this case, a PRACH preamble of Msg1 could also indicate the (early) triggered SRS(s) as specified/defined herein in the present disclosure. Alternatively, the third channel(s)/signal(s) could correspond to or could be associated/specific to a RACH scheduled transmission—e.g., Msg3; in this case, the PUSCH transmission providing Msg3 and/or scheduled by RAR could also include, comprise, carry or convey the (early) triggered SRS(s) as specified/defined herein in the present disclosure. Optionally, the third channel(s)/signal(s) could correspond to or could be associated/specific to a MsgA of Type-2 random access procedure; in this case, the PRACH (preamble) or PUSCH transmission providing MsgA could also include, comprise, carry or convey the (early) triggered SRS(s) as specified/defined herein in the present disclosure. In addition, the third channel(s)/signal(s) could correspond to the UL channel(s)/signal(s) including PUCCH(s)/PUSCH(s)/PRACH(s)/SRS(s) and/or etc. associated with or after a RACH scheduled (PUSCH) transmission or a Msg3 as indicated or configured or provided by the RAR as specified/defined in Option-4 in the present disclosure.
In another example (Alt-G), the third channel(s)/signal(s) could correspond to or could be associated/specific to an uplink wake-up signal (UL WUS). The UL WUS is received by a low power radio (low power receiver) in the gNB. In one example, an UL WUS is OOK-1 (on off keying type 1) as described in TR 38.869. In another example, an UL WUS is OOK-2 [TR 38.869]. In another example, an UL WUS is OOK-3 [TR 38.869]. In another example, an UL WUS is OOK-4 [TR 38.869].

The UE could determine or identify UL resource(s) or resource allocation(s) for the one or more third channel(s)/signal(s) according to or based on one or more of: (a-1) (pre-)configured UL resource(s) and/or (pre-)configuration of UL resource(s) or resource allocation(s), (a-2) network's (dynamic) indication of UL resource(s) or resource allocation(s), and (a-3) UE's autonomous determination or selection of UL resource(s) or resource allocation(s), which could be sent to the network (e.g., the network 130) via various UL channels/signals.

For (a-1) discussed herein, according to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, (pre-)configured UL resource(s) or resource allocation(s) or resource configuration(s)—or denoted by second UL resource(s)/resource configuration(s)—for the one or more third channels/signals as specified/defined herein in the present disclosure.
For PUCCH(s) or PUCCH resource(s) in Alt-A, the (pre-)configured UL resource(s) or resource allocation(s) or resource configuration(s) could be provided by PUCCH-Config, PUCCH-Resource, PUCCH-ResourceSet and/or etc., and/or could comprise or provide or contain or include one or more of:
   Time domain resources, including symbols (e.g., OFDM symbols) within a slot or sub-frame or frame to transmit the PUCCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUCCH(s) and/or PUCCH resource(s). Frequency domain resources can include one or more of number of resources, starting resource and/or ending resource.
   ID of code or sequence for PUCCH(s) and/or PUCCH resource(s).
   Cyclic shift for PUCCH(s) and/or PUCCH resource(s).
   PUCCH configuration index, wherein the PUCCH configuration index points to a PUCCH configuration in a set or list of configured PUCCH resources.
   PUCCH format (e.g., PUCCH Format 0 or PUCCH Format 1 or PUCCH Format 2 or PUCCH Format 3 or PUCCH Format 4).
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUCCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUCCH associated with the determined CSI-RS.
For PUSCH(s) or PUSCH resource(s) in Alt-B and/or Alt-C, the (pre-)configured UL resource(s) or resource allocation(s) or resource configuration(s) could be provided by PUSCH-Config and/or etc., and/or could comprise or provide or contain or include one or more of:
   Time domain resources, including symbols (e.g., OFDM symbols) within a slot or sub-frame or frame to transmit the PUSCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure. In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUSCH(s) and/or PUSCH resource(s). Frequency domain resources can include one or more of number of resources, starting resource and/or ending resource.
   ID of code or sequence for PUSCH(s) and/or PUSCH resource(s).
   PUSCH configuration index, wherein the PUSCH configuration index points to a PUSCH configuration in a set or list of configured PUSCH resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUSCH associated with the determined SSB. In another example, the spatial domain transmission filter corresponds to an CSI-RS (Channel State Information Reference Signal), e.g., CSI-RS ID. A UE (e.g., the UE 116) determines a CSI-RS, e.g., CSI-RS with RSRP above a configured threshold or CSI-RS with the largest RSRP), and selects or determines a resource for the PUSCH associated with the determined CSI-RS.
For PRACH transmission(s) in Alt-D, Alt-E and/or Alt-F, the (pre-)configured UL resource(s) or resource allocation(s) or resource configuration(s) could be provided by RACH-Config, RACH-ConfigCommon and/or RACH-ConfigDedicated, and/or could comprise or provide or contain or include one or more of:
   Time domain resources, including symbols (e.g., OFDM symbols) within a slot or sub-frame or frame to transmit the PRACH(s), including one or more of the number of symbols, the starting symbol and/or the ending symbol.
   Time domain resources including PRACH occasions.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group of PRBs) and/or interlaces for transmission of PRACH(s) and/or PRACH resource(s) and/or PRACH occasion(s). Frequency domain resources can include one or more of number of resources, starting resource and/or ending resource.
   Root sequence and/or cyclic shift.
   PRACH configuration index.
   Preamble format.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PRACH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PRACH associated with the determined CSI-RS.
For UL WUS in Alt-G, the corresponding (pre-)configured UL resource(s) or resource allocation(s) or resource configuration(s) could comprise or provide or contain or include one or more of:
   Time domain resources, including symbols (e.g., OFDM symbols) within a slot or sub-frame or frame to transmit the UL WUS(s), including one or more of the number of symbols, the starting symbol and/or the ending symbol.
   Time domain resources including periodicity and offset within the periodicity, wherein the periodicity and/or offset within a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group or number of PRBs) and/or interlaces for transmission of the UL WUS(s). Frequency domain resources can include one or more of number of resources, starting resource and/or ending resource.
   Comb size and comb offset if a comb structure is used for the frequency resources. For example, a comb of size M, transmits every M-th frequency resource starting from an offset (comb offset).
   ID of code or sequence. For example, this can be an overlaid sequence on the UL WUS(s).
   UL WUS configuration index, wherein the UL WUS configuration index points to a UL WUS configuration in a set or list of configured UL WUS resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the UL WUS associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the UL WUS associated the determined CSI-RS.

Furthermore, the UE could transmit or send or indicate to the network, in/by/via the third channel(s)/signal(s), the (early) triggered SRS(s) according to or based on one or more of the followings.
In one example, the UE could transmit or send or indicate to the network the third channel(s)/signal(s) carrying or conveying the (early) triggered SRS(s) using or via a/the most recent in time and/or available UL resource(s) a minimum time T_1 from the end (or start) of the second triggering channel(s)/signal(s). For instance, for Option-1, the second triggering channel(s)/signal(s) as mentioned herein could correspond to a PDCCH reception providing the DCI format(s) triggering the SRS transmission.
In another example, the symbol or slot or subframe or frame used by a UE to transmit the (early) triggered SRS(s) could be a/the most recent in time and/or available UL resource(s) at or after a time T_1 from the end (or start) of the second triggering channel(s)/signal(s). For instance, for Option-1, the second triggering channel(s)/signal(s) as mentioned herein could correspond to a PDCCH reception providing the DCI format(s) triggering the SRS transmission.
In another example, the symbol or slot or subframe or frame used by a UE to transmit the (early) triggered SRS(s) could be that first symbol or slot or subframe or frame that starts at or after a time T_1 from the end (or start) of the second triggering channel(s)/signal(s) and optionally based on a time offset/gap. For instance, for Option-1, the second triggering channel(s)/signal(s) as mentioned herein could correspond to a PDCCH reception providing the DCI format(s) triggering the SRS transmission.

The time T_1 and/or the time offset/gap could be in number of symbol(s), slot(s), subframe(s), frame(s) and/or etc. Furthermore, the UE could determine or identify the value(s) of the time T_1 and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_1 and/or the time offset/gap could be indicated or provided by/in the DCI format(s) that trigger(s) the SRS transmission(s)—as in Option-1 in the present disclosure.
For example, one or more new DCI fields in the DCI format(s) could indicate or provide the value(s) of the time T_1 and/or the time offset/gap.
For another example, one or more existing DCI fields in the DCI format(s) could be repurposed to indicate or provide the value(s) of the time T_1 and/or the time offset/gap.

The value(s) of the time T_1 and/or the time offset/gap could be present or absent in their corresponding second triggering channel(s)/signal(s) according to network's configuration or indication (e.g., via RRC signaling(s)/configuration(s)). For instance, the UE could be provided or indicated or configured by the network a higher layer parameter/signaling denoted by timeIndicationSRS_PresentInDCI. In this case, when/if the higher layer parameter/signaling timeIndicationSRS_PresentInDCI is provided/configured and/or set to ‘enabled’ or ‘on’, the value(s) of the time T_1 and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationSRS_PresentInDCI is not provided/configured and/or set to ‘disabled’ or ‘off’, the value(s) of the time T_1 and/or the time offset/gap as specified/defined herein in the present disclosure may not be present or could be absent in the corresponding DCI format(s) as specified/defined in Option-1 according to those specified herein in the present disclosure. In this case, when/if the network does not receive or detect the (early) triggered SRS(s) transmitted from the UE,
a minimum time M_1 from the end (or start) of the second triggering channel(s)/signal(s)—for instance, for Option-1, the second triggering channel(s)/signal(s) as mentioned herein could correspond to a PDCCH reception providing the DCI format(s) triggering the SRS transmission, and/or
at or after a time M_1 from the end (or start) of the second triggering channel(s)/signal(s)—for instance, for Option-1, the second triggering channel(s)/signal(s) as mentioned herein could correspond to a PDCCH reception providing the DCI format(s) triggering the SRS transmission, and/or
at or after a time M_1 from the end (or start) of the second triggering channel(s)/signal(s) and optionally based on a time offset/gap—for instance, for Option-1, the second triggering channel(s)/signal(s) as mentioned herein could correspond to a PDCCH reception providing the DCI format(s) triggering the SRS transmission,
   the network could (dynamically) indicate to the UE, e.g., by/in/via higher layer RRC signaling(s)/parameter(s) and/or MAC CE command(s) and/or dynamic DCI based L1 signaling(s) based on or according to a corresponding UE's capability or capability signaling, UL resource(s) and/or UL resource allocation(s) for (re-)transmitting the (early) triggered SRS(s) according to or based on those specified herein in the present disclosure.

For (a-2) discussed herein, according to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, (pre-)configured UL resource(s) or resource allocation(s) or resource configuration(s) for the one or more third channels/signals as specified/defined herein in the present disclosure. The UE could then receive from the network, e.g., via higher layer RRC signaling(s)/parameter(s) and/or MAC CE command(s) and/or dynamic DCI based L1 signaling(s), one or more indicators to indicate which one or more of the (pre-)configured UL resource(s) or resource(s) or resource configuration(s) to use or apply for determining or identifying SRS resource(s) to transmit or send the (early) triggered SRS(s) in the third channel(s)/signal(s).

For (a-3) discussed herein, according to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, (pre-)configured UL resource(s) or resource allocation(s) or resource configuration(s) for the one or more third channels/signals as specified/defined herein in the present disclosure. The UE could then transmit or indicate or send to the network one or more indicators to indicate which one or more of the (pre-)configured UL resource(s) or resource(s) or resource configuration(s) the UE could or would use or apply for determining or identifying SRS resource(s) to transmit or send the (early) triggered SRS(s) in the third channel(s)/signal(s).

For Mode-A, the UE could expect to receive from the network, in/by/via the second channel(s)/signal(s), the second indicator(s) to trigger the (early) SRS transmission(s) according to or based on one or more of the followings.
In one example, the UE could expect to receive from the network, in/by/via the second channel(s)/signal(s), the second indicator(s) for the (early) triggering of the SRS transmission(s) a minimum time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the SRS transmission(s) could be at or after a time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the SRS transmission(s) could be that first symbol or slot or subframe or frame that starts at or after a time T_2 from the end (or start) of the first channel(s)/signal(s) and optionally based on a time offset/gap.

The time T_2 and/or the time offset/gap could be in number of symbol(s), slot(s), subframe(s), frame(s) and/or etc. Furthermore, the UE could determine or identify the value(s) of the time T and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_2 and/or the time offset/gap could be indicated or provided by/in the DCI format(s) that trigger(s) the SRS transmission(s)—as in Option-1 in the present disclosure.
For example, one or more new DCI fields in the DCI format(s) could indicate or provide the value(s) of the time T_2 and/or the time offset/gap.
For another example, one or more existing DCI fields in the DCI format(s) could be repurposed to indicate or provide the value(s) of the time T_2 and/or the time offset/gap.

The value(s) of the time T_2 and/or the time offset/gap could be present or absent in their corresponding first channel(s)/signal(s) according to network's configuration or indication (e.g., via RRC signaling(s)/configuration(s)). For instance, the UE could be provided or indicated or configured by the network a higher layer parameter/signaling denoted by timeIndicationSRSTrigger_PresentInDCI. In this case, when/if the higher layer parameter/signaling timeIndicationSRSTrigger_PresentInDCI is provided/configured and/or set to ‘enabled’ or ‘on’, the value(s) of the time T_2 and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationSRSTrigger_PresentInDCI is not provided/configured and/or set to ‘disabled’ or ‘off’, the value(s) of the time T_2 and/or the time offset/gap as specified/defined herein in the present disclosure may not be present or could be absent in the corresponding DCI format(s) as specified/defined in Option-1 according to those specified herein in the present disclosure. When/if the UE does not from the network, in/by/via the second channel(s)/signal(s), the second indicator(s) to trigger the (early) SRS transmission(s) according to or based on the timeline(s) or timing relation(s) mentioned herein, the UE could (re-)transmit or (re-)send to the network, in/via/by one or more first channels/signals, one or more first indicators to request the (early) triggering of the SRS transmission(s), wherein here the UE could determine or identify the one or more first channels/signals including the corresponding UL resource(s) and/or resource allocation(s) and/or the one or more first indicator(s) according to or following those specified herein in the present disclosure.

FIG. 12 illustrates a signal flow of an example procedure 1200 for early triggering of SRS transmission according to embodiments of the present disclosure. For example, procedure 1200 can be performed by the UE 116 and the gNB 102 and/or network 130 in the wireless network 100 of FIG. 1. This example is for illustration only and other embodiments can be used without departing from the scope of the present disclosure.

The procedure begins in 1210, a NW/gNB transmits configuration(s) of SRS resource(s) for early triggering to a UE, e.g., via SIB, RRC release message, etc. In 1220, the UE transmits first indicator(s) sent in first channel(s)/signal(s) to trigger SR S transmission(s) to the NW/gNB, In 1230, the NW/gNB transmits second indicator(s) sent in second channel(s)/signal(s) to the UE to indicate UL resource(s) for the (early) triggered SRS(s). In 1240, the UE transmits SRS transmission(s) in third channel(s)/signal(s) to the NW/gNB.

In one example (Mode-B), after a UE has received from the network the SRS resource configuration(s) for the early triggering of the SRS transmission(s) according to or following those specified herein in the present disclosure, the UE could send or indicate or transmit to the network, via/in/by one or more first channels/signals, a first indicator to trigger (early) SRS transmission(s). For this design example, the UE could expect to receive from the network, in/via/by one or more second triggering channels/signals, one or more second indicators to indicate UL resource(s) and/or resource allocation(s) for transmitting the (early) triggered SRS(s)—as in (a-2) in the present disclosure. Upon detection and/or reception of the one or more second indicators, the UE could determine or identify, based on or according to the SRS resource configuration(s) and allocation(s), the SRS(s) along with the corresponding parameter(s)/setting(s) to transmit. In this case, the UE could then transmit or send to the network, in/via/by one or more third channels/signals, the (early) triggered SRS(s). In FIG. 12, an example signaling flow between a UE and a gNB (e.g., the BS 102)/network for Mode-B is presented.

For Mode-B, the one or more first indicators could correspond to a one-bit indicator (e.g., a one-bit UCI or a one-bit scheduling request (SR) provided by a SR configuration) or a multi-bit indicator. For instance, when/if the one or more first indicators correspond to a one-bit indicator, and/or when/if the UE has sent or indicated or transmitted to the network, the one or more first indicators set to ‘1’ or ‘positive’ or ‘on’ or etc., the UE could indicate to the network that (early) SRS transmission(s) is triggered. Furthermore, the one or more first channels/signals in Mode-B could correspond to or could be associated/specific to one or more of Alt-1, Alt-2, . . . , Alt-10 as specified/defined herein in the present disclosure for the one or more first channels/signals for Mode-A. Furthermore, the UE could determine or identify resource configuration(s) for the one or more first channels/signals in Mode-B as or according to or based on the resource configuration(s) for the one or more first channels/signals in Mode-A as specified/defined herein in the present disclosure. For Mode-B, the UE could determine or identify the one or more second channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the second channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more second indicators could correspond to or comprise, or could be in form/terms of one or more of:
A message indicating ACK or NACK in response to the first indicator(s) transmitted/sent in the first channel(s)/signal(s); for instance, the message could be a one-bit indicator with ‘1’ (or ‘0’) indicating ACK in response to the first indicator(s) transmitted/sent in the first channel(s)/signal(s), and ‘0’ (or ‘1’) indicating NACK in response to the first indicator(s) transmitted/sent in the first channel(s)/signal(s)
UL resource(s) or resource allocation(s)/indication(s) as in (a-2) for the third channel(s)/signal(s) to carry or convey the (early) triggered SRS(s)

The one or more second indicators could be present or absent in their corresponding second channel(s)/signal(s) according to network's configuration or indication (e.g., via RRC signaling(s)/configuration(s)). For instance, the UE could be provided or indicated or configured by the network (e.g., the network 130), a higher layer parameter/signaling denoted by earlySRSRa_PresentInDCI. In this case, when/if the higher layer parameter/signaling earlySRSRa_PresentInDCI is provided/configured and/or set to ‘enabled’ or ‘on’, the second indicator(s) as specified/defined herein in the present disclosure could be present in the corresponding DCI format(s) as specified/defined in Option-1 following those specified herein in the present disclosure; otherwise, i.e., when/if the higher layer parameter/signaling earlySRSRa_PresentInDCI is not provided/configured and/or set to ‘disabled’ or ‘off’, the second indicator(s) as specified/defined herein in the present disclosure may not be present or could be absent in the corresponding DCI format(s) as specified/defined in Option-1 according to those specified herein in the present disclosure.

FIG. 13 illustrates a signal flow of an example procedure 1300 for early triggering of SRS transmission according to embodiments of the present disclosure. For example, procedure 1300 can be performed by the UE 116 and the gNB 103 and/or network 130 in the wireless network 100 of FIG. 1. This example is for illustration only and other embodiments can be used without departing from the scope of the present disclosure.

The procedure begins in 1310, a NW/gNB transmits configuration(s) of SRS resource(s) for early triggering to a UE, e.g., via SIB, RRC release message, etc. In 1320, the UE transmits first indicator(s) sent in first channel(s)/signal(s) to the NW/gNB to trigger SRS transmission(s). In 1330, the UE transmits SRS transmission(s) in second channel(s)/signal(s) to the NV/gNB.

Furthermore, for Mode-B, after the UE has detected/received the second indicator(s) transmitted/sent from the network in the second channel(s)/signal(s), the UE could transmit, in one or more third channels/signals, the (early) triggered SRS(s). According to those specified herein in the present disclosure, the UE could determine or identify the one or more third channels/signals to transmit or send the (early) triggered SRS(s) based on or according to one or more of Alt-A, Alt-B, Alt-C, Alt-D, Alt-E, Alt-F and Alt-G as specified/defined for the one or more third channels/signals as in Mode-A in the present disclosure. The UE could determine or identify UL resource(s) or resource allocation(s) for the one or more third channels/signals in Mode-B according to or based on network's (dynamic) indication of UL resource(s) or resource allocation(s) as in (a-2), provided/indicated by the second indicator(s) transmitted or sent in the second channel(s)/signal(s) as mentioned herein in Mode-B.

For Mode-B, the UE could expect to receive from the network, in/by/via the second channel(s)/signal(s), the second indicator(s) to provide or indicate UL resource(s) or resource allocation(s) for the (early) triggered SRS transmission(s) according to or based on one or more of the followings.
In one example, the UE could expect to receive from the network, in/by/via the second channel(s)/signal(s), the second indicator(s) to provide or indicate UL resource(s) or resource allocation(s) for the (early) triggered SRS transmission(s) a minimum time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the SRS transmission(s) could be at or after a time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the SRS transmission(s) could be that first symbol or slot or subframe or frame that starts at or after a time T_2 from the end (or start) of the first channel(s)/signal(s) and optionally based on a time offset/gap.

The time T_2 and/or the time offset/gap could be in number of symbol(s), slot(s), subframe(s), frame(s) and/or etc. Furthermore, the UE (e.g., the UE 116) could determine or identify the value(s) of the time T and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_2 and/or the time offset/gap could be indicated or provided by/in the DCI format(s) that trigger(s) the SRS transmission(s)—as in Option-1 in the present disclosure.
For example, one or more new DCI fields in the DCI format(s) could indicate or provide the value(s) of the time T_2 and/or the time offset/gap.
For another example, one or more existing DCI fields in the DCI format(s) could be repurposed to indicate or provide the value(s) of the time T_2 and/or the time offset/gap.

The value(s) of the time T_2 and/or the time offset/gap could be present or absent in their corresponding first channel(s)/signal(s) according to network's configuration or indication (e.g., via RRC signaling(s)/configuration(s)). For instance, the UE could be provided or indicated or configured by the network a higher layer parameter/signaling denoted by timeIndicationSRSTrigger_PresentInDCI. In this case, when/if the higher layer parameter/signaling timeIndicationSRSTrigger_PresentInDCI is provided/configured and/or set to ‘enabled’ or ‘on’, the value(s) of the time T_2 and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationSRSTrigger_PresentInDCI is not provided/configured and/or set to ‘disabled’ or ‘off’, the value(s) of the time T_2 and/or the time offset/gap as specified/defined herein in the present disclosure may not be present or could be absent in the corresponding DCI format(s) as specified/defined in Option-1 according to those specified herein in the present disclosure. When/if the UE does not from the network, in/by/via the second channel(s)/signal(s), the second indicator(s) to trigger the (early) SRS transmission(s) according to or based on the timeline(s) or timing relation(s) mentioned herein, the UE could (re-)transmit or (re-)send to the network, in/via/by one or more first channels/signals, one or more first indicators to request the (early) triggering of the SRS transmission(s), wherein here the UE could determine or identify the one or more first channels/signals including the corresponding UL resource(s) and/or resource allocation(s) and/or the one or more first indicator(s) according to or following those specified herein in the present disclosure.

In one example (Mode-C), after a UE has received from the network the SRS resource configuration(s) for the early triggering of the SRS transmission(s) according to or following those specified herein in the present disclosure, the UE could send or indicate or transmit to the network, via/in/by one or more first channels/signals, a first indicator to trigger (early) SRS transmission(s). For this design example, the UE could determine or identify, based on or according to the SRS resource configuration(s) and allocation(s), the SRS(s) along with the corresponding parameter(s)/setting(s) to transmit. In this case, the UE could then transmit or send to the network, in/via/by one or more second channels/signals, the (early) triggered SRS(s). In FIG. 13, an example signaling flow between a UE and a gNB/network for Mode-C is presented.

For Mode-C, the one or more first indicators could correspond to a one-bit indicator (e.g., a one-bit UCI or a one-bit scheduling request (SR) provided by a SR configuration) or a multi-bit indicator. For instance, when/if the one or more first indicators correspond to a one-bit indicator, and/or when/if the UE has sent or indicated or transmitted to the network, the one or more first indicators set to ‘1’ or ‘positive’ or ‘on’ or etc., the UE could indicate to the network that (early) SRS transmission(s) is triggered. Furthermore, the one or more first channels/signals in Mode-C could correspond to or could be associated/specific to one or more of Alt-1, Alt-2, . . . , Alt-10 as specified/defined herein in the present disclosure for the one or more first channels/signals for Mode-A. Furthermore, the UE could determine or identify resource configuration(s) for the one or more first channels/signals in Mode-C as or according to or based on the resource configuration(s) for the one or more first channels/signals in Mode-A as specified/defined herein in the present disclosure.

Furthermore, for Mode-C, after the UE has transmitted or sent to the network, in/via/by the first channel(s)/signal(s), the first indicator(s) to trigger the (early) SRS transmission(s), the UE could then transmit, in one or more second channels/signals, the (early) triggered SRS(s). According to those specified herein in the present disclosure, the UE could determine or identify the one or more second channels/signals to transmit or send the (early) triggered SRS(s) based on or according to one or more of Alt-A, Alt-B, Alt-C, Alt-D, Alt-E, Alt-F and Alt-G as specified/defined for the one or more third channels/signals as in Mode-A in the present disclosure. The UE could determine or identify UL resource(s) or resource allocation(s) for the one or more second channels/signals in Mode-C according to or based on (pre-)configured UL resource(s) and/or (pre-)configuration of UL resource(s) or resource allocation(s) as specified, described or discussed in (a-1), and/or UE's autonomous determination or selection of UL resource(s) or resource allocation(s) as in (a-3), which could be sent to the network via various UL channels/signals.

For Mode-C, the UE could transmit or send or indicate to the network, in/by/via the second channel(s)/signal(s), the (early) triggered SRS(s) according to or based on one or more of the followings.
In one example, the UE could transmit or send or indicate to the network the second channel(s)/signal(s) carrying or conveying the (early) triggered SRS(s) using or via a/the most recent in time and/or available UL resource(s) a minimum time T_3 from the end (or start) of the first triggering channel(s)/signal(s).
In another example, the symbol or slot or subframe or frame used by a UE to transmit the (early) triggered SRS(s) could be a/the most recent in time and/or available UL resource(s) at or after a time T_3 from the end (or start) of the first triggering channel(s)/signal(s).
In another example, the symbol or slot or subframe or frame used by a UE to transmit the (early) triggered SRS(s) could be that first symbol or slot or subframe or frame that starts at or after a time T_3 from the end (or start) of the first triggering channel(s)/signal(s) and optionally based on a time offset/gap.

The time T_3 and/or the time offset/gap could be in number of symbol(s), slot(s), subframe(s), frame(s) and/or etc. Furthermore, the UE could determine or identify the value(s) of the time T_3 and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_3 and/or the time offset/gap could be indicated or provided by/in a DCI format.
For example, one or more new DCI fields in the DCI format could indicate or provide the value(s) of the time T_3 and/or the time offset/gap.
For another example, one or more existing DCI fields in the DCI format could be repurposed to indicate or provide the value(s) of the time T_3 and/or the time offset/gap.

The value(s) of the time T_3 and/or the time offset/gap could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationSRS_PresentInDCI. In this case, when/if the higher layer parameter/signaling timeIndicationSRS_PresentInDCI is provided/configured and/or set to ‘enabled’ or ‘on’, the value(s) of the time T_3 and/or the time offset/gap as specified/defined herein in the present disclosure could be present in the corresponding DCI format(s); otherwise, i.e., when/if the higher layer parameter/signaling timeIndicationSRS_PresentInDCI is not provided/configured and/or set to ‘disabled’ or ‘off’, the value(s) of the time T_3 and/or the time offset/gap as specified/defined herein in the present disclosure may not be present or could be absent in the corresponding DCI format(s).

When the design procedure(s), option(s) and example(s) in (a-1), (a-2) and/or (a-3) apply to Mode-C, the third channel(s)/signal(s)—used to carry or convey the early triggered SRS(s) for Mode-A/B—in (a-1), (a-2) and/or (a-3) could correspond to or could be replaced by or could be equivalent to the second channel(s)—used to carry or convey the early triggered SRS(s) for Mode-C.

The UE could indicate or send or transmit to the network, e.g., in their corresponding capability signaling(s), whether they are capable of supporting Mode-A, Mode-B and/or Mode-C. For instance, the corresponding capability signaling(s) could comprise one or more and/or a combination of one or more of the following components, wherein Component-1, Component-2 and/or Component-3 could be basic UE's capability/feature:
Component-1: support of Mode-A
Component-2: support of Mode-B
Component-3: support of Mode-C

In this case, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of Mode-A, Mode-B and Mode-C is enabled for the UE to transmit (early) triggered SRS(s). For instance, when/if a UE is provided by a higher layer parameter enableModeAforEarlySRS and/or set to ‘enabled’, the UE could follow those specified/defined in Mode-A in the present disclosure for the (early) triggering of the SRS transmission(s). When/if a UE is provided by a higher layer parameter enableModeACforEarlySRS and/or set to ‘enabled’, the UE could follow those specified/defined in Mode-A and/or Mode-C in the present disclosure for the (early) triggering of the SRS transmission(s).

The UE could indicate or send or transmit to the network, e.g., in their corresponding capability signaling(s), whether they are capable of supporting (i) dynamic scheduling/indication of SRS resource(s) to transmit the (early) triggered SRS(s) and/or (ii) (pre-)configuration of SRS resource(s) to transmit the (early) triggered SRS(s). For instance, the corresponding capability signaling(s) could comprise one or more and/or a combination of one or more of the following components, wherein Component-A, Component-B could be basic UE's capability/feature:
Component-A: support of dynamic scheduling/indication of SRS resource(s) to transmit the (early) triggered SRS(s)—or equivalently, Mode-A and/or Mode-B
Component-B: support of (pre-)configuration of SRS resource(s) to transmit the (early) triggered SRS(s)—or equivalently, Mode-A and/or Mode-C

In this case, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of (i) and (ii) as specified/described herein is enabled for the UE to transmit (early) triggered SRS(s). For instance, when/if a UE is provided by a higher layer parameter enableDynamicSchedulingforEarlySRS and/or set to ‘enabled’, the UE could follow those specified/defined in Mode-A and/or Mode-B in the present disclosure for the (early) triggering of the SRS transmission(s). When/if a UE is provided by a higher layer parameter enablePreConfigurationforEarlySRS and/or set to ‘enabled’, the UE could follow those specified/defined in Mode-A and/or Mode-C in the present disclosure for the (early) triggering of the SRS transmission(s).

As specified/defined herein in the present disclosure, for Mode-A and Mode-B, a UE could be indicated, provided or configured by the network, e.g., via higher layer RRC signaling(s)/parameter(s) and/or MAC CE command(s) and/or dynamic DCI based L1 signaling(s) based on or according to a corresponding UE's capability or capability signaling, UL resource(s) or resource allocation(s)—as in (a-2) in the present disclosure—for the (early) triggered SRS transmission(s). For instance, the UE could receive from the network, in/via/by one or more first resource allocation/indication channels/signals, one or more first resource indicators to indicate or provide UL resource(s) or resource allocation(s)—as in (a-2) in the present disclosure—for the (early) triggered SRS transmission(s).

For Mode-A, the UE could additionally receive from the network, in/via/by one or more fourth channels/signals, one or more third indicators to indicate or provide UL resource(s) or resource allocation(s) for the (early) triggered SRS transmission(s). The UE could determine or identify the one or more fourth channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the fourth channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more third indicators could be present or absent in their corresponding fourth channel(s)/signal(s) according to network's configuration or indication (e.g., via RRC signaling(s)/configuration(s)). For instance, the UE could be provided or indicated or configured by the network a higher layer parameter/signaling denoted by earlySRSRa_PresentInDCI. In this case, when/if the higher layer parameter/signaling earlySRSRa_PresentInDCI is provided/configured and/or set to ‘enabled’ or ‘on’, the third indicator(s) as specified/defined herein in the present disclosure could be present in the corresponding DCI format(s) as specified/defined in Option-1 following those specified herein in the present disclosure; otherwise, i.e., when/if the higher layer parameter/signaling earlySRSRa_PresentInDCI is not provided/configured and/or set to ‘disabled’ or ‘off’, the third indicator(s) as specified/defined herein in the present disclosure may not be present or could be absent in the corresponding DCI format(s) as specified/defined in Option-1 according to those specified herein in the present disclosure. The one or more fourth channels/signals could be the same as or identical to the one or more second channels/signals in Mode-A; optionally, the one or more fourth channels/signals could be different or separate from the one or more second channels/signals in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more fourth channels/signals are the same as or identical to the one or more second channels/signals in Mode-A, the one or more third indicators could be the same as or identical to the one or more second indicators in Mode-A; optionally, the one or more third indicators could be different or separate from the one or more second indicators in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In this case (Mode-A), the one or more fourth channels/signals (or the one or more second channels/signals when/if the one or more fourth channels/signals are the same as or identical to the one or more second channels/signals) could correspond to the one or more first resource allocation/indication channels/signals, and the one or more third indicators (or the one or more second indicators when/if the one or more third indicators are the same as or identical to the one or more second indicators) could correspond to the one or more first resource indicators.

For Mode-B, the one or more second channels/signals could correspond to the one or more first resource allocation/indication channels/signals, and the one or more second indicators could correspond to the one or more first resource indicators.

Hence, for both Mode-A and Mode-B,
For Option-1 specified/defined herein in the present disclosure, the one or more first resource indicators could correspond to or could be provided/indicated in/by one or more new DCI fields in the DCI format(s), or one or more existing DCI fields (e.g., SRS request field in DCI format 0_1/1_1/2_3) in the DCI format(s) repurposed for indicating or providing resource allocation(s) for the (early) triggered SRS transmission(s).
For Option-2 specified/defined herein in the present disclosure, the higher layer message could carry, convey, include or comprise the one or more first resource indicators as specified/defined herein in the present disclosure.
For Option-3 specified/defined herein in the present disclosure, the PO(s)/PEI could comprise, contain, include, convey or carry the one or more first resource indicators as specified/defined herein in the present disclosure.
For Option-4 specified/defined herein in the present disclosure, the RAR (e.g., Msg2) could also include, comprise, carry or convey the one or more first resource indicators as specified/defined herein in the present disclosure. Optionally, the contention resolution message (e.g., Msg4) could also include, comprise, carry or convey the one or more first resource indicators as specified/defined herein in the present disclosure. Alternatively, the MsgB (or the success RAR or fall back RAR) could include, comprise, carry or convey the one or more first resource indicators as specified/defined herein in the present disclosure.

The one or more first resource indicators could be present or absent in their corresponding first resource allocation/indication channel(s)/signal(s) according to network's configuration or indication (e.g., via RRC signaling(s)/configuration(s)). For instance, the UE could be provided or indicated or configured by the network a higher layer parameter/signaling denoted by earlySRSRa_PresentInDCI. In this case, when/if the higher layer parameter/signaling earlySRSRa_PresentInDCI is provided/configured and/or set to ‘enabled’ or ‘on’, the first resource indicator(s) as specified/defined herein in the present disclosure could be present in the corresponding DCI format(s) as specified/defined in Option-1 following those specified herein in the present disclosure; otherwise, i.e., when/if the higher layer parameter/signaling earlySRSRa_PresentInDCI is not provided/configured and/or set to ‘disabled’ or ‘off’, the first resource indicator(s) as specified/defined herein in the present disclosure may not be present or could be absent in the corresponding DCI format(s) as specified/defined in Option-1 according to those specified herein in the present disclosure.

In one example, the higher layer parameter(s)/signaling(s) including SIB1, SIB2, RRCRelease-IEs as specified/defined herein could provide or indicate or comprise multiple or more than one (K_early>1) SRS resource configurations for the early triggering of the SRS transmission(s), wherein each of the SRS resource configurations could be provided by EarlySRS-Config, and could comprise or provide or include or configure one or more SRS resource sets each provided by EarlySRS-ResourceSet and comprising, providing or configuring one or more SRS resources each provided by EarlySRS-Resource. For this design example, the one or more first resource indicators could correspond to or comprise, or could be in form/terms of one or more of:
A bitmap of length K_early with each entry/bit position of the bitmap associated/corresponding/specific to a SRS resource configuration provided by EarlySRS-Config for the early triggering of the SRS transmission(s). In this case, when/if an entry/bit position of the bitmap is set to ‘1’ (or ‘0’), the SRS resource configuration associated/corresponding/specific to the entry/bit position could be used/applied (by the UE) for determining or identifying the SRS resource(s) and the corresponding parameter(s)/setting(s) to transmit the (early) triggered SRS(s). For Option-1, the bitmap could be provided or indicated by a new DCI field in the corresponding DCI format(s).
One or more one-bit flag indicators each associated/corresponding/specific to a SRS resource configuration provided by EarlySRS-Config for the early triggering of the SRS transmission(s). In this case, when/if a one-bit flag indicator is set to ‘1’ (or ‘0’), the SRS resource configuration associated/corresponding/specific to the one-bit flag indicator could be used/applied (by the UE) for determining or identifying the SRS resource(s) and the corresponding parameter(s)/setting(s) to transmit the (early) triggered SRS(s). For Option-1, the one or more one-bit flag indicators could be provided or indicated by one or more new DCI fields in the corresponding DCI format(s).
A x0-bit indicator with x0=┌log₂(K_early)┐: each codepoint/state of the x0-bit indicator could be associated/corresponding/specific to a SRS resource configuration provided by EarlySRS-Config for the early triggering of the SRS transmission(s). In this case, when a codepoint/state of the x0-bit indicator is indicated, the SRS resource configuration associated/corresponding/specific to the codepoint/state of the x0-bit indicator could be used/applied (by the UE) for determining or identifying the SRS resource(s) and the corresponding parameter(s)/setting(s) to transmit the (early) triggered SRS(s). For Option-1, the x0-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=4 SRS resource configurations for the early triggering of the SRS transmission(s), wherein each of the SRS resource configurations could be provided by EarlySRS-Config; for this design example, x0=2 with codepoint/state ‘00’ indicating the first SRS resource configuration or the SRS resource configuration with the lowest configuration ID/index value, codepoint/state ‘01’ indicating the second SRS resource configuration or the SRS resource configuration with the second lowest configuration ID/index value, codepoint/state ‘10’ indicating the third SRS resource configuration or the SRS resource configuration with the second highest configuration ID/index value, and codepoint/state ‘11’ indicating the fourth SRS resource configuration or the SRS resource configuration with the highest configuration ID/index value.
One or more SRS resource configuration IDs/ID values. In this case, the SRS resource configuration(s) with or having the one or more SRS resource configuration IDs/ID values could be used/applied (by the UE) for determining or identifying the SRS resource(s) and the corresponding parameter(s)/setting(s) to transmit the (early) triggered SRS(s). For Option-1, the one or more SRS resource configuration IDs/ID values could be provided or indicated by one or more new DCI fields in the corresponding DCI format(s).
One or more indexes or index values denoted by k_1, . . . , k_x with each index or index value belonging to {1, . . . , K_early} or {0, . . . , K_early−1}, i.e., k_1, . . . , k_x∈{1, . . . , K_early} or {0, . . . , K_early−1}. In this case, the k_1-th, . . . , k_x-th SRS resource configuration(s) among the configured/provided K_early SRS resource configurations (e.g., with their resource configuration IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more indexes or index values could be provided or indicated by one or more new DCI fields in the corresponding DCI format(s).
One or more trigger states each pointing/corresponding to an entry in a list of aperiodic SRS resource trigger states provided by aperiodicSRS-ResourceTrigger or aperiodicSRS-ResourceTriggerList. In this case, the SRS resource configuration(s) corresponding/associated/specific to the one or more trigger states could be used/applied (by the UE) for determining or identifying the SRS resource(s) and the corresponding parameter(s)/setting(s) to transmit the (early) triggered SRS(s). For Option-1, the one or more trigger states could be provided or indicated by one or more SRS request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise K_early>1 groups of PRACH preambles with each group corresponding/specific to a SRS resource configuration provided by EarlySRS-Config according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , K_early} or {0, . . . , K_early−1}), the x-th SRS resource configuration among the configured/provided K_early SRS resource configurations (e.g., with their resource configuration IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the K_early>1 subgroups of a PO such that each subgroup of the PO could be associated/corresponding/specific to a SRS resource configuration provided by EarlySRS-Config according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , K_early} or {0, . . . , K_early−1}), the x-th SRS resource configuration among the configured/provided K_early SRS resource configurations (e.g., with their resource configuration IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more subgroup indexes of the PO could be provided or indicated by one or more new DCI fields in the corresponding DCI format(s).
Information related to one or more SRS resource configurations. The UE could determine or identify the association(s)/mapping(s) between the information and the one or more SRS resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more SRS resource configurations corresponding/associated/specific to the information could be used/applied (by the UE) for determining or identifying the SRS resource(s) and the corresponding parameter(s)/setting(s) to transmit the (early) triggered SRS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the K_early SRS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early SRS resource configurations, a mapping between the one or more UE IDs and resources used for reception of the PDCCH providing the DCI format as mentioned herein, and the K_early SRS resource configurations and/or etc. For Option-1, the information could be provided or indicated by one or more new DCI fields in the corresponding DCI format(s).

When/if the first resource indicator(s) is absent or not present in the corresponding first resource allocation/indication channel(s)/signal(s) according to or following those specified herein in the present disclosure, the UE (e.g., the UE 116) could determine the SRS resource configuration(s), and therefore the corresponding SRS resource(s) along with its associated parameter(s)/setting(s), to use/apply for transmitting the (early) triggered SRS(s) according to or based on fixed rule(s) in system specification(s) and/or per RRC (re-)configuration/setup. In this case, for example, the K_early SRS resource configurations provided/configured for the early triggering of the SRS transmission(s) could be used/applied (by the UE) for determining or identifying the SRS resource(s) and the corresponding parameter(s)/setting(s) to transmit the (early) triggered SRS(s); for another example, the first (or last) SRS resource configuration or the SRS resource configuration with the lowest (or highest) configuration ID/index value, e.g., among the K_early SRS resource configurations provided/configured for the early triggering of the SRS transmission(s), could be used/applied (by the UE) for determining or identifying the SRS resource(s) and the corresponding parameter(s)/setting(s) to transmit the (early) triggered SRS(s).

In one example, the higher layer parameter(s)/signaling(s) including SIB1, SIB2, RRCRelease-IEs as specified/defined herein could provide or indicate or comprise one (K_early=1) SRS resource configuration for the early triggering of the SRS transmission(s), wherein the SRS resource configuration could be provided by EarlySRS-Config, and could comprise, provide or configure multiple or more than one (L_early>1) SRS resource sets each provided by EarlySRS-ResourceSet and comprising, providing or configuring one or more SRS resources each provided by EarlySRS-Resource. For this design example, the one or more first resource indicators could correspond to or comprise, or could be in form/terms of one or more of:
A bitmap of length L_early with each entry/bit position of the bitmap associated/corresponding/specific to a SRS resource set provided by EarlySRS-ResourceSet for the early triggering of the SRS transmission(s). In this case, when/if an entry/bit position of the bitmap is set to ‘1’ (or ‘0’), the SRS resource set associated/corresponding/specific to the entry/bit position could be used/applied (by the UE) for determining or identifying the SRS resource(s) and the corresponding parameter(s)/setting(s) to transmit the (early) triggered SRS(s). For Option-1, the bitmap could be provided or indicated by a new DCI field in the corresponding DCI format(s).
One or more one-bit flag indicators each associated/corresponding/specific to a SRS resource set provided by EarlySRS-ResourceSet for the early triggering of the SRS transmission(s). In this case, when/if a one-bit flag indicator is set to ‘1’ (or ‘0’), the SRS resource set associated/corresponding/specific to the one-bit flag indicator could be used/applied (by the UE) for determining or identifying the SRS resource(s) and the corresponding parameter(s)/setting(s) to transmit the (early) triggered SRS(s). For Option-1, the one or more one-bit flag indicators could be provided or indicated by one or more new DCI fields in the corresponding DCI format(s).
A x1-bit indicator with x1=┌log₂(L_early)┐: each codepoint/state of the x1-bit indicator could be associated/corresponding/specific to a SRS resource set provided by EarlySRS-ResourceSet for the early triggering of the SRS transmission(s). In this case, when a codepoint/state of the x1-bit indicator is indicated, the SRS resource set associated/corresponding/specific to the codepoint/state of the x1-bit indicator could be used/applied (by the UE) for determining or identifying the SRS resource(s) and the corresponding parameter(s)/setting(s) to transmit the (early) triggered SRS(s). For Option-1, the x1-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=1 SRS resource configuration comprising or providing or configuring L_early=4 SRS resource sets for the early triggering of the SRS transmission(s), wherein each of the SRS resource sets could be provided by EarlySRS-ResourceSet; for this design example, x1=2 with codepoint/state ‘00’ indicating the first SRS resource set or the SRS resource set with the lowest set ID/index value, codepoint/state ‘01’ indicating the second SRS resource set or the SRS resource set with the second lowest set ID/index value, codepoint/state ‘10’ indicating the third SRS resource set or the SRS resource set with the second highest set ID/index value, and codepoint/state ‘11’ indicating the fourth SRS resource set or the SRS resource set with the highest set ID/index value.
One or more SRS resource set IDs/ID values. In this case, the SRS resource set(s) with or having the one or more SRS resource set IDs/ID values could be used/applied (by the UE) for determining or identifying the SRS resource(s) and the corresponding parameter(s)/setting(s) to transmit the (early) triggered SRS(s). For Option-1, the one or more SRS resource set IDs/ID values could be provided or indicated by one or more new DCI fields in the corresponding DCI format(s).
One or more indexes or index values denoted by l_1, . . . , l_x with each index or index value belonging to {1, . . . , L_early} or {0, . . . , L_early−1}, i.e., l_1, . . . , 1_x∈{1, . . . , L_early} or {0, . . . , L_early−1}. In this case, the l_1-th, . . . , l_x-th SRS resource set(s) among the configured/provided L_early SRS resource sets (e.g., with their resource set IDs/ID values ordered from low to high or from high to low) in the SRS resource configuration could be used/applied (by the UE) for determining or identifying the SRS resource(s) and the corresponding parameter(s)/setting(s) to transmit the (early) triggered SRS(s). For Option-1, the one or more indexes or index values could be provided or indicated by one or more new DCI fields in the corresponding DCI format(s).
One or more trigger states each pointing/corresponding to an entry in a list of aperiodic SRS resource trigger states provided by aperiodicSRS-ResourceTrigger or aperiodicSRS-ResourceTriggerList. In this case, the SRS resource set(s) corresponding/associated/specific to the one or more trigger states could be used/applied (by the UE) for determining or identifying the SRS resource(s) and the corresponding parameter(s)/setting(s) to transmit the (early) triggered SRS(s). For Option-1, the one or more trigger states could be provided or indicated by one or more SRS request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise L_early>1 groups of PRACH preambles with each group corresponding/specific to a SRS resource set provided by EarlySRS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , L_early} or {0, . . . , L_early−1}), the x-th SRS resource set among the configured/provided L_early SRS resource sets (e.g., with their resource set IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the L_early>1 subgroups of a PO such that each subgroup of the PO could be associated/corresponding/specific to a SRS resource set provided by EarlySRS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , L_early} or {0, . . . , L_early−1}), the x-th SRS resource set among the configured/provided L_early SRS resource sets (e.g., with their resource set IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more subgroup indexes of the PO could be provided or indicated by one or more new DCI fields in the corresponding DCI format(s).
Information related to one or more SRS resource sets. The UE could determine or identify the association(s)/mapping(s) between the information and the one or more SRS resource sets according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more SRS resource sets corresponding/associated/specific to the information could be used/applied (by the UE) for determining or identifying the SRS resource(s) and the corresponding parameter(s)/setting(s) to transmit the (early) triggered SRS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the L_early SRS resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early SRS resource sets, a mapping between the one or more UE IDs and resources used for reception of the PDCCH providing the DCI format as mentioned herein, and the L_early SRS resource sets and/or etc. For Option-1, the information could be provided or indicated by one or more new DCI fields in the corresponding DCI format(s).

When/if the first resource indicator(s) is absent or not present in the corresponding first resource allocation/indication channel(s)/signal(s) according to or following those specified herein in the present disclosure, the UE could determine the SRS resource set(s), and therefore the corresponding SRS resource(s) along with its associated parameter(s)/setting(s), to use/apply for transmitting the (early) triggered SRS(s) according to or based on fixed rule(s) in system specification(s) and/or per RRC (re-)configuration/setup. In this case, for example, the L_early SRS resource sets provided/configured in the SRS resource configuration for the early triggering of the SRS transmission(s) could be used/applied (by the UE) for determining or identifying the SRS resource(s) and the corresponding parameter(s)/setting(s) to transmit the (early) triggered SRS(s); for another example, the first (or last) SRS resource set or the SRS resource set with the lowest (or highest) set ID/index value, e.g., among the L_early SRS resource sets provided/configured for the early triggering of the SRS transmission(s), could be used/applied (by the UE) for determining or identifying the SRS resource(s) and the corresponding parameter(s)/setting(s) to transmit the (early) triggered SRS(s).

In one example, the higher layer parameter(s)/signaling(s) including SIB1, SIB2, RRCRelease-IEs as specified/defined herein could provide or indicate or comprise one (K_early=1) SRS resource configuration for the early triggering of the SRS transmission(s), wherein the SRS resource configuration could be provided by EarlySRS-Config, and could comprise, provide or configure one (L_early=1) SRS resource set provided by EarlySRS-ResourceSet and comprising, providing or configuring multiple or more than one (N_early>1) SRS resources each provided by EarlySRS-Resource. For this design example, the one or more first resource indicators could correspond to or comprise, or could be in form/terms of one or more of:
A bitmap of length N_early with each entry/bit position of the bitmap associated/corresponding/specific to a SRS resource provided by EarlySRS-Resource for the early triggering of the SRS transmission(s). In this case, when/if an entry/bit position of the bitmap is set to ‘1’ (or ‘0’), the SRS resource associated/corresponding/specific to the entry/bit position could be used/applied (by the UE) for determining or identifying the SRS resource(s) and the corresponding parameter(s)/setting(s) to transmit the (early) triggered SRS(s). For Option-1, the bitmap could be provided or indicated by a new DCI field in the corresponding DCI format(s).
One or more one-bit flag indicators each associated/corresponding/specific to a SRS resource provided by EarlySRS-Resource for the early triggering of the SRS transmission(s). In this case, when/if a one-bit flag indicator is set to ‘1’ (or ‘0’), the SRS resource associated/corresponding/specific to the one-bit flag indicator could be used/applied (by the UE) for determining or identifying the SRS resource(s) and the corresponding parameter(s)/setting(s) to transmit the (early) triggered SRS(s). For Option-1, the one or more one-bit flag indicators could be provided or indicated by one or more new DCI fields in the corresponding DCI format(s).
A x2-bit indicator with x2=┌log₂(N_early)┐: each codepoint/state of the x2-bit indicator could be associated/corresponding/specific to a SRS resource provided by EarlySRS-Resource for the early triggering of the SRS transmission(s). In this case, when a codepoint/state of the x2-bit indicator is indicated, the SRS resource associated/corresponding/specific to the codepoint/state of the x2-bit indicator could be used/applied (by the UE) for determining or identifying the SRS resource(s) and the corresponding parameter(s)/setting(s) to transmit the (early) triggered SRS(s). For Option-1, the x2-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=1 SRS resource configuration comprising or providing or configuring L_early=1 SRS resource set comprising or providing or configuring N_early>1 SRS resources for the early triggering of the SRS transmission(s), wherein each of the SRS resources could be provided by EarlySRS-Resource; for this design example, x2=2 with codepoint/state ‘00’ indicating the first SRS resource or the SRS resource with the lowest resource ID/index value, codepoint/state ‘01’ indicating the second SRS resource or the SRS resource with the second lowest resource ID/index value, codepoint/state ‘10’ indicating the third SRS resource or the SRS resource with the second highest resource ID/index value, and codepoint/state ‘11’ indicating the fourth SRS resource or the SRS resource with the highest resource ID/index value.
One or more SRS resource IDs/ID values. In this case, the SRS resource(s) with or having the one or more SRS resource IDs/ID values could be used/applied (by the UE) for determining or identifying the SRS resource(s) and the corresponding parameter(s)/setting(s) to transmit the (early) triggered SRS(s). For Option-1, the one or more SRS resource IDs/ID values could be provided or indicated by one or more new DCI fields in the corresponding DCI format(s).
One or more indexes or index values denoted by n_1, . . . , n_x with each index or index value belonging to {1, . . . , N_early} or {0, . . . , N_early−1}, i.e., n_1, . . . , n_x∈{1, . . . , N_early} or {0, . . . , N_early−1}. In this case, the n_1-th, . . . , n_x-th SRS resource(s) among the configured/provided N_early SRS resources (e.g., with their resource IDs/ID values ordered from low to high or from high to low) in the SRS resource set/configuration could be used/applied (by the UE) for determining or identifying the SRS resource(s) and the corresponding parameter(s)/setting(s) to transmit the (early) triggered SRS(s). For Option-1, the one or more indexes or index values could be provided or indicated by one or more new DCI fields in the corresponding DCI format(s).
One or more trigger states each pointing/corresponding to an entry in a list of aperiodic SRS resource trigger states provided by aperiodicSRS-ResourceTrigger or aperiodicSRS-ResourceTriggerList. In this case, the SRS resource(s) corresponding/associated/specific to the one or more trigger states could be used/applied (by the UE) for determining or identifying the SRS resource(s) and the corresponding parameter(s)/setting(s) to transmit the (early) triggered SRS(s). For Option-1, the one or more trigger states could be provided or indicated by one or more SRS request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise N_early>1 groups of PRACH preambles with each group corresponding/specific to a SRS resource provided by EarlySRS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , N_early} or {0, . . . , N_early−1}), the x-th SRS resource among the configured/provided N_early SRS resources (e.g., with their resource IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the N_early>1 subgroups of a PO such that each subgroup of the PO could be associated/corresponding/specific to a SRS resource provided by EarlySRS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , N_early} or {0, . . . , N_early−1}), the x-th SRS resource among the configured/provided N_early SRS resources (e.g., with their resource IDs/ID values ordered from low to high or from high to low) could be used/applied (by the UE) for determining or identifying the SRS resource(s) and the corresponding parameter(s)/setting(s) to transmit the (early) triggered SRS(s). For Option-1, the one or more subgroup indexes of the PO could be provided or indicated by one or more new DCI fields in the corresponding DCI format(s).
Information related to one or more SRS resources. The UE could determine or identify the association(s)/mapping(s) between the information and the one or more SRS resources according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more SRS resources corresponding/associated/specific to the information could be used/applied (by the UE) for determining or identifying the SRS resource(s) and the corresponding parameter(s)/setting(s) to transmit the (early) triggered SRS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the N_early SRS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the N_early SRS resources, a mapping between the one or more UE IDs and resources used for reception of the PDCCH providing the DCI format as mentioned herein, and the N_early SRS resources, and/or etc. For Option-1, the information could be provided or indicated by one or more new DCI fields in the corresponding DCI format(s).

When/if the first resource indicator(s) is absent or not present in the corresponding first resource allocation/indication channel(s)/signal(s) according to or following those specified herein in the present disclosure, the UE could determine the SRS resource(s), and therefore the corresponding parameter(s)/setting(s), to use/apply for transmitting the (early) triggered SRS(s) according to or based on fixed rule(s) in system specification(s) and/or per RRC (re-)configuration/setup. In this case, for example, the N_early SRS resources provided/configured in the SRS resource set/configuration for the early triggering of the SRS transmission(s) could be used/applied (by the UE) for determining or identifying the SRS resource(s) and the corresponding parameter(s)/setting(s) to transmit the (early) triggered SRS(s); for another example, the first (or last) SRS resource or the SRS resource with the lowest (or highest) resource ID/index value, e.g., among the N_early SRS resources provided/configured for the early triggering of the SRS transmission(s), could be used/applied (by the UE) for determining or identifying the SRS resource(s) and the corresponding parameter(s)/setting(s) to transmit the (early) triggered SRS(s).

As specified/defined herein in the present disclosure, for Mode-A and Mode-C, a UE could autonomously determine or identify or select which one or more of the configured/provided SRS resource configurations (and therefore, the corresponding SRS resource set(s)/SRS resource(s) provided/configured therein) for the early triggering of the SRS transmission(s) as specified/defined herein in the present disclosure, which one or more of the configured/provided SRS resource sets (and therefore, the corresponding SRS resource(s) provided/configured therein) for the early triggering of the SRS transmission(s) as specified/defined herein in the present disclosure, and/or which one or more of the configured/provided SRS resources for the early triggering of the SRS transmission(s) as specified/defined herein in the present disclosure, to use/apply for determining or identifying the SRS resource(s) and the corresponding parameter(s)/setting(s) to transmit the (early) triggered SRS(s). The UE could be indicated or provided or configured by the network, e.g., via higher layer RRC signaling(s)/parameter(s) and/or MAC CE command(s) and/or dynamic DCI based L1 signaling(s) based on or according to a corresponding UE's capability or capability signaling, whether or not the UE could autonomously determine, identify or select the SRS resource(s)—and therefore the corresponding parameter(s)/setting(s)—to transmit the (early) triggered SRS(s); for instance, when/if the UE is provided or configured by the network (e.g., the network 130) a higher layer parameter ueSelectSRSResource and/or set to ‘enabled’ based on or according to a corresponding UE's capability/capability signaling, the UE could autonomously determine or identify or select the SRS resource(s) for the early triggering of the SRS transmission(s) as specified/defined herein in the present disclosure. Optionally, when/if the first resource indicator(s) as specified/defined herein in the present disclosure is absent or not present in the corresponding first resource allocation/indication channel(s)/signal(s) according to or following those specified herein in the present disclosure, the UE could autonomously determine or identify or select the SRS resource(s) for the early triggering of the SRS transmission(s) as specified/defined herein in the present disclosure. In this case—as in (a-3) in the present disclosure, for Mode-A and Mode-C, the UE could transmit or send to the network, in/via/by one or more second resource indication channels/signals, one or more second resource indicators to indicate their autonomous determination, identification or selection of the SRS resource(s) for the early triggering of the SRS transmission(s) as specified/defined herein.

For Mode-A and/or Mode-C, the UE could additionally transmit or send to the network, in/via/by one or more fifth channels/signals, one or more fourth indicators to indicate or provide UL resource(s) or resource allocation(s) for the (early) triggered SRS transmission(s). the UE could determine or identify the one or more fifth channels/signals based on or according to one or more of Alt-1, Alt-2, . . . , Alt-10 as specified/defined herein in the present disclosure for Mode-A. The UE (e.g., the UE 116) could determine or identify which one or more of the Alt-1, Alt-2, . . . , Alt-10 to use or follow or apply to determine or identify the fifth channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, when/if the UE could autonomously determine or identify or select the SRS resource(s) for the early triggering of the SRS transmission(s) as specified/defined herein in the present disclosure (e.g., enabled by the network and/or based on/according to absence of the first resource indicator(s) in the first resource indication/allocation channel(s)/signal(s)), the UE could transmit or send to the network, in the fifth channel(s)/signal(s), the fourth indicator(s) as specified/defined herein in the present disclosure; otherwise, i.e., when/if the UE may not autonomously determine or identify or select the SRS resource(s) for the early triggering of the SRS transmission(s) as specified/defined herein in the present disclosure (e.g., not enabled or disabled by the network and/or the first resource indicator(s) is present in the corresponding first resource indication/allocation channel(s)/signal(s)), the fourth indicator(s) as specified/defined herein in the present disclosure may not be present or could be absent in the corresponding fifth channel(s)/signal(s) and/or the fifth channel(s)/signal(s) may not be present or could be absent according to those specified herein in the present disclosure. The one or more fifth channels/signals could be the same as or identical to the one or more first channels/signals in Mode-A/Mode-C; optionally, the one or more fifth channels/signals could be different or separate from the one or more first channels/signals in Mode-A/Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more fifth channels/signals are the same as or identical to the one or more first channels/signals in Mode-A/Mode-C, the one or more fourth indicators could be the same as or identical to the one or more first indicators in Mode-A/Mode-C; optionally, the one or more fourth indicators could be different or separate from the one or more first indicators in Mode-A/Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In this case (Mode-A/Mode-C), the one or more fifth channels/signals (or the one or more first channels/signals when/if the one or more fifth channels/signals are the same as or identical to the one or more first channels/signals) could correspond to the one or more second resource indication channels/signals, and the one or more fourth indicators (or the one or more first indicators when/if the one or more fourth indicators are the same as or identical to the one or more first indicators) could correspond to the one or more second resource indicators.

For Mode-A and/or Mode-C, the UE could additionally transmit or send to the network, in/via/by one or more fifth channels/signals, one or more fourth indicators to indicate or provide UL resource(s) or resource allocation(s) for the (early) triggered SRS transmission(s). the UE could determine or identify the one or more fifth channels/signals based on or according to one or more of Alt-A, Alt-B, . . . , Alt-G as specified/defined herein in the present disclosure for Mode-A. The UE could determine or identify which one or more of the Alt-A, Alt-B, . . . , Alt-G to use or follow or apply to determine or identify the fifth channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, when/if the UE could autonomously determine or identify or select the SRS resource(s) for the early triggering of the SRS transmission(s) as specified/defined herein in the present disclosure (e.g., enabled by the network and/or based on/according to absence of the first resource indicator(s) in the first resource indication/allocation channel(s)/signal(s)), the UE could transmit or send to the network, in the fifth channel(s)/signal(s), the fourth indicator(s) as specified/defined herein in the present disclosure; otherwise, i.e., when/if the UE may not autonomously determine or identify or select the SRS resource(s) for the early triggering of the SRS transmission(s) as specified/defined herein in the present disclosure (e.g., not enabled or disabled by the network and/or the first resource indicator(s) is present in the corresponding first resource indication/allocation channel(s)/signal(s)), the fourth indicator(s) as specified/defined herein in the present disclosure may not be present or could be absent in the corresponding fifth channel(s)/signal(s) and/or the fifth channel(s)/signal(s) may not be present or could be absent according to those specified herein in the present disclosure. The one or more fifth channels/signals could be the same as or identical to the one or more third channels/signals in Mode-A and/or the one or more second channels/signals in Mode-C; optionally, the one or more fifth channels/signals could be different or separate from the one or more third channels/signals in Mode-A and/or the one or more second channels/signals in Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the one or more fourth indicators could be the same as or identical to or could have the same form as the one or more first indicators in Mode-A/Mode-C; optionally, the one or more fourth indicators could be different or separate from the one or more first indicators in Mode-A/Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In this case (Mode-A/Mode-C), the one or more fifth channels/signals (or the one or more third channels/signals when/if the one or more fifth channels/signals are the same as or identical to the one or more third channels/signals in Mode-A, or the one or more second channels/signals when/if the one or more fifth channels/signals are the same as or identical to the one or more second channels/signals in Mode-C) could correspond to the one or more second resource indication channels/signals, and the one or more fourth indicators (or the one or more first indicators in Mode-A/Mode-C) could correspond to the one or more second resource indicators.

In one example, the higher layer parameter(s)/signaling(s) including SIB1, SIB2, RRCRelease-IEs as specified/defined herein could provide or indicate or comprise multiple or more than one (K_early>1) SRS resource configurations for the early triggering of the SRS transmission(s), wherein each of the SRS resource configurations could be provided by EarlySRS-Config, and could comprise or provide or include or configure one or more SRS resource sets each provided by EarlySRS-ResourceSet and comprising, providing or configuring one or more SRS resources each provided by EarlySRS-Resource. For this design example, the one or more second resource indicators could correspond to or comprise, or could be in form/terms of one or more of:
A bitmap of length K_early with each entry/bit position of the bitmap associated/corresponding/specific to a SRS resource configuration provided by EarlySRS-Config for the early triggering of the SRS transmission(s). In this case, when/if an entry/bit position of the bitmap is set to ‘1’ (or ‘0’), the UE could indicate to the network that the SRS resource configuration associated/corresponding/specific to the entry/bit position could be used/applied (by the UE) for determining or identifying the SRS resource(s) and the corresponding parameter(s)/setting(s) to transmit the (early) triggered SRS(s).
One or more one-bit flag indicators each associated/corresponding/specific to a SRS resource configuration provided by EarlySRS-Config for the early triggering of the SRS transmission(s). In this case, when/if a one-bit flag indicator is set to ‘1’ (or ‘0’), the UE could indicate to the network that the SRS resource configuration associated/corresponding/specific to the one-bit flag indicator could be used/applied (by the UE) for determining or identifying the SRS resource(s) and the corresponding parameter(s)/setting(s) to transmit the (early) triggered SRS(s).
A y0-bit indicator with y0=┌log₂(K_early)┐: each codepoint/state of the y0-bit indicator could be associated/corresponding/specific to a SRS resource configuration provided by EarlySRS-Config for the early triggering of the SRS transmission(s). In this case, when a codepoint/state of the y0-bit indicator is indicated, the UE could indicate to the network that the SRS resource configuration associated/corresponding/specific to the codepoint/state of the y0-bit indicator could be used/applied (by the UE) for determining or identifying the SRS resource(s) and the corresponding parameter(s)/setting(s) to transmit the (early) triggered SRS(s). For instance, the higher layer parameter(s)/signaling(s) including SIB1, SIB2, RRCRelease-IEs as specified/defined herein could provide or indicate or comprise K_early=4 SRS resource configurations for the early triggering of the SRS transmission(s), wherein each of the SRS resource configurations could be provided by EarlySRS-Config; for this design example, y0=2 with codepoint/state ‘00’ indicating the first SRS resource configuration or the SRS resource configuration with the lowest configuration ID/index value, codepoint/state ‘01’ indicating the second SRS resource configuration or the SRS resource configuration with the second lowest configuration ID/index value, codepoint/state ‘10’ indicating the third SRS resource configuration or the SRS resource configuration with the second highest configuration ID/index value, and codepoint/state ‘11’ indicating the fourth SRS resource configuration or the SRS resource configuration with the highest configuration ID/index value.
One or more SRS resource configuration IDs/ID values. In this case, the UE could indicate to the network that the SRS resource configuration(s) with or having the one or more SRS resource configuration IDs/ID values could be used/applied (by the UE) for determining or identifying the SRS resource(s) and the corresponding parameter(s)/setting(s) to transmit the (early) triggered SRS(s).
One or more indexes or index values denoted by k_1, . . . , k_y with each index or index value belonging to {1, . . . , K_early} or {0, . . . , K_early−1}, i.e., k_1, . . . , k_y∈{1, . . . , K_early} or {0, . . . , K_early−1}. In this case, the UE could indicate to the network that the k_1-th, . . . , k_y-th SRS resource configuration(s) among the configured/provided K_early SRS resource configurations (e.g., with their resource configuration IDs/ID values ordered from low to high or from high to low) could be used/applied (by the UE) for determining or identifying the SRS resource(s) and the corresponding parameter(s)/setting(s) to transmit the (early) triggered SRS(s).
One or more trigger states each pointing/corresponding to an entry in a list of aperiodic SRS resource trigger states provided by aperiodicSRS-ResourceTrigger or aperiodicSRS-ResourceTriggerList. In this case, the UE could indicate to the network that the SRS resource configuration(s) corresponding/associated/specific to the one or more trigger states could be used/applied (by the UE) for determining or identifying the SRS resource(s) and the corresponding parameter(s)/setting(s) to transmit the (early) triggered SRS(s).
One or more PRACH preambles. In this case, the higher layer parameter(s)/signaling(s) including SIB1, SIB2, RRCRelease-IEs as specified/defined herein could also provide or indicate or comprise K_early>1 groups of PRACH preambles with each group corresponding/specific to a SRS resource configuration provided by EarlySRS-Config according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , K_early} or {0, . . . , K_early−1}), the UE could indicate to the network that the y-th SRS resource configuration among the configured/provided K_early SRS resource configurations (e.g., with their resource configuration IDs/ID values ordered from low to high or from high to low) could be used/applied (by the UE) for determining or identifying the SRS resource(s) and the corresponding parameter(s)/setting(s) to transmit the (early) triggered SRS(s).
One or more subgroup indexes of a PO. In this case, the higher layer parameter(s)/signaling(s) including SIB1, SIB2, RRCRelease-IEs as specified/defined herein could also provide or indicate or comprise the K_early>1 subgroups of a PO such that each subgroup of the PO could be associated/corresponding/specific to a SRS resource configuration provided by EarlySRS-Config according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , K_early} or {0, . . . , K_early−1}), the UE could indicate to the network that the y-th SRS resource configuration among the configured/provided K_early SRS resource configurations (e.g., with their resource configuration IDs/ID values ordered from low to high or from high to low) could be used/applied (by the UE) for determining or identifying the SRS resource(s) and the corresponding parameter(s)/setting(s) to transmit the (early) triggered SRS(s).
Information related to one or more SRS resource configurations. The UE could determine or identify the association(s)/mapping(s) between the information and the one or more SRS resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more SRS resource configurations corresponding/associated/specific to the information could be used/applied (by the UE) for determining or identifying the SRS resource(s) and the corresponding parameter(s)/setting(s) to transmit the (early) triggered SRS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the K_early SRS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early SRS resource configurations, a mapping between the one or more UE IDs and resources used for reception of the PDCCH providing the DCI format as mentioned herein, and the K_early SRS resource configurations and/or etc.

In one example, the higher layer parameter(s)/signaling(s) including SIB1, SIB2, RRCRelease-IEs as specified/defined herein could provide or indicate or comprise one (K_early=1) SRS resource configuration for the early triggering of the SRS transmission(s), wherein the SRS resource configuration could be provided by EarlySRS-Config, and could comprise, provide or configure multiple or more than one (L_early>1) SRS resource sets each provided by EarlySRS-ResourceSet and comprising, providing or configuring one or more SRS resources each provided by EarlySRS-Resource. For this design example, the one or more second resource indicators could correspond to or comprise, or could be in form/terms of one or more of:
A bitmap of length L_early with each entry/bit position of the bitmap associated/corresponding/specific to a SRS resource set provided by EarlySRS-ResourceSet for the early triggering of the SRS transmission(s). In this case, when/if an entry/bit position of the bitmap is set to ‘1’ (or ‘0’), the UE could indicate to the network that the SRS resource set associated/corresponding/specific to the entry/bit position could be used/applied (by the UE) for determining or identifying the SRS resource(s) and the corresponding parameter(s)/setting(s) to transmit the (early) triggered SRS(s).
One or more one-bit flag indicators each associated/corresponding/specific to a SRS resource set provided by EarlySRS-ResourceSet for the early triggering of the SRS transmission(s). In this case, when/if a one-bit flag indicator is set to ‘1’ (or ‘0’), the UE could indicate to the network that the SRS resource set associated/corresponding/specific to the one-bit flag indicator could be used/applied (by the UE) for determining or identifying the SRS resource(s) and the corresponding parameter(s)/setting(s) to transmit the (early) triggered SRS(s).
A y1-bit indicator with y1=┌log₂(L_early)┐: each codepoint/state of the y1-bit indicator could be associated/corresponding/specific to a SRS resource set provided by EarlySRS-ResourceSet for the early triggering of the SRS transmission(s). In this case, when a codepoint/state of the y1-bit indicator is indicated, the UE could indicate to the network that the SRS resource set associated/corresponding/specific to the codepoint/state of the y1-bit indicator could be used/applied (by the UE) for determining or identifying the SRS resource(s) and the corresponding parameter(s)/setting(s) to transmit the (early) triggered SRS(s). For instance, the higher layer parameter(s)/signaling(s) including SIB1, SIB2, RRCRelease-IEs as specified/defined herein could provide or indicate or comprise K_early=1 SRS resource configuration comprising or providing or configuring L_early=4 SRS resource sets for the early triggering of the SRS transmission(s), wherein each of the SRS resource sets could be provided by EarlySRS-ResourceSet; for this design example, y1=2 with codepoint/state ‘00’ indicating the first SRS resource set or the SRS resource set with the lowest set ID/index value, codepoint/state ‘01’ indicating the second SRS resource set or the SRS resource set with the second lowest set ID/index value, codepoint/state ‘10’ indicating the third SRS resource set or the SRS resource set with the second highest set ID/index value, and codepoint/state ‘11’ indicating the fourth SRS resource set or the SRS resource set with the highest set ID/index value.
One or more SRS resource set IDs/ID values. In this case, the UE could indicate to the network that the SRS resource set(s) with or having the one or more SRS resource set IDs/ID values could be used/applied (by the UE) for determining or identifying the SRS resource(s) and the corresponding parameter(s)/setting(s) to transmit the (early) triggered SRS(s).
One or more indexes or index values denoted by l_1, . . . , l_y with each index or index value belonging to {1, . . . , L_early} or {0, . . . , L_early−1}, i.e., l_1, . . . , 1_y∈{1, . . . , L_early} or {0, . . . , L_early−1}. In this case, the UE could indicate to the network that the l_1-th, . . . , l_y-th SRS resource set(s) among the configured/provided L_early SRS resource sets (e.g., with their resource set IDs/ID values ordered from low to high or from high to low) in the SRS resource configuration could be used/applied (by the UE) for determining or identifying the SRS resource(s) and the corresponding parameter(s)/setting(s) to transmit the (early) triggered SRS(s).
One or more trigger states each pointing/corresponding to an entry in a list of aperiodic SRS resource trigger states provided by aperiodicSRS-ResourceTrigger or aperiodicSRS-ResourceTriggerList. In this case, the UE could indicate to the network that the SRS resource set(s) corresponding/associated/specific to the one or more trigger states could be used/applied (by the UE) for determining or identifying the SRS resource(s) and the corresponding parameter(s)/setting(s) to transmit the (early) triggered SRS(s).
One or more PRACH preambles. In this case, the higher layer parameter(s)/signaling(s) including SIB1, SIB2, RRCRelease-IEs as specified/defined herein could also provide or indicate or comprise L_early>1 groups of PRACH preambles with each group corresponding/specific to a SRS resource set provided by EarlySRS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , L_early} or {0, . . . , L_early−1}), the UE could indicate to the network that the y-th SRS resource set among the configured/provided L_early SRS resource sets (e.g., with their resource set IDs/ID values ordered from low to high or from high to low) could be used/applied (by the UE) for determining or identifying the SRS resource(s) and the corresponding parameter(s)/setting(s) to transmit the (early) triggered SRS(s).
One or more subgroup indexes of a PO. In this case, the higher layer parameter(s)/signaling(s) including SIB1, SIB2, RRCRelease-IEs as specified/defined herein could also provide or indicate or comprise the L_early>1 subgroups of a PO such that each subgroup of the PO could be associated/corresponding/specific to a SRS resource set provided by EarlySRS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , L_early} or {0, . . . , L_early−1}), the UE could indicate to the network that the y-th SRS resource set among the configured/provided L_early SRS resource sets (e.g., with their resource set IDs/ID values ordered from low to high or from high to low) could be used/applied (by the UE) for determining or identifying the SRS resource(s) and the corresponding parameter(s)/setting(s) to transmit the (early) triggered SRS(s).
Information related to one or more SRS resource sets. The UE could determine or identify the association(s)/mapping(s) between the information and the one or more SRS resource sets according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more SRS resource sets corresponding/associated/specific to the information could be used/applied (by the UE) for determining or identifying the SRS resource(s) and the corresponding parameter(s)/setting(s) to transmit the (early) triggered SRS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the L_early SRS resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early SRS resource sets, a mapping between the one or more UE IDs and resources used for reception of the PDCCH providing the DCI format as mentioned herein, and the L_early SRS resource sets and/or etc.

In one example, the higher layer parameter(s)/signaling(s) including SIB1, SIB2, RRCRelease-IEs as specified/defined herein could provide or indicate or comprise one (K_early=1) SRS resource configuration for the early triggering of the SRS transmission(s), wherein the SRS resource configuration could be provided by EarlySRS-Config, and could comprise, provide or configure one (L_early=1) SRS resource set provided by EarlySRS-ResourceSet and comprising, providing or configuring multiple or more than one (N_early>1) SRS resources each provided by EarlySRS-Resource. For this design example, the one or more second resource indicators could correspond to or comprise, or could be in form/terms of one or more of:
A bitmap of length N_early with each entry/bit position of the bitmap associated/corresponding/specific to a SRS resource provided by EarlySRS-Resource for the early triggering of the SRS transmission(s). In this case, when/if an entry/bit position of the bitmap is set to ‘1’ (or ‘0’), the UE (e.g., the UE 116) could indicate to the network that the SRS resource associated/corresponding/specific to the entry/bit position could be used/applied (by the UE) for determining or identifying the SRS resource(s) and the corresponding parameter(s)/setting(s) to transmit the (early) triggered SRS(s).
One or more one-bit flag indicators each associated/corresponding/specific to a SRS resource provided by EarlySRS-Resource for the early triggering of the SRS transmission(s). In this case, when/if a one-bit flag indicator is set to ‘1’ (or ‘0’), the UE could indicate to the network (e.g., the network 130) that the SRS resource associated/corresponding/specific to the one-bit flag indicator could be used/applied (by the UE) for determining or identifying the SRS resource(s) and the corresponding parameter(s)/setting(s) to transmit the (early) triggered SRS(s).
A y2-bit indicator with y2=┌log₂(N_early)┐: each codepoint/state of the y2-bit indicator could be associated/corresponding/specific to a SRS resource provided by EarlySRS-Resource for the early triggering of the SRS transmission(s). In this case, when a codepoint/state of the y2-bit indicator is indicated, the UE could indicate to the network that the SRS resource associated/corresponding/specific to the codepoint/state of the y2-bit indicator could be used/applied (by the UE) for determining or identifying the SRS resource(s) and the corresponding parameter(s)/setting(s) to transmit the (early) triggered SRS(s). For instance, the higher layer parameter(s)/signaling(s) including SIB1, SIB2, RRCRelease-IEs as specified/defined herein could provide or indicate or comprise K_early=1 SRS resource configuration comprising or providing or configuring L_early=1 SRS resource set comprising or providing or configuring N_early>1 SRS resources for the early triggering of the SRS transmission(s), wherein each of the SRS resources could be provided by EarlySRS-Resource; for this design example, y2=2 with codepoint/state ‘00’ indicating the first SRS resource or the SRS resource with the lowest resource ID/index value, codepoint/state ‘01’ indicating the second SRS resource or the SRS resource with the second lowest resource ID/index value, codepoint/state ‘10’ indicating the third SRS resource or the SRS resource with the second highest resource ID/index value, and codepoint/state ‘11’ indicating the fourth SRS resource or the SRS resource with the highest resource ID/index value.
One or more SRS resource IDs/ID values. In this case, the UE could indicate to the network that the SRS resource(s) with or having the one or more SRS resource IDs/ID values could be used/applied (by the UE) for determining or identifying the SRS resource(s) and the corresponding parameter(s)/setting(s) to transmit the (early) triggered SRS(s).
One or more indexes or index values denoted by n_1, . . . , n_y with each index or index value belonging to {1, . . . , N_early} or {0, . . . , N_early−1}, i.e., n_1, . . . , n_y∈{1, . . . , N_early} or {0, . . . , N_early−1}. In this case, the UE could indicate to the network that the n_1-th, . . . , n_y-th SRS resource(s) among the configured/provided N_early SRS resources (e.g., with their resource IDs/ID values ordered from low to high or from high to low) in the SRS resource set/configuration could be used/applied (by the UE) for determining or identifying the SRS resource(s) and the corresponding parameter(s)/setting(s) to transmit the (early) triggered SRS(s).
One or more trigger states each pointing/corresponding to an entry in a list of aperiodic SRS resource trigger states provided by aperiodicSRS-ResourceTrigger or aperiodicSRS-ResourceTriggerList. In this case, the UE could indicate to the network that the SRS resource(s) corresponding/associated/specific to the one or more trigger states could be used/applied (by the UE) for determining or identifying the SRS resource(s) and the corresponding parameter(s)/setting(s) to transmit the (early) triggered SRS(s).
One or more PRACH preambles. In this case, the higher layer parameter(s)/signaling(s) including SIB1, SIB2, RRCRelease-IEs as specified/defined herein could also provide or indicate or comprise N_early>1 groups of PRACH preambles with each group corresponding/specific to a SRS resource provided by EarlySRS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , N_early} or {0, . . . , N_early−1}), the UE could indicate to the network that the y-th SRS resource among the configured/provided N_early SRS resources (e.g., with their resource IDs/ID values ordered from low to high or from high to low) could be used/applied (by the UE) for determining or identifying the SRS resource(s) and the corresponding parameter(s)/setting(s) to transmit the (early) triggered SRS(s).
One or more subgroup indexes of a PO. In this case, the higher layer parameter(s)/signaling(s) including SIB1, SIB2, RRCRelease-IEs as specified/defined herein could also provide or indicate or comprise the N_early>1 subgroups of a PO such that each subgroup of the PO could be associated/corresponding/specific to a SRS resource provided by EarlySRS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , N_early} or {0, . . . , N_early−1}), the UE could indicate to the network that the y-th SRS resource among the configured/provided N_early SRS resources (e.g., with their resource IDs/ID values ordered from low to high or from high to low) could be used/applied (by the UE) for determining or identifying the SRS resource(s) and the corresponding parameter(s)/setting(s) to transmit the (early) triggered SRS(s).
Information related to one or more SRS resources. The UE could determine or identify the association(s)/mapping(s) between the information and the one or more SRS resources according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more SRS resources corresponding/associated/specific to the information could be used/applied (by the UE) for determining or identifying the SRS resource(s) and the corresponding parameter(s)/setting(s) to transmit the (early) triggered SRS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the N_early SRS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Nearly SRS resources, a mapping between the one or more UE IDs and resources used for reception of the PDCCH providing the DCI format as mentioned herein, and the N_early SRS resources and/or etc.

After the UE has transmitted or sent to the network, via/in/by the one or more second resource indication channels/signals, the one or more second resource indicators according to or following those specified herein in the present disclosure, the UE may expect to receive from the network, via/in/by one or more first response channels/signals, one or more first response indicators to the one or more second resource indicators. The UE could determine or identify the one or more first response channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the first response channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more first response indicators could be present or absent in their corresponding first response channel(s)/signal(s) according to network's configuration or indication (e.g., via RRC signaling(s)/configuration(s)). For instance, the UE could be provided or indicated or configured by the network a higher layer parameter/signaling denoted by earlySRSRaResponse_PresentInDCI. In this case, when/if the higher layer parameter/signaling earlySRSRaResponse_PresentInDCI is provided/configured and/or set to ‘enabled’ or ‘on’, the first response indicator(s) as specified/defined herein in the present disclosure could be present in the corresponding DCI format(s) as specified/defined in Option-1 following those specified herein in the present disclosure; otherwise, i.e., when/if the higher layer parameter/signaling earlySRSRaResponse_PresentInDCI is not provided/configured and/or set to ‘disabled’ or ‘off’, the first response indicator(s) as specified/defined herein in the present disclosure may not be present or could be absent in the corresponding DCI format(s) as specified/defined in Option-1 according to those specified herein in the present disclosure. The one or more first response channels/signals could be the same as or identical to the one or more second channels/signals in Mode-A; optionally, the one or more first response channels/signals could be different or separate from the one or more second channels/signals in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more first response channels/signals are the same as or identical to the one or more second channels/signals in Mode-A, the one or more first response indicators could be the same as or identical to the one or more second indicators in Mode-A; optionally, the one or more first response indicators could be different or separate from the one or more second indicators in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In particular, the one or more first response indicators could correspond to or comprise, or could be in form/terms of one or more of:
A message indicating ACK or NACK in response to the second resource indicator(s) transmitted/sent in the second resource indication channel(s)/signal(s) as specified/defined herein in the present disclosure; for instance, the message could be a one-bit indicator with ‘i’ (or ‘0’) indicating ACK in response to the second resource indicator(s) transmitted/sent in the second resource indication channel(s)/signal(s), and ‘0’ (or ‘i’) indicating NACK in response to the second resource indicator(s) transmitted/sent in the second resource indication channel(s)/signal(s)
UL resource(s) or resource allocation(s)/indication(s) as in (a-2) for the third channel(s)/signal(s) in Mode-A and/or the second channel(s)/signal(s) in Mode-C to carry or convey the (early) triggered SRS(s)

Furthermore, the UE could expect to receive from the network the first response indicator(s)—in/via/by the first response channel(s)/signal(s)—within a time offset/gap/window delta_T starting from the last (or first) symbol/slot of transmitting the second resource indicator(s)—in/via/by the second resource indication channel(s)/signal(s), wherein the time offset/gap/window delta_T could be in form/terms of number of slots, symbols, etc. The UE could determine or identify the value(s) of the delta_T according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the delta_T could be indicated or provided by/in a DCI format.
For example, one or more new DCI fields in the DCI format could indicate or provide the value(s) of the delta_T.
For another example, one or more existing DCI fields in the DCI format could be repurposed to indicate or provide the value(s) of the delta_T.

The value(s) of the delta_T could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationResponseToSRSRi_PresentInDCI. In this case, when/if the higher layer parameter/signaling timeIndicationResponseToSRSRi_PresentInDCI is provided/configured and/or set to ‘enabled’ or ‘on’, the value(s) of the delta_T as specified/defined herein in the present disclosure could be present in the corresponding DCI format(s); otherwise, i.e., when/if the higher layer parameter/signaling timeIndicationResponseToSRSRi_PresentInDCI is not provided/configured and/or set to ‘disabled’ or ‘off’, the value(s) of the time offset/gap/window delta_T as specified/defined herein in the present disclosure may not be present or could be absent in the corresponding DCI format(s). In this case, when/if the UE does not from the network the first response indicator(s)—in/via/by the first response channel(s)/signal(s)—within the time offset/gap/window delta_T starting from the last (or first) symbol/slot of transmitting the second resource indicator(s)—in/via/by the second resource indication channel(s)/signal(s)—according to or following those specified herein in the present disclosure, the UE could (re-)transmit or (re-)send to the network, in the one or more second resource indication channels/signals, the one or more second resource indicators. When/if the UE has (re-)transmitted or (re-)sent the same second resource indicator(s)—via/by/in the second resource indication channel(s)/signal(s)—a number of times, denoted by maxNumReTxRi, within a time window/period, denoted by timeWindowMaxNumReTxRi, (b-1) the UE could stop or terminate sending or transmitting the second resource indicator(s) via/by/in the second resource indication channel(s)/signal(s), and/or (b-2) the UE could stop or terminate the (early) SRS triggering and/or transmission(s). The UE could determine or identify the value(s) of the maxNumReTxRi and/or timeWindowMaxNumReTxRi according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, the UE could indicate to the network, e.g., via/in various UL channels/signals including beam/CSI report and/or UE's capability signaling(s), information (e.g., one-bit flag indicator(s)) to indicate the occurrence(s) of (b-1) and/or (b-2) as specified/defined herein.

For Mode-A and/or Mode-C, the UE could determine or identify or select which one or more of the configured/provided SRS resource configurations (and therefore, the corresponding SRS resource set(s)/SRS resource(s) provided/configured therein) for the early triggering of the SRS transmission(s) as specified/defined herein in the present disclosure, which one or more of the configured/provided SRS resource sets (and therefore, the corresponding SRS resource(s) provided/configured therein) for the early triggering of the SRS transmission(s) as specified/defined herein in the present disclosure, and/or which one or more of the configured/provided SRS resources for the early triggering of the SRS transmission(s) as specified/defined herein in the present disclosure, to use/apply for determining or identifying the SRS resource(s) and the corresponding parameter(s)/setting(s) to transmit the (early) triggered SRS(s) according to or based on fixed mapping rule(s) in system specification(s) and/or per RRC (re-)configuration/setup.
In one example, when/if the higher layer parameter(s)/signaling(s) including SIB1, SIB2, RRCRelease-IEs as specified/defined herein provides or indicates or comprises multiple or more than one (K_early>1) SRS resource configurations for the early triggering of the SRS transmission(s), wherein each of the SRS resource configurations could be provided by EarlySRS-Config, and could comprise or provide or include or configure one or more SRS resource sets each provided by EarlySRS-ResourceSet and comprising, providing or configuring one or more SRS resources each provided by EarlySRS-Resource, the fixed mapping rule(s) could correspond to or could comprise a mapping between the one or more UE IDs and the K_early SRS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early SRS resource configurations, a mapping between the one or more UE IDs and resources used for reception of the PDCCH providing the DCI format as mentioned herein, and the K_early SRS resource configurations and/or etc.
In another example, when/if the higher layer parameter(s)/signaling(s) including SIB1, SIB2, RRCRelease-IEs as specified/defined herein provides or indicates or comprises one (K_early=1) SRS resource configuration for the early triggering of the SRS transmission(s), wherein the SRS resource configuration could be provided by EarlySRS-Config, and could comprise, provide or configure multiple or more than one (L_early>1) SRS resource sets each provided by EarlySRS-ResourceSet and comprising, providing or configuring one or more SRS resources each provided by EarlySRS-Resource, the fixed mapping rule(s) could correspond to or could comprise a mapping between the one or more UE IDs and the L_early SRS resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early SRS resource sets, a mapping between the one or more UE IDs and resources used for reception of the PDCCH providing the DCI format as mentioned herein, and the L_early SRS resource sets and/or etc.
In another example, when/if the higher layer parameter(s)/signaling(s) including SIB1, SIB2, RRCRelease-IEs as specified/defined herein provides or indicates or comprises one (K_early=1) SRS resource configuration for the early triggering of the SRS transmission(s), wherein the SRS resource configuration could be provided by EarlySRS-Config, and could comprise, provide or configure one (L_early=1) SRS resource set provided by EarlySRS-ResourceSet and comprising, providing or configuring multiple or more than one (N_early>1) SRS resources each provided by EarlySRS-Resource, the fixed mapping rule(s) could correspond to or could comprise a mapping between the one or more UE IDs and the N_early SRS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Nearly SRS resources, a mapping between the one or more UE IDs and resources used for reception of the PDCCH providing the DCI format as mentioned herein, and the N_early SRS resources, and/or etc.

As specified herein in the present disclosure, a UE could be first configured or provided or indicated by the network, e.g., via higher layer RRC signaling(s)/parameter(s) including SIB1, SIB2 and RRCRelease-IEs and/or MAC CE command(s) and/or dynamic DCI based L1 signaling(s)/parameter(s) based on or according to a corresponding UE's capability or capability signaling, one or more second UL resources or resource configurations including one or more SRS resource configurations/settings, one or more SRS resource sets and/or one or more SRS resources for the early triggering of the SRS transmission(s), i.e., for transmitting the (early) triggered SRS(s) in the third channel(s)/signal(s)—as in Mode-A/B, or in the second channel(s)/signal(s)—as in Mode-C. The one or more second UL resources/resource configurations could be (e.g., one-to-one or many-to-one) mapped/linked/associated to one or more first UL resources/resource configurations for the first channel(s)/signal(s) used to carry or convey the first indicator(s) as in Mode-A, Mode-B and/or Mode-C specified/described herein in the present disclosure. Here, the UE could determine or identify the mapping/linkage/association between the one or more first UL resources/resource configurations and the one or more second UL resources/resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, for Mode-A and/or Mode-C, when/if the UE transmits or sends to the network, in the first channel(s)/signal(s) via a first UL resource/resource configuration, the first indicator(s) to trigger the (early) SRS transmission(s), the UE could determine or identify, based on or according to the mapping(s)/linkage(s)/association(s) as specified/defined herein, a second UL resource/resource configuration mapped/linked/associated to the first UL resource/resource configuration. When applicable, the UE could send or transmit to the network, in the third channel(s)/signal(s) for Mode-A and/or second channel(s)/signal(s) for Mode-C via the determined/identified second UL resource/resource configuration, the (early) triggered SRS(s).

As specified/defined herein in the present disclosure, for Mode-C, the UE could transmit or send or indicate to the network, in/by/via the second channel(s)/signal(s), the (early) triggered SRS(s) according to or based on one or more of the followings.
In one example, the UE could transmit or send or indicate to the network the second channel(s)/signal(s) carrying or conveying the (early) triggered SRS(s) using or via a/the most recent in time and/or available UL resource(s) a minimum time T_3 from the end (or start) of the first triggering channel(s)/signal(s).
In another example, the symbol or slot or subframe or frame used by a UE to transmit the (early) triggered SRS(s) could be a/the most recent in time and/or available UL resource(s) at or after a time T_3 from the end (or start) of the first triggering channel(s)/signal(s).
In another example, the symbol or slot or subframe or frame used by a UE to transmit the (early) triggered SRS(s) could be that first symbol or slot or subframe or frame that starts at or after a time T_3 from the end (or start) of the first triggering channel(s)/signal(s) and optionally based on a time offset/gap.

The time T_3 and/or the time offset/gap could be in number of symbol(s), slot(s), subframe(s), frame(s) and/or etc. Furthermore, the UE (e.g., the UE 116) could determine or identify the value(s) of the time T_3 and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s). For instance, the value(s) of the time T_3 and/or the time offset/gap could be indicated or provided by/in a DCI format.
For example, one or more new DCI fields in the DCI format could indicate or provide the value(s) of the time T_3 and/or the time offset/gap.
For another example, one or more existing DCI fields in the DCI format could be repurposed to indicate or provide the value(s) of the time T_3 and/or the time offset/gap.

The value(s) of the time T_3 and/or the time offset/gap could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationSRS_PresentInDCI. In this case, when/if the higher layer parameter/signaling timeIndicationSRS_PresentInDCI is provided/configured and/or set to ‘enabled’ or ‘on’, the value(s) of the time T_3 and/or the time offset/gap as specified/defined herein in the present disclosure could be present in the corresponding DCI format(s); otherwise, i.e., when/if the higher layer parameter/signaling timeIndicationSRS_PresentInDCI is not provided/configured and/or set to ‘disabled’ or ‘off’, the value(s) of the time T_3 and/or the time offset/gap as specified/defined herein in the present disclosure may not be present or could be absent in the corresponding DCI format(s).

Optionally, for Mode-A, the UE could transmit or send or indicate to the network, in/by/via the third channel(s)/signal(s), the (early) triggered SRS(s) according to or based on one or more of the followings.
In one example, the UE could transmit or send or indicate to the network the third channel(s)/signal(s) carrying or conveying the (early) triggered SRS(s) using or via a/the most recent in time and/or available UL resource(s) a minimum time T_3′ from the end (or start) of the first triggering channel(s)/signal(s).
In another example, the symbol or slot or subframe or frame used by a UE to transmit the (early) triggered SRS(s) could be a/the most recent in time and/or available UL resource(s) at or after a time T_3′ from the end (or start) of the first triggering channel(s)/signal(s).
In another example, the symbol or slot or subframe or frame used by a UE to transmit the (early) triggered SRS(s) could be that first symbol or slot or subframe or frame that starts at or after a time T_3′ from the end (or start) of the first triggering channel(s)/signal(s) and optionally based on a time offset/gap.
In another example, the UE could transmit or send or indicate to the network the third channel(s)/signal(s) carrying or conveying the (early) triggered SRS(s) using or via a/the most recent in time and/or available UL resource(s) a minimum time T_3′ from the end (or start) of the second triggering channel(s)/signal(s). For instance, for Option-1, the second triggering channel(s)/signal(s) as mentioned herein could correspond to a PDCCH reception providing the DCI format(s) triggering the SRS transmission.
In another example, the symbol or slot or subframe or frame used by a UE to transmit the (early) triggered SRS(s) could be a/the most recent in time and/or available UL resource(s) at or after a time T_3′ from the end (or start) of the second triggering channel(s)/signal(s). For instance, for Option-1, the second triggering channel(s)/signal(s) as mentioned herein could correspond to a PDCCH reception providing the DCI format(s) triggering the SRS transmission.
In another example, the symbol or slot or subframe or frame used by a UE to transmit the (early) triggered SRS(s) could be that first symbol or slot or subframe or frame that starts at or after a time T_3′ from the end (or start) of the second triggering channel(s)/signal(s) and optionally based on a time offset/gap. For instance, for Option-1, the second triggering channel(s)/signal(s) as mentioned herein could correspond to a PDCCH reception providing the DCI format(s) triggering the SRS transmission.

The time T_3′ and/or the time offset/gap could be in number of symbol(s), slot(s), subframe(s), frame(s) and/or etc. Furthermore, the UE could determine or identify the value(s) of the time T_3′ and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_3′ and/or the time offset/gap could be indicated or provided by/in a DCI format.
For example, one or more new DCI fields in the DCI format could indicate or provide the value(s) of the time T_3′ and/or the time offset/gap.
For another example, one or more existing DCI fields in the DCI format could be repurposed to indicate or provide the value(s) of the time T_3′ and/or the time offset/gap.

The value(s) of the time T_3′ and/or the time offset/gap could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationSRS_PresentInDCI. In this case, when/if the higher layer parameter/signaling timeIndicationSRS_PresentInDCI is provided/configured and/or set to ‘enabled’ or ‘on’, the value(s) of the time T_3′ and/or the time offset/gap as specified/defined herein in the present disclosure could be present in the corresponding DCI format(s); otherwise, i.e., when/if the higher layer parameter/signaling timeIndicationSRS_PresentInDCI is not provided/configured and/or set to ‘disabled’ or ‘off’, the value(s) of the time T_3′ and/or the time offset/gap as specified/defined herein in the present disclosure may not be present or could be absent in the corresponding DCI format(s).

The UE could indicate or send or transmit to the network, e.g., in their corresponding capability signaling(s), whether they are capable of supporting (a-1), (a-2) and/or (a-3) as specified/defined herein in the present disclosure to determine or identify UL resource(s) or resource allocation(s) for transmitting or sending the (early) triggered SRS(s). For instance, the corresponding capability signaling(s) could comprise one or more and/or a combination of one or more of the following components, wherein Component-I, Component-II or Component-III could be basic UE's capability/feature:
Component-I: support of (a-1) as specified/defined herein in the present disclosure to determine or identify UL resource(s) or resource allocation(s) for transmitting or sending the (early) triggered SRS(s)
Component-IL: support of (a-2) as specified/defined herein in the present disclosure to determine or identify UL resource(s) or resource allocation(s) for transmitting or sending the (early) triggered SRS(s)
Component-III: support of (a-3) as specified/defined herein in the present disclosure to determine or identify UL resource(s) or resource allocation(s) for transmitting or sending the (early) triggered SRS(s)

In this case, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of (a-1), (a-2) and (a-3) as specified/described herein is enabled for the UE to determine or identify UL resource(s) or resource allocation(s) for transmitting or sending the (early) triggered SRS(s). For instance, when/if a UE is provided by a higher layer parameter enablePreConfigurationforEarlySRS and/or set to ‘enabled’, the UE could follow those specified/defined in (a-1) in the present disclosure to determine or identify UL resource(s) or resource allocation(s) for transmitting or sending the (early) triggered SRS(s). When/if a UE is provided by a higher layer parameter enableNwIndicationforEarlySRS and/or set to ‘enabled’, the UE could follow those specified/defined in (a-2) in the present disclosure to determine or identify UL resource(s) or resource allocation(s) for transmitting or sending the (early) triggered SRS(s). When/if a UE is provided by a higher layer parameter enableUeIndicationforEarlySRS and/or set to ‘enabled’, the UE could follow those specified/defined in (a-3) in the present disclosure to determine or identify UL resource(s) or resource allocation(s) for transmitting or sending the (early) triggered SRS(s).

After the UE has transmitted or sent to the network, via/in/by the one or more third channels/signals in Mode-A/B and/or the one or more second channels/signals in Mode-C, the (early) triggered SRS(s) according to or following those specified herein in the present disclosure, the UE may expect to receive from the network, via/in/by one or more second response channels/signals, one or more second response indicators to the (early) triggered SRS transmission(s). The UE could determine or identify the one or more second response channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the second response channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more second response indicators could be present or absent in their corresponding second response channel(s)/signal(s) according to network's configuration or indication (e.g., via RRC signaling(s)/configuration(s)). For instance, the UE could be provided or indicated or configured by the network a higher layer parameter/signaling denoted by earlySRSResponse_PresentInDCI. In this case, when/if the higher layer parameter/signaling earlySRSResponse_PresentInDCI is provided/configured and/or set to ‘enabled’ or ‘on’, the second response indicator(s) as specified/defined herein in the present disclosure could be present in the corresponding DCI format(s) as specified/defined in Option-1 following those specified herein in the present disclosure; otherwise, i.e., when/if the higher layer parameter/signaling earlySRSResponse_PresentInDCI is not provided/configured and/or set to ‘disabled’ or ‘off’, the second response indicator(s) as specified/defined herein in the present disclosure may not be present or could be absent in the corresponding DCI format(s) as specified/defined in Option-1 according to those specified herein in the present disclosure. The one or more second response channels/signals could be the same as or identical to the one or more second channels/signals in Mode-A; optionally, the one or more second response channels/signals could be different or separate from the one or more second channels/signals in Mode-A/B; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more second response channels/signals are the same as or identical to the one or more second channels/signals in Mode-A/B, the one or more second response indicators could be the same as or identical to the one or more second indicators in Mode-A/B; optionally, the one or more second response indicators could be different or separate from the one or more second indicators in Mode-A/B; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In particular, the one or more second response indicators could correspond to or comprise, or could be in form/terms of one or more of:
A message indicating ACK or NACK in response to the (early) triggered SRS(s) transmitted/sent in the third channel(s)/signal(s) for Mode-A/B or the second channel(s)/signal(s) for Mode-C as specified/defined herein in the present disclosure; for instance, the message could be a one-bit indicator with ‘1’ (or ‘0’) indicating ACK in response to the (early) triggered SRS(s) transmitted/sent in the third channel(s)/signal(s) for Mode-A/B or the second channel(s)/signal(s) for Mode-C, and ‘0’ (or ‘1’) indicating NACK in response to the (early) triggered SRS(s) transmitted/sent in the third channel(s)/signal(s) for Mode-A/B or the second channel(s)/signal(s) for Mode-C
UL resource(s) or resource allocation(s)/indication(s) as in (a-2) for the third channel(s)/signal(s) in Mode-A and/or the second channel(s)/signal(s) in Mode-C to carry or convey the (early) triggered SRS(s)

Furthermore, the UE could expect to receive from the network the second response indicator(s)—in/via/by the second response channel(s)/signal(s)—within a time offset/gap/window delta_T′ starting from the last (or first) symbol/slot of transmitting the early triggered SRS(s)—in/via/by the third channel(s)/signal(s) for Mode-A/B or the second channel(s)/signal(s) for Mode-C, wherein the time offset/gap/window delta_T′ could be in form/terms of number of slots, symbols, etc. The UE could determine or identify the value(s) of the delta_T′ according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the delta_T′ could be indicated or provided by/in a DCI format.
For example, one or more new DCI fields in the DCI format could indicate or provide the value(s) of the delta_T′.
For another example, one or more existing DCI fields in the DCI format could be repurposed to indicate or provide the value(s) of the delta_T′.

The value(s) of the delta_T′ could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationResponseToSRS_PresentInDCI. In this case, when/if the higher layer parameter/signaling timeIndicationResponseToSRS_PresentInDCI is provided/configured and/or set to ‘enabled’ or ‘on’, the value(s) of the delta_T′ as specified/defined herein in the present disclosure could be present in the corresponding DCI format(s); otherwise, i.e., when/if the higher layer parameter/signaling timeIndicationResponseToSRS_PresentInDCI is not provided/configured and/or set to ‘disabled’ or ‘off’, the value(s) of the time offset/gap/window delta_T′ as specified/defined herein in the present disclosure may not be present or could be absent in the corresponding DCI format(s). In this case, when/if the UE does not from the network the second response indicator(s)—in/via/by the second response channel(s)/signal(s)—within the time offset/gap/window delta_T′ starting from the last (or first) symbol/slot of transmitting the early triggered SRS(s)—in/via/by the third channel(s)/signal(s) for Mode-A/B or the second channel(s)/signal(s) for Mode-C—according to or following those specified herein in the present disclosure, the UE could (re-)transmit or (re-)send to the network, in/via/by the third channel(s)/signal(s) for Mode-A/B or the second channel(s)/signal(s) for Mode-C, the (early) triggered SRS(s). When/if the UE has (re-)transmitted or (re-)sent the same (early) triggered SRS(s)—in/via/by the third channel(s)/signal(s) for Mode-A/B or the second channel(s)/signal(s) for Mode-C—a number of times, denoted by maxNumReTx, within a time window/period, denoted by timeWindowMaxNumReTx, (c-1) the UE could stop or terminate the (early) SRS triggering and/or transmission(s). The UE could determine or identify the value(s) of the maxNumReTx and/or timeWindowMaxNumReTx according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, the UE could indicate to the network, e.g., via/in various UL channels/signals including beam/CSI report and/or UE's capability signaling(s), information (e.g., one-bit flag indicator(s)) to indicate the occurrence(s) of (c-1) as specified/defined herein.

This disclosure covers various design examples, aspects and means of providing configuration(s) of CSI-RS resource(s) for early triggering of CSI measurement/reporting, and/or configuration(s) of SRS resource(s) for early triggering of SRS transmission, including
Signaling medium(s)/container(s) to carry the configuration(s), which includes SIB, RRC setup, RRC reconfiguration, RRC release message and/or etc.
Detailed configuration(s) and setting(s) for the CSI-RS resource(s) for early CSI measurement/reporting triggering and/or the SRS resource(s) for early SRS transmission triggering
Selection and indication of CSI-RS resource configuration(s) by the UE for the early triggering of CSI measurement/reporting, and/or selection and indication of SRS resource configuration(s) by the UE for the early triggering of SRS transmission
Selection and indication of CSI-RS and/or SRS resource configuration(s) by the network for the early triggering of CSI measurement/reporting and/or SRS transmission(s)

The corresponding/related design procedure(s), signaling flow(s)/method(s), UE's assumption(s)/behavior(s) and/or etc. of the above are also presented in this disclosure.

Furthermore, this disclosure also presents detailed UE-initiated early triggering(s) of SRS transmission(s) and/or CSI measurement/reporting, wherein various design examples, aspects and means of providing configuration(s) of CSI-RS resource(s) for the early triggering of the CSI measurement/reporting are also provided in this disclosure, similar to those for the SRS resource(s) for the early triggering of the SRS transmission(s).

In the present disclosure, the configuration(s) of CSI-RS resource(s) may include, contain or comprise at least one or more of the following parameters/settings/components:
CSI-RS resource (including SSB and NZP CSI-RS resource) ID/index, CSI resource set (including SSB resource set and NZP CSI-RS resource set) ID/index, CSI resource configuration/setting ID/index, CSI reporting configuration/setting ID/index.
Resource type and corresponding parameter(s) for the corresponding CSI-RS resource(s) including ‘aperiodic’, ‘periodic’, and/or ‘semi-persistent’; the parameter(s) corresponding to the resource type of ‘aperiodic’ could also comprise or include or contain an aperiodic CSI trigger state list provided by CSI-AperiodicTriggerStateList.
Repetition setting (e.g., repetition set to ‘on’ or ‘off’)
Usage of the CSI-RS resource(s): e.g., CSI-RS for beam management, CSI-RS for CSI, TRS (with trs-Info set to ‘true’), and etc.
Time and frequency resources (e.g., symbols within a slot for CSI-RS, starting symbol for CSI-RS, time slot for CSI-RS, periodicity and offset of CSI-RS (e.g., in case of periodic or semi-persistent CSI-RS), starting PRB for CSI-RS, number of PRBs for CSI-RS).
Resource mapping of CSI-RS resource(s): OFDM symbol location(s) in a slot and subcarrier occupancy in a PRB of the CSI-RS resource
Periodicity and slot offset for the CSI-RS resource(s)
Scrambling ID
Transmit power control parameter(s)/setting(s) for the corresponding reference signal.
TCI state(s) and/or reference signal(s) used for determining the spatial filter(s) for receiving the corresponding CSI-RS(s).

In particular, a UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, the configuration(s) of the CSI-RS resource(s) for the early triggering of the CSI measurement/reporting. For instance, the UE could be provided by the network via/in a higher layer parameter EarlyCSI-ResourceConfig providing or configuring or indicating
At least one or more of the parameters/settings/components mentioned herein for the configuration(s) of the corresponding CSI-RS resource(s)
At least one or more of parameters/settings/components provided or configured by/in higher layer parameter(s) including at least CSI-ResourceConfig, CSI-ResourceSet including CSI-SSB-ResourceSet/NZP-CSI-RS-ResourceSet, NZP-CSI-RS-Resource/SSB-Index, and/or etc. for the corresponding CSI-RS resource(s) defined/specified in [REF 6] for 5G NR.

The UE could alternatively be provided by the network via/in a higher layer parameter EarlyCSI-ReportConfig associated/specific to one or more CSI resource settings/configurations—each provided by EarlyCSI-ResourceConfig—for the early triggering of the CSI measurement/reporting as mentioned herein, wherein the higher layer parameter EarlyCSI-ReportConfig could provide or configure or indicate at least one or more of parameters/settings/components provided or configured by/in higher layer parameter(s) including at least CSI-ReportConfig associated/specific/linked to the corresponding CSI-RS resource(s) defined/specified in [REF 6] for 5G NR.

In one example, the UE could be provided or configured by the network, in system information block including SIB1, SIB2 and/or other SIBs, the above discussed/specified CSI-RS resource configuration(s) for early triggering of the CSI measurement/reporting (e.g., provided by EarlyCSI-ResourceConfig or EarlyCSI-ReportConfig). Examples of providing or configuring the EarlyCSI-ResourceConfig and/or EarlyCSI-ReportConfig as defined/specified herein in the higher layer parameters SIB1 and SIB2 are respectively presented herein.

| | |
|---|---|
| SIB1 ::= | SEQUENCE { |

...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

| | |
|---|---|
| SIB2 ::= | SEQUENCE { |

...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

In one example, the UE could be provided or configured by the network, in RRC release message, the above discussed/specified CSI-RS resource configuration(s) for early triggering of the CSI measurement/reporting (e.g., provided by EarlyCSI-ResourceConfig or EarlyCSI-ReportConfig). One example of providing or configuring the EarlyCSI-ResourceConfig and/or EarlyCSI-ReportConfig as defined/specified herein in the higher layer parameters RRCRelease-IEs is presented herein.

| RRCRelease-IEs ::= | SEQUENCE { | |
|---|---|---|
| redirectedCarrierInfo | RedirectedCarrierInfo | OPTIONAL, |

-- Need N,

| | |
|---|---|
| cellReselectionPriorities | CellReselectionPriorities |

OPTIONAL, -- Need R,

| | | |
|---|---|---|
| suspendConfig | SuspendConfig | OPTIONAL, -- Need R, |

...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

According to those specified herein in the present disclosure, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, which RRC signaling(s)/parameter(s)—e.g., RRCRelease-IEs and/or SIB1 and/or SIB2 as specified/defined herein—to use/apply for determine the CSI-RS resource configuration(s) for the early CSI measurement/reporting triggering(s). Furthermore, the CSI-RS resource configuration(s) for the early triggering of the CSI measurement/reporting, e.g., provided by EarlyCSI-ResourceConfig or linked/specific to EarlyCSI-ReportConfig, can be (configured to be) present or absent/not present in the corresponding RRC signaling(s)/parameter(s)—e.g., RRCRelease-IEs and/or SIB1 and/or SIB2 as specified/defined herein. When/if there are multiple or more than one RRC signalings/parameters, e.g., both SIB1 and RRCRelease-IEs, providing or configuring the CSI-RS resource configurations for the early triggering, the UE (e.g., the UE 116) could determine or identify which of the CSI-RS resource configurations, provided/configured in the multiple RRC signalings/parameters as specified/defined herein in the present disclosure, to use/apply for the early CSI measurement/reporting triggering(s), according to or based on
Fixed rule(s) in system specification(s) and/or per RRC (re-)configuration/setup: for example, the UE could determine or identify the CSI-RS resource configuration(s), e.g., EarlyCSI-ResourceConfig/EarlyCSI-ReportConfig, provided/configured in SIB1 to use/apply for the early CSI measurement/reporting triggering(s); for another example, the UE could determine or identify the CSI-RS resource configuration(s), e.g., EarlyCSI-ResourceConfig/EarlyCSI-ReportConfig, provided/configured in SIB1 to use/apply for the early CSI measurement/reporting triggering(s); for another example, the UE could determine or identify the CSI-RS resource configuration(s), e.g., EarlyCSI-ResourceConfig and/or EarlyCSI-ReportConfig, provided/configured in the higher layer parameter(s)/signaling(s) that is provided/received the latest (or earlies) in time to use/apply for the early CSI measurement/reporting triggering(s); for another example, association(s)/mapping(s) between one or more of the higher layer signalings/parameters that provide or configure the CSI-RS resource configurations for early triggering of the CSI measurement/reporting and one or more of signaling mediums/containers that could carry or provide actual indicator(s) to trigger the early CSI measurement/reporting according to or following those specified/described herein in the present disclosure could be fixed in system specification(s) and/or per RRC (re-)configuration/setup; for this design example, when/if the UE has received an indicator to trigger the early CSI measurement/reporting as specified/defined herein in the present disclosure, the UE could then determine or identify the CSI-RS resource configuration for the early CSI measurement/reporting triggering based on or according to the association/mapping relationship between the higher layer parameter/signaling that provides/configures the CSI-RS resource configuration and the signaling medium/container that carries or provides or indicates the indicator; for another example, the UE could determine or identify the CSI-RS resource configuration(s) for the early triggering of the CSI measurement/reporting according to or based on priority orders of the higher layer parameters/signalings that provide or configure the CSI-RS resource configurations for early CSI measurement/reporting triggering(s) from high to low (or from low to high), wherein the priority orders could be fixed in system specification(s) and/or per RRC (re-)configuration/setup.
Network's configuration(s)/indication(s), e.g., via/by higher layer RRC signaling(s)/parameter(s) and/or MAC CE command(s) and/or dynamic DCI based L1 signaling(s) based on or according to a corresponding UE's capability or capability signaling: for example, the network's configuration(s)/indication(s) can be in form of a bitmap with each entry/bit position of the bitmap corresponding/specific to a higher layer parameter/signaling that provides the CSI-RS resource configuration(s)—e.g., provided by EarlyCSI-ResourceConfig or EarlyCSI-ReportConfig—for the early triggering; for this design example, when/if an entry/bit position of the bitmap is set to ‘1’ (or ‘0’), the higher layer parameter/signaling that is corresponding/specific to the entry/bit position is enabled for providing or configuring the CSI-RS resource configuration for the early triggering of the CSI measurement/reporting; for another example, the network's configuration(s)/indication(s) can be in form of one-bit flag indicator(s), provided/configured in or associated/specific to the higher layer parameter(s)/signaling(s) that provides the CSI-RS resource configuration(s) for the early triggering of the CSI measurement/reporting; for this design example, when/if an one-bit flag indicator, provided/configured in or associated/specific to a higher layer parameter/signaling that provides the CSI-RS resource configuration(s) for the early triggering, is set to ‘1’ (or ‘0’) or ‘enabled’, the higher layer parameter/signaling is enabled for providing or configuring the CSI-RS resource configuration for the early triggering of the CSI measurement/reporting; for another example, the UE could be indicated, configured or provided by the network (e.g., the network 130), e.g., via/by higher layer RRC signaling(s)/parameter(s) and/or MAC CE command(s) and/or dynamic DCI based L1 signaling(s) based on or according to a corresponding UE's capability or capability signaling, association(s)/mapping(s) between one or more of the higher layer signalings/parameters that provide or configure the CSI-RS resource configurations for early triggering of the CSI measurement/reporting and one or more of signaling mediums/containers that could carry or provide actual indicator(s) to trigger the early CSI measurement/reporting according to or following those specified/described herein in the present disclosure; for this design example, when/if the UE has received an indicator to trigger the early CSI measurement/reporting as specified/defined herein in the present disclosure, the UE could then determine or identify the CSI-RS resource configuration for the early CSI measurement/reporting triggering based on or according to the association/mapping relationship between the higher layer parameter/signaling that provides/configures the CSI-RS resource configuration and the signaling medium/container that carries or provides or indicates the indicator; for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, priority order(s) for the higher layer signalings/parameters that provide or indicate the CSI-RS resource configurations for the early triggering of the CSI measurement/reporting; for this design example, the UE could determine or identify the CSI-RS resource configuration(s) for the early triggering of the CSI measurement/reporting according to or based on priority orders of the higher layer parameters/signalings that provide or configure the CSI-RS resource configurations for early CSI measurement/reporting triggering(s) from high to low (or from low to high).

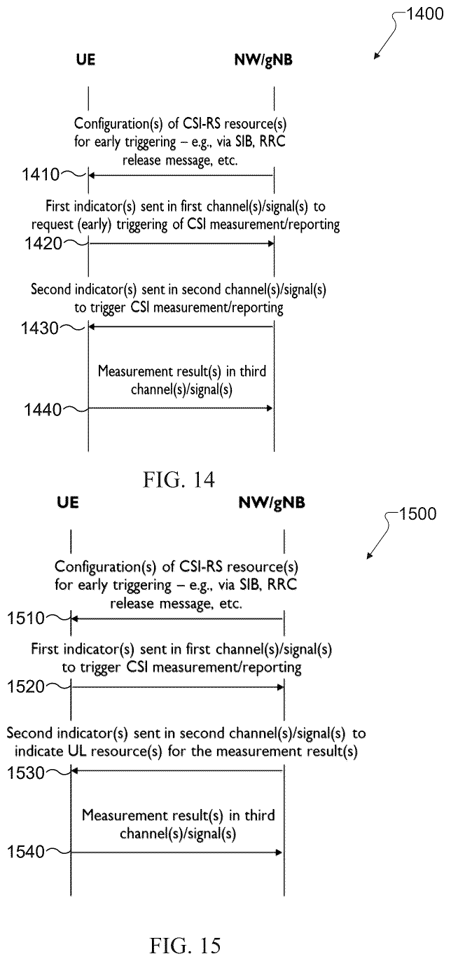

FIG. 14 illustrates a signal flow of an example procedure 1400 for early triggering of CSI measurement and reporting according to embodiments of the present disclosure. For example, procedure 1400 can be performed by the UE 116 and the gNB 102 and/or network 130 in the wireless network 100 of FIG. 1. This example is for illustration only and other embodiments can be used without departing from the scope of the present disclosure.

The procedure begins in 1410, a NW/gNB transmits configuration(s) of CSI-RS resource(s) to a UE for early triggering—e.g., via. SIB, RRC release message, etc. In 1420, the UE transmits first indicator(s) sent in first channel(s)/signal(s) to the NW/gNB to request (early) triggering of CSI measurement/reporting. In 1430, the NW/gNB transmits second indicator(s) sent in second channel(s)/signal(s) to the UE to trigger CSI measurement/reporting. In 1440, the UE transmits measurement result(s) in third channel(s)/signal(s) to the NW/gNB.

According to those specified herein in the present disclosure, a UE could be provided or configured or indicated by the network, e.g., via higher layer RRC signaling(s)/parameter(s)—e.g., via/by/in SIB1, SIB2, RRCRelease-IEs, and/or etc.—and/or MAC CE command(s) and/or dynamic DCI based L1 signaling(s) based on or according to a corresponding UE's capability or capability signaling, one or more CSI-RS resource configurations (e.g., each provided by EarlyCSI-ResourceConfig or EarlyCSI-ReportConfig) for the early triggering of the CSI measurement and reporting(s). For instance, a UE could be provided or configured by the network, e.g., via/by/in a/the same RRC signaling/parameter (e.g., SIB1, SIB2 or RRCRelease-IEs as specified/described herein in the present disclosure) and/or different or separate RRC signalings/parameters (e.g., via/by/in both SIB1 and RRCRelease-IEs), one or more (denoted by K_early>1) CSI-RS resource configurations for the early triggering of the CSI measurement and reporting(s)—each provided by EarlyCSI-Config as defined herein in the present disclosure. Optionally, a UE could be provided or configured by the network, e.g., via/by/in a/the same RRC signaling/parameter (e.g., SIB1, SIB2 or RRCRelease-IEs as specified/described herein in the present disclosure) and/or different or separate RRC signalings/parameters (e.g., via/by/in both SIB1 and RRCRelease-IEs), multiple or more than one (denoted by K_early>1) CSI-RS resource configurations for the early triggering of the CSI measurement and reporting(s)—each provided by EarlyCSI-ResourceConfig or EarlyCSI-ReportConfig as defined herein in the present disclosure.

In one example (Mode-A), after a UE has received from the network the CSI-RS resource configuration(s) for the early triggering of the CSI measurement and/or reporting according to or following those specified herein in the present disclosure, the UE could send or indicate or transmit to the network, via/in/by one or more first channels/signals, a first indicator to request (early) triggering of CSI measurement and/or reporting. For this design example, the UE could expect to receive from the network, in/via/by one or more second triggering channels/signals, one or more second indicators to indicate and/or trigger and/or enable the (early) CSI measurement and/or reporting. Upon detection and/or reception of the one or more second indicators, the UE could determine or identify, based on or according to the CSI-RS resource configuration(s), the CSI-RS(s) along with the corresponding parameter(s)/setting(s) to receive and measure. In this case, the UE could then transmit or send to the network, in/via/by one or more third channels/signals, measurement result(s) such as a beam/CSI report comprising one or more report quantities including SSBRI(s)/CRI(s), L1-RSRP(s)/L1-SINR(s), CQI(s), RI(s), PMI(s) and/or etc. In FIG. 14, an example signaling flow between a UE and a gNB/network for Mode-A is presented. The UE could determine or identify the third channel(s)/signal(s)—e.g., in form/terms of time and/or frequency resource(s)—to transmit the measurement result(s) according to or based on: (a) fixed rule(s) in system specification(s) and/or per RRC (re-)configuration/setup such as association(s)/mapping(s) between (resource(s) of) the third channel(s)/signal(s) and (resource(s) of) the second triggering channel(s)/signal(s), wherein the association(s)/mapping(s) could be in form/terms of timing relationship(s) or timeline(s), configuration(s), time-frequency resource allocation(s) and/or etc. according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s), (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network via various UL channels/signals e.g. via/in part of beam/CSI report(s) and/or UE's capability signaling(s).

For Mode-A, the one or more first indicators could correspond to a one-bit indicator (e.g., a one-bit UCI or a one-bit scheduling request (SR) provided by a SR configuration) or a multi-bit indicator. For instance, when/if the one or more first indicators correspond to a one-bit indicator, and/or when/if the UE has sent or indicated or transmitted to the network, the one or more first indicators set to ‘1’ or ‘positive’ or ‘on’ or etc., the UE could request the network to (early) trigger the CSI measurement and/or reporting. Furthermore, the one or more first channels/signals could correspond to or could be associated/specific to:
Alt-1—(periodic or periodically configured) PUCCH(s) or PUCCH resource(s), wherein the corresponding PUCCH resource configuration(s) including time-frequency resource allocation(s) for the PUCCH(s)/PUCCH resource(s) provided by PUCCH-Config, PUCCH-Resource, PUCCH-ResourceSet, and/or etc. could be provided or indicated in the higher layer parameter(s) including SIB1, SIB2, RRCRelease-IEs and/or etc. that provides or indicates the CSI-RS resource configuration(s) for the early triggering of the CSI measurement and/or reporting as specified/defined herein in the present disclosure.
Alt-2—(periodic or periodically configured) PUSCH(s) or PUSCH resource(s)—e.g., Type1/2 CG PUSCH(s), wherein the corresponding PUSCH resource configuration(s) including time-frequency resource allocation(s) for the PUSCH(s)/PUSCH resource(s) provided by PUSCH-Config and/or etc. could be provided or indicated in the higher layer parameter(s) including SIB1, SIB2, RRCRelease-IEs and/or etc. that provides or indicates the CSI-RS resource configuration(s) for the early triggering of the CSI measurement and/or reporting as specified/defined herein in the present disclosure.
Alt-3—one or more PUSCH(s) or PUSCH resource(s) scheduled or activated by a DCI format (e.g., a DL DCI format of 1_0/1_1/1_2/1_3 or a UL DCI format of 0_0/0_1/0_2/0_3 or a DCI format of 2_3 or a new DL/UL DCI format, e.g., dedicated for the early triggering of the CSI measurement and/or reporting). For instance, the DCI format could indicate or comprise or provide a one-bit indicator—e.g., via/by/in a new DCI field or a repurposed existing DCI field—with ‘1’ (or ‘0’) indicating that the correspondingly scheduled/activated PUSCH(s)/PUSCH resource(s) could be for carrying, conveying, sending or transmitting the first indicator(s) as specified/defined herein in the present disclosure. Furthermore, the CRC of the DCI format(s) could be scrambled with a RNTI, wherein the RNTI could be associated with the early triggered CSI-RS(s).
Alt-4—UL channel(s)/signal(s) including PUCCH(s)/PUSCH(s)/PRACH(s)/SRS(s) and/or etc. corresponding/associated/specific to one or more higher layer messages carried by/in PDSCH(s). Here, the higher layer message(s) could be a SIB message (e.g., SIB1, SIB2 or other SIB message(s)), a RRC message (e.g., a RRC reconfiguration message, a RRC setup message, a RRC release message, and/or etc.), a MAC CE message/signaling, and/or etc.; furthermore, the PDSCH(s) could be scheduled/activated by a corresponding DCI format. The CRC of the higher layer message(s) and/or the corresponding DCI format could be scrambled with a RNTI, wherein the RNTI could be associated with the early triggered CSI-RS(s). For instance, the UL channel(s)/signal(s) herein could be associated with or after a PRACH preamble transmission as indicated or configured or provided by the higher layer message(s). Optionally, the UL channel(s)/signal(s) herein could be associated with or after a RACH scheduled transmission or a Msg3 as indicated or configured or provided by the higher layer message(s). Furthermore, the UL channel(s)/signal(s) herein could be associated with or after a MsgA as indicated or configured or provided by the higher layer message(s).
Alt-5—UL channel(s)/signal(s) including PUCCH(s)/PUSCH(s)/PRACH(s)/SRS(s) and/or etc. corresponding/associated/specific to one or more paging early indications (PEIs) or paging messages, e.g., corresponding to/for one or more paging occasions. Here, a PEI could include an indication for each subgroup of a PO whether there is a corresponding paging message for the UEs of that subgroup. In addition, a PEI could be carried or conveyed using a DCI format (e.g., DCI format 27). For instance, the UL channel(s)/signal(s) herein could be associated with or after a PRACH preamble transmission as indicated or configured or provided by the PEI(s)/paging message(s). Optionally, the UL channel(s)/signal(s) herein could be associated with or after a RACH scheduled transmission or a Msg3 as indicated or configured or provided by the PEI(s)/paging message(s). Furthermore, the UL channel(s)/signal(s) herein could be associated with or after a MsgA as indicated or configured or provided by the PEI(s)/paging message(s).
Alt-6—a PRACH transmission or a RACH preamble transmission—e.g., Msg1; in this case, a PRACH preamble of Msg1 could also indicate the one or more first indicators as specified/defined herein in the present disclosure.
Alt-7—a RACH scheduled transmission—e.g., Msg3; in this case, the PUSCH transmission providing Msg3 and/or scheduled by RAR could also include, comprise, carry or convey the one or more first indicators as specified/defined herein in the present disclosure.
Alt-8—a MsgA of Type-2 random access procedure; in this case, the PRACH (preamble) or PUSCH transmission providing MsgA could also include, comprise, carry or convey the one or more first indicators as specified/defined herein in the present disclosure.
Alt-9—UL channel(s)/signal(s) including PUCCH(s)/PUSCH(s)/PRACH(s)/SRS(s) and/or etc. associated with or after a RACH scheduled (PUSCH) transmission or a Msg3 as indicated or configured or provided by a RAR. Here, the RAR could be a Msg2 corresponding to a preamble transmission for a contention based or a contention free random access procedure, or a MsgB of a Type-2 random access procedure as a success RAR (e.g., of a contention based random access procedure) or a fall back RAR (e.g., of a contention free random access procedure).
Alt-10—an uplink wake-up signal (UL WUS). The UL WUS is received by a low power radio (low power receiver) in the gNB (e.g., the BS 102). In one example, an UL WUS is OOK-1 (on off keying type 1) as described in TR 38.869. In another example, an UL WUS is OOK-2 [TR 38.869]. In another example, an UL WUS is OOK-3 [TR 38.869]. In another example, an UL WUS is OOK-4 [TR 38.869].

According to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, resource configuration(s)—or denoted by first UL resource(s)/resource configuration(s)—for the one or more first channels/signals as specified/defined herein in the present disclosure.
For PUCCH(s) or PUCCH resource(s) in Alt-1, the resource configuration(s) could be provided by PUCCH-Config, PUCCH-Resource, PUCCH-ResourceSet and/or etc., and/or could comprise or provide or contain or include one or more of:
   Time domain resources, including symbols (e.g., OFDM symbols) within a slot or sub-frame or frame to transmit the PUCCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUCCH(s) and/or PUCCH resource(s). Frequency domain resources can include one or more of number of resources, starting resource and/or ending resource.
   ID of code or sequence for PUCCH(s) and/or PUCCH resource(s).
   Cyclic shift for PUCCH(s) and/or PUCCH resource(s).
   PUCCH configuration index, wherein the PUCCH configuration index points to a PUCCH configuration in a set or list of configured PUCCH resources.
   PUCCH format (e.g., PUCCH Format 0 or PUCCH Format 1 or PUCCH Format 2 or PUCCH Format 3 or PUCCH Format 4).
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUCCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUCCH associated with the determined CSI-RS.
For PUSCH(s) or PUSCH resource(s) in Alt-2 and/or Alt-3, the resource configuration(s) could be provided by PUSCH-Config and/or etc., and/or could comprise or provide or contain or include one or more of:
   Time domain resources, including symbols (e.g., OFDM symbols) within a slot or sub-frame or frame to transmit the PUSCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure. In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUSCH(s) and/or PUSCH resource(s). Frequency domain resources can include one or more of number of resources, starting resource and/or ending resource.
   ID of code or sequence for PUSCH(s) and/or PUSCH resource(s).
   PUSCH configuration index, wherein the PUSCH configuration index points to a PUSCH configuration in a set or list of configured PUSCH resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUSCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUSCH associated with the determined CSI-RS.
For PRACH transmission(s) in Alt-4, Alt-5, Alt-6, Alt-7, Alt-8 and/or Alt-9, the resource configuration(s) could be provided by RACH-Config, RACH-ConfigCommon and/or RACH-ConfigDedicated, and/or could comprise or provide or contain or include one or more of:
   Time domain resources, including symbols (e.g., OFDM symbols) within a slot or sub-frame or frame to transmit the PRACH(s), including one or more of the number of symbols, the starting symbol and/or the ending symbol.
   Time domain resources including PRACH occasions.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group of PRBs) and/or interlaces for transmission of PRACH(s) and/or PRACH resource(s) and/or PRACH occasion(s). Frequency domain resources can include one or more of number of resources, starting resource and/or ending resource.
   Root sequence and/or cyclic shift.
   PRACH configuration index.
   Preamble format.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PRACH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PRACH associated with the determined CSI-RS.
For UL WUS in Alt-10, the corresponding resource configuration(s) could comprise or provide or contain or include one or more of:
   Time domain resources, including symbols (e.g., OFDM symbols) within a slot or sub-frame or frame to transmit the UL WUS(s), including one or more of the number of symbols, the starting symbol and/or the ending symbol.
   Time domain resources including periodicity and offset within the periodicity, wherein the periodicity and/or offset within a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group or number of PRBs) and/or interlaces for transmission of the UL WUS(s). Frequency domain resources can include one or more of number of resources, starting resource and/or ending resource.
   Comb size and comb offset if a comb structure is used for the frequency resources. For example, a comb of size M, transmits every M-th frequency resource starting from an offset (comb offset).
   ID of code or sequence. For example, this can be an overlaid sequence on the UL WUS(s).
   UL WUS configuration index, wherein the UL WUS configuration index points to a UL WUS configuration in a set or list of configured UL WUS resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the UL WUS associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the UL WUS associated the determined CSI-RS.

In the present disclosure, the UE could determine or identify the one or more second triggering channels/signals based on or according to:
In one example (Option-1), the second triggering channel(s)/signal(s) could correspond to or could be associated/specific to a DCI format (e.g., a DL DCI format of 1_0/1_1/1_2/1_3 or a UL DCI format of 0_0/0_1/0_2/0_3 or a DCI format of 2_3 or a new DL/UL DCI format, e.g., dedicated for the early triggering of the CSI measurement and/or reporting), wherein the one or more second indicators could correspond to or could be provided/indicated in/by one or more new DCI fields in the DCI format(s), or one or more existing DCI fields (e.g., CSI request field in DCI format 0_1/0_2) in the DCI format(s) repurposed for the early triggering of the CSI measurement and/or reporting. Furthermore, the CRC of the DCI format(s) could be scrambled with a RNTI, wherein the RNTI could be associated with the early triggered CSI-RS(s).
In another example (Option-2), the second triggering channel(s)/signal(s) could correspond to or could be associated/specific to a higher layer message carried by/in a PDSCH, wherein the higher layer message could be a SIB message (e.g., SIB1, SIB2 or other SIB message(s)), a RRC message (e.g., a RRC reconfiguration message, a RRC setup message, a RRC release message, and/or etc.), a MAC CE message/signaling, and/or etc.; furthermore, the PDSCH could be scheduled/activated by a corresponding DCI format. The CRC of the higher layer message and/or the corresponding DCI format could be scrambled with a RNTI, wherein the RNTI could be associated with the early triggered CSI-RS(s). In this case, the higher layer message could carry, convey, include or comprise the one or more second indicators as specified/defined herein in the present disclosure.
In another example (Option-3), the second triggering channel(s)/signal(s) could correspond to or could be associated/specific to one or more paging occasions (POs) or a paging early indication (PEI) associated with a PO, wherein the PEI could include an indication for each subgroup of a PO whether there is a corresponding paging message for the UEs of that subgroup. In this case, the PO(s)/PEI could comprise, contain, include, convey or carry the one or more second indicators as specified/defined herein in the present disclosure. In addition, the PEI could be carried or conveyed using a DCI format (e.g., DCI format 2_7).
In another example (Option-4), the second triggering channel(s)/signal(s) could correspond to or could be associated/specific to a random access response (RAR)—e.g., Msg2—to a preamble transmission for a contention based or a contention free random access procedure; in this case, the RAR (e.g., Msg2) could also include, comprise, carry or convey the one or more second indicators as specified/defined herein in the present disclosure. Optionally, the second triggering channel(s)/signal(s) could correspond to or could be associated/specific to a contention resolution message (e.g., a MAC CE) providing a C-RNTI for the UE, or in Msg4, of a contention based random access procedure; in this case, the contention resolution message (e.g., Msg4) could also include, comprise, carry or convey the one or more second indicators as specified/defined herein in the present disclosure. Alternatively, the second triggering channel(s)/signal(s) could correspond to or could be associated/specific to a MsgB of a Type-2 random access procedure, wherein the MsgB could be for success RAR (e.g., of a contention based random access procedure) or a fall back RAR (e.g., of a contention free random access procedure); in this case, the MsgB (or the success RAR or fall back RAR) could also include, comprise, carry or convey the one or more second indicators as specified/defined herein in the present disclosure.

The UE could determine or identify which one or more of the Option-1, Option-2, Option-3 and Option-4 to use or follow or apply to determine or identify the second triggering channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more second indicators could correspond to or comprise, or could be in form/terms of one or more of:
A one-bit flag indicator (e.g., a new one-bit DCI field in the DCI format(s) as specified/defined in Option-1) with ‘i’ (or ‘0’) indicating or enabling or triggering (early) CSI measurement and/or reporting
A (higher layer) parameter set to ‘enabled’ or ‘on’ indicating or enabling or triggering (early) CSI measurement and/or reporting
A message indicating ACK or NACK in response to the first indicator(s) transmitted/sent in the first channel(s)/signal(s); for instance, the message could be a one-bit indicator with ‘1’ (or ‘0’) indicating ACK in response to the first indicator(s) transmitted/sent in the first channel(s)/signal(s), and ‘0’ (or ‘1’) indicating NACK in response to the first indicator(s) transmitted/sent in the first channel(s)/signal(s)

The one or more second indicators could be present or absent in their corresponding second triggering channel(s)/signal(s) according to network's configuration or indication (e.g., via RRC signaling(s)/configuration(s)). For instance, the UE (e.g., the UE 116) could be provided or indicated or configured by the network (e.g., the network 130) a higher layer parameter/signaling denoted by EarlyCSITrigger_PresentInDCI. In this case, when/if the higher layer parameter/signaling EarlyCSITrigger_PresentInDCI is provided/configured and/or set to ‘enabled’ or ‘on’, the second indicator(s) as specified/defined herein in the present disclosure could be present in the corresponding DCI format(s) as specified/defined in Option-1 following those specified herein in the present disclosure; otherwise, i.e., when/if the higher layer parameter/signaling EarlyCSITrigger_PresentInDCI is not provided/configured and/or set to ‘disabled’ or ‘off’, the second indicator(s) as specified/defined herein in the present disclosure may not be present or could be absent in the corresponding DCI format(s) as specified/defined in Option-1 according to those specified herein in the present disclosure.

In FIG. 11, conceptual examples of first and second channels/signals to carry, convey, provide or indicate the first and second indicators respectively in RACH procedure(s) are presented according to or following those specified herein in the present disclosure.

Furthermore, as illustrated in FIG. 14 (Mode-A), after the UE has detected/received the second indicator(s) transmitted/sent from the network in the second channel(s)/signal(s), the UE could transmit, in one or more third channels/signals, the measurement result(s). According to those specified herein in the present disclosure, the UE could determine or identify the one or more third channels/signals to transmit or send the measurement result(s) based on or according to:
In one example (Alt-A), the one or more third channels/signals could correspond to or could be associated/specific to (periodic or periodically configured) PUCCH(s) or PUCCH resource(s), wherein the corresponding PUCCH resource configuration(s) including time-frequency resource allocation(s) for the PUCCH(s)/PUCCH resource(s) provided by PUCCH-Config, PUCCH-Resource, PUCCH-ResourceSet, and/or etc. could be provided or indicated in the higher layer parameter(s) including SIB1, SIB2, RRCRelease-IEs and/or etc. that provides or indicates the CSI-RS resource configuration(s) for the early triggering of the CSI measurement and/or reporting as specified/defined herein in the present disclosure.
In another example (Alt-B), the one or more third channels/signals could correspond to or could be associated/specific to (periodic or periodically configured) PUSCH(s) or PUSCH resource(s)—e.g., Type1/2 CG PUSCH(s), wherein the corresponding PUSCH resource configuration(s) including time-frequency resource allocation(s) for the PUSCH(s)/PUSCH resource(s) provided by PUSCH-Config and/or etc. could be provided or indicated in the higher layer parameter(s) including SIB1, SIB2, RRCRelease-IEs and/or etc. that provides or indicates the CSI-RS resource configuration(s) for the early triggering of the CSI measurement and/or reporting as specified/defined herein in the present disclosure.
In another example (Alt-C), the one or more third channels/signals could correspond to or could be associated/specific to one or more PUSCH(s) or PUSCH resource(s) scheduled or activated by a DCI format(s), wherein the DCI format(s) could correspond to the one or more second triggering channels/signals as specified/defined in Option-1 in the present disclosure.
In another example (Alt-D), the third channel(s)/signal(s) could correspond to the UL channel(s)/signal(s) including PUCCH(s)/PUSCH(s)/PRACH(s)/SRS(s) and/or etc. corresponding/associated/specific to the higher layer message(s) as specified/defined in Option-2 in the present disclosure. For instance, the UL channel(s)/signal(s) herein could be associated with or after a PRACH preamble transmission as indicated or configured or provided by the higher layer message(s) as specified/defined in Option-2 in the present disclosure. Optionally, the UL channel(s)/signal(s) herein could be associated with or after a RACH scheduled transmission or a Msg3 as indicated or configured or provided by the higher layer message(s) as specified/defined in Option-2 in the present disclosure. Furthermore, the UL channel(s)/signal(s) herein could be associated with or after a MsgA as indicated or configured or provided by the higher layer message(s) as specified/defined in Option-2 in the present disclosure.
In another example (Alt-E), the third channel(s)/signal(s) could correspond to the UL channel(s)/signal(s) including PUCCH(s)/PUSCH(s)/PRACH(s)/SRS(s) and/or etc. corresponding/associated/specific to the PEI(s) or paging message(s), e.g., corresponding to/for one or more POs, as specified/defined in Option-3 in the present disclosure. For instance, the UL channel(s)/signal(s) herein could be associated with or after a PRACH preamble transmission as indicated or configured or provided by the PEI(s)/paging message(s) as specified/defined in Option-3 in the present disclosure. Optionally, the UL channel(s)/signal(s) herein could be associated with or after a RACH scheduled transmission or a Msg3 as indicated or configured or provided by the PEI(s)/paging message(s) as specified/defined in Option-3 in the present disclosure. Furthermore, the UL channel(s)/signal(s) herein could be associated with or after a MsgA as indicated or configured or provided by the PEI(s)/paging message(s) as specified/defined in Option-3 in the present disclosure.
In another example (Alt-F), the third channel(s)/signal(s) could correspond to or could be associated/specific to a PRACH transmission or a RACH preamble transmission—e.g., Msg1; in this case, a PRACH preamble of Msg1 could also indicate the measurement result(s) as specified/defined herein in the present disclosure. Alternatively, the third channel(s)/signal(s) could correspond to or could be associated/specific to a RACH scheduled transmission—e.g., Msg3; in this case, the PUSCH transmission providing Msg3 and/or scheduled by RAR could also include, comprise, carry or convey the measurement result(s) as specified/defined herein in the present disclosure. Optionally, the third channel(s)/signal(s) could correspond to or could be associated/specific to a MsgA of Type-2 random access procedure; in this case, the PRACH (preamble) or PUSCH transmission providing MsgA could also include, comprise, carry or convey the measurement result(s) as specified/defined herein in the present disclosure. In addition, the third channel(s)/signal(s) could correspond to the UL channel(s)/signal(s) including PUCCH(s)/PUSCH(s)/PRACH(s)/SRS(s) and/or etc. associated with or after a RACH scheduled (PUSCH) transmission or a Msg3 as indicated or configured or provided by the RAR as specified/defined in Option-4 in the present disclosure.
In another example (Alt-G), the third channel(s)/signal(s) could correspond to or could be associated/specific to an uplink wake-up signal (UL WUS). The UL WUS is received by a low power radio (low power receiver) in the gNB. In one example, an UL WUS is OOK-1 (on off keying type 1) as described in TR 38.869. In another example, an UL WUS is OOK-2 [TR 38.869]. In another example, an UL WUS is OOK-3 [TR 38.869]. In another example, an UL WUS is OOK-4 [TR 38.869].

The UE could determine or identify UL resource(s) or resource allocation(s) for the one or more third channel(s)/signal(s) according to or based on one or more of: (a-1) (pre-)configured UL resource(s) and/or (pre-)configuration of UL resource(s) or resource allocation(s), (a-2) network's (dynamic) indication of UL resource(s) or resource allocation(s), and (a-3) UE's autonomous determination or selection of UL resource(s) or resource allocation(s), which could be sent to the network via various UL channels/signals.

For (a-1) discussed herein, according to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, (pre-)configured UL resource(s) or resource allocation(s) or resource configuration(s)—or denoted by second UL resource(s)/resource configuration(s)—for the one or more third channels/signals as specified/defined herein in the present disclosure.
For PUCCH(s) or PUCCH resource(s) in Alt-A, the (pre-)configured UL resource(s) or resource allocation(s) or resource configuration(s) could be provided by PUCCH-Config, PUCCH-Resource, PUCCH-ResourceSet and/or etc., and/or could comprise or provide or contain or include one or more of:
   Time domain resources, including symbols (e.g., OFDM symbols) within a slot or sub-frame or frame to transmit the PUCCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUCCH(s) and/or PUCCH resource(s). Frequency domain resources can include one or more of number of resources, starting resource and/or ending resource.
   ID of code or sequence for PUCCH(s) and/or PUCCH resource(s).
   Cyclic shift for PUCCH(s) and/or PUCCH resource(s).
   PUCCH configuration index, wherein the PUCCH configuration index points to a PUCCH configuration in a set or list of configured PUCCH resources.
   PUCCH format (e.g., PUCCH Format 0 or PUCCH Format 1 or PUCCH Format 2 or PUCCH Format 3 or PUCCH Format 4).
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUCCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUCCH associated with the determined CSI-RS.
For PUSCH(s) or PUSCH resource(s) in Alt-B and/or Alt-C, the (pre-)configured UL resource(s) or resource allocation(s) or resource configuration(s) could be provided by PUSCH-Config and/or etc., and/or could comprise or provide or contain or include one or more of:
   Time domain resources, including symbols (e.g., OFDM symbols) within a slot or sub-frame or frame to transmit the PUSCH(s), including one or more of the number of symbols, the starting symbol and/or the ending symbol.
   Time domain resources including periodicity and offset within the periodicity, wherein the periodicity and/or offset with a periodicity can be in time-units, where time-units is as described herein in this disclosure. In one example, time domain resources can include an offset (e.g., in time-units) from a corresponding reference signal (e.g., SSB or CSI-RS are described in the following).
   Frequency domain resources including sub-carriers and/or PRBs and/or sub-channels (a sub-channel is a group of PRBs) and/or interlaces for transmission of PUSCH(s) and/or PUSCH resource(s). Frequency domain resources can include one or more of number of resources, starting resource and/or ending resource.
   ID of code or sequence for PUSCH(s) and/or PUSCH resource(s).
   PUSCH configuration index, wherein the PUSCH configuration index points to a PUSCH configuration in a set or list of configured PUSCH resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PUSCH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PUSCH associated with the determined CSI-RS.
For PRACH transmission(s) in Alt-D, Alt-E and/or Alt-F, the (pre-)configured UL resource(s) or resource allocation(s) or resource configuration(s) could be provided by RACH-Config, RACH-ConfigCommon and/or RACH-ConfigDedicated, and/or could comprise or provide or contain or include one or more of:
   Time domain resources, including symbols (e.g., OFDM symbols) within a slot or sub-frame or frame to transmit the PRACH(s), including one or more of the number of symbols, the starting symbol and/or the ending symbol.
   Time domain resources including PRACH occasions.
   Time domain resources including periodicity and offset within the periodicity, wherein the periodicity and/or offset with a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group of PRBs) and/or interlaces for transmission of PRACH(s) and/or PRACH resource(s) and/or PRACH occasion(s). Frequency domain resources can include one or more of number of resources, starting resource and/or ending resource.
   Root sequence and/or cyclic shift.
   PRACH configuration index.
   Preamble format.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the PRACH associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the PRACH associated with the determined CSI-RS.
For UL WUS in Alt-G, the corresponding (pre-)configured UL resource(s) or resource allocation(s) or resource configuration(s) could comprise or provide or contain or include one or more of:
   Time domain resources, including symbols (e.g., OFDM symbols) within a slot or sub-frame or frame to transmit the UL WUS(s), including one or more of the number of symbols, the starting symbol and/or the ending symbol.
   Time domain resources including periodicity and offset within the periodicity, wherein the periodicity and/or offset within a periodicity can be in time-units, where time-units is as described herein in this disclosure.
   In one example, time domain resources can include an offset (e.g., in time-units) from a corresponding reference signal (e.g., SSB or CSI-RS are described in the following).
   Frequency domain resource including sub-carriers and/or PRBs and/or sub-channels (a sub-channel is a group or number of PRBs) and/or interlaces for transmission of the UL WUS(s). Frequency domain resources can include one or more of number of resources, starting resource and/or ending resource.
   Comb size and comb offset if a comb structure is used for the frequency resources. For example, a comb of size M, transmits every M-th frequency resource starting from an offset (comb offset).
   ID of code or sequence. For example, this can be an overlaid sequence on the UL WUS(s).
   UL WUS configuration index, wherein the UL WUS configuration index points to a UL WUS configuration in a set or list of configured UL WUS resources.
   A spatial domain transmission filter. In one example, the spatial domain transmission filter corresponds to an SSB (Synchronization Signal/Physical Broadcast Channel (PBCH) Block—SS/PBCH Block). A UE determines an SSB, e.g., SSB with RSRP above a configured threshold or SSB with the largest RSRP), and selects or determines a resource for the UL WUS associated with the determined SSB. In another example, the spatial domain transmission filter corresponds to an CSI-RS (Channel State Information Reference Signal), e.g., CSI-RS ID. A UE determines a CSI-RS, e.g., CSI-RS with RSRP above a configured threshold or CSI-RS with the largest RSRP), and selects or determines a resource for the UL WUS associated the determined CSI-RS.

Furthermore, the UE could transmit or send or indicate to the network, in/by/via the third channel(s)/signal(s), the measurement result(s) according to or based on one or more of the followings.
In one example, the UE could transmit or send or indicate to the network the third channel(s)/signal(s) carrying or conveying the measurement result(s) using or via a/the most recent in time and/or available UL resource(s) a minimum time T_1 from the end (or start) of the second triggering channel(s)/signal(s). For instance, for Option-1, the second triggering channel(s)/signal(s) as mentioned herein could correspond to a PDCCH reception providing the DCI format(s) triggering the CSI measurement and/or reporting.
In another example, the symbol or slot or subframe or frame used by a UE to transmit the measurement result(s) could be a/the most recent in time and/or available UL resource(s) at or after a time T_1 from the end (or start) of the second triggering channel(s)/signal(s). For instance, for Option-1, the second triggering channel(s)/signal(s) as mentioned herein could correspond to a PDCCH reception providing the DCI format(s) triggering the CSI measurement and/or reporting.
In another example, the symbol or slot or subframe or frame used by a UE to transmit the measurement result(s) could be that first symbol or slot or subframe or frame that starts at or after a time T_1 from the end (or start) of the second triggering channel(s)/signal(s) and optionally based on a time offset/gap. For instance, for Option-1, the second triggering channel(s)/signal(s) as mentioned herein could correspond to a PDCCH reception providing the DCI format(s) triggering the CSI measurement and/or reporting.

The time T_1 and/or the time offset/gap could be in number of symbol(s), slot(s), subframe(s), frame(s) and/or etc. Furthermore, the UE could determine or identify the value(s) of the time T_1 and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_1 and/or the time offset/gap could be indicated or provided by/in the DCI format(s) that trigger(s) the CSI measurement and/or reporting—as in Option-1 in the present disclosure.
For example, one or more new DCI fields in the DCI format(s) could indicate or provide the value(s) of the time T_1 and/or the time offset/gap.
For another example, one or more existing DCI fields in the DCI format(s) could be repurposed to indicate or provide the value(s) of the time T_1 and/or the time offset/gap.

The value(s) of the time T_1 and/or the time offset/gap could be present or absent in their corresponding second triggering channel(s)/signal(s) according to network's configuration or indication (e.g., via RRC signaling(s)/configuration(s)). For instance, the UE could be provided or indicated or configured by the network a higher layer parameter/signaling denoted by timeIndicationCSI_PresentInDCI. In this case, when/if the higher layer parameter/signaling timeIndicationCSI_PresentInDCI is provided/configured and/or set to ‘enabled’ or ‘on’, the value(s) of the time T_1 and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationCSI_PresentInDCI is not provided/configured and/or set to ‘disabled’ or ‘off’, the value(s) of the time T_1 and/or the time offset/gap as specified/defined herein in the present disclosure may not be present or could be absent in the corresponding DCI format(s) as specified/defined in Option-1 according to those specified herein in the present disclosure. In this case, when/if the network does not receive or detect the measurement result(s) transmitted from the UE,
a minimum time M_1 from the end (or start) of the second triggering channel(s)/signal(s)—for instance, for Option-1, the second triggering channel(s)/signal(s) as mentioned herein could correspond to a PDCCH reception providing the DCI format(s) triggering the CSI measurement and/or reporting, and/or
at or after a time M_1 from the end (or start) of the second triggering channel(s)/signal(s)—for instance, for Option-1, the second triggering channel(s)/signal(s) as mentioned herein could correspond to a PDCCH reception providing the DCI format(s) triggering the CSI measurement and/or reporting, and/or
at or after a time M_1 from the end (or start) of the second triggering channel(s)/signal(s) and optionally based on a time offset/gap—for instance, for Option-1, the second triggering channel(s)/signal(s) as mentioned herein could correspond to a PDCCH reception providing the DCI format(s) triggering the CSI measurement and/or reporting,
   the network could (dynamically) indicate to the UE, e.g., by/in/via higher layer RRC signaling(s)/parameter(s) and/or MAC CE command(s) and/or dynamic DCI based L1 signaling(s) based on or according to a corresponding UE's capability or capability signaling, UL resource(s) and/or UL resource allocation(s) for (re-)transmitting the measurement result(s) according to or based on those specified herein in the present disclosure.

For (a-2) discussed herein, according to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, (pre-)configured UL resource(s) or resource allocation(s) or resource configuration(s) for the one or more third channels/signals as specified/defined herein in the present disclosure. The UE could then receive from the network, e.g., via higher layer RRC signaling(s)/parameter(s) and/or MAC CE command(s) and/or dynamic DCI based L1 signaling(s), one or more indicators to indicate which one or more of the (pre-)configured UL resource(s) or resource(s) or resource configuration(s) to use or apply for determining or identifying UL resource(s) to transmit or send the measurement result(s) in the third channel(s)/signal(s).

For (a-3) discussed herein, according to those specified/defined herein in the present disclosure, the UE could be provided or configured or indicated by the network, e.g., via higher layer RRC signaling(s) and/or MAC CE command(s) and/or dynamic DCI based L1 signaling(s) based on or according to a corresponding UE's capability or capability signaling, (pre-)configured UL resource(s) or resource allocation(s) or resource configuration(s) for the one or more third channels/signals as specified/defined herein in the present disclosure. The UE could then transmit or indicate or send to the network one or more indicators to indicate which one or more of the (pre-)configured UL resource(s) or resource(s) or resource configuration(s) the UE could or would use or apply for determining or identifying UL resource(s) to transmit or send the measurement result(s) in the third channel(s)/signal(s).

For Mode-A, the UE (e.g., the UE 116) could expect to receive from the network (e.g., the network 130), in/by/via the second channel(s)/signal(s), the second indicator(s) to trigger the (early) CSI measurement and/or reporting according to or based on one or more of the followings.
In one example, the UE could expect to receive from the network, in/by/via the second channel(s)/signal(s), the second indicator(s) for the (early) triggering of the CSI measurement and/or reporting a minimum time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the CSI measurement and/or reporting could be at or after a time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the CSI measurement and/or reporting could be that first symbol or slot or subframe or frame that starts at or after a time T_2 from the end (or start) of the first channel(s)/signal(s) and optionally based on a time offset/gap.

The time T_2 and/or the time offset/gap could be in number of symbol(s), slot(s), subframe(s), frame(s) and/or etc. Furthermore, the UE could determine or identify the value(s) of the time T and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_2 and/or the time offset/gap could be indicated or provided by/in the DCI format(s) that trigger(s) the CSI measurement and/or reporting—as in Option-1 in the present disclosure.
For example, one or more new DCI fields in the DCI format(s) could indicate or provide the value(s) of the time T_2 and/or the time offset/gap.
For another example, one or more existing DCI fields in the DCI format(s) could be repurposed to indicate or provide the value(s) of the time T_2 and/or the time offset/gap.

The value(s) of the time T_2 and/or the time offset/gap could be present or absent in their corresponding first channel(s)/signal(s) according to network's configuration or indication (e.g., via RRC signaling(s)/configuration(s)). For instance, the UE could be provided or indicated or configured by the network a higher layer parameter/signaling denoted by timeIndicationCSITrigger_PresentInDCI. In this case, when/if the higher layer parameter/signaling timeIndicationCSITrigger_PresentInDCI is provided/configured and/or set to ‘enabled’ or ‘on’, the value(s) of the time T_2 and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationCSITrigger_PresentInDCI is not provided/configured and/or set to ‘disabled’ or ‘off’, the value(s) of the time T_2 and/or the time offset/gap as specified/defined herein in the present disclosure may not be present or could be absent in the corresponding DCI format(s) as specified/defined in Option-1 according to those specified herein in the present disclosure. When/if the UE does not from the network, in/by/via the second channel(s)/signal(s), the second indicator(s) to trigger the (early) CSI measurement and/or reporting according to or based on the timeline(s) or timing relation(s) mentioned herein, the UE could (re-)transmit or (re-)send to the network, in/via/by one or more first channels/signals, one or more first indicators to request the (early) triggering of the CSI measurement and/or reporting, wherein here the UE could determine or identify the one or more first channels/signals including the corresponding UL resource(s) and/or resource allocation(s) and/or the one or more first indicator(s) according to or following those specified herein in the present disclosure.

FIG. 15 illustrates a signal flow of an example procedure 1500 for early triggering of CSI measurement and reporting according to embodiments of the present disclosure. For example, procedure 1500 can be performed by the UE 116 and the gNB 103 and/or network 130 in the wireless network 100 of FIG. 1. This example is for illustration only and other embodiments can be used without departing from the scope of the present disclosure.

The procedure begins in 1510, a NW/gNB transmits configuration(s) of CSI-RS resource(s) to a UE for early triggering—e.g., via SIB, RRC release message, etc. In 1520, the UE transmits first indicator(s) sent in first channel(s)/signal(s) to the NW/gNB to trigger CSI measurement/reporting. In 1530, the NW/gNB transmits second indicator(s) sent in second channel(s)/signal(s) to the UE to indicate UL resource(s) for the measurement result(s). In 1540, the UE transmits measurement result(s) in third channel(s)/signal(s) to the NW/gNB.

In one example (Mode-B), after a UE has received from the network the CSI-RS resource configuration(s) for the early triggering of the CSI measurement and/or reporting according to or following those specified herein in the present disclosure, the UE could send or indicate or transmit to the network, via/in/by one or more first channels/signals, a first indicator to trigger (early) CSI measurement and/or reporting. For this design example, the UE could expect to receive from the network, in/via/by one or more second triggering channels/signals, one or more second indicators to indicate UL resource(s) and/or resource allocation(s) for transmitting the measurement result(s)—as in (a-2) in the present disclosure. Upon detection and/or reception of the one or more second indicators, the UE could determine or identify, based on or according to the CSI-RS resource configuration(s) and allocation(s), the CSI-RS(s) along with the corresponding parameter(s)/setting(s) to receive and measure. In this case, the UE could then transmit or send to the network, in/via/by one or more third channels/signals, the measurement result(s). In FIG. 15, an example signaling flow between a UE and a gNB (e.g., the BS 102)/network for Mode-B is presented.

For Mode-B, the one or more first indicators could correspond to a one-bit indicator (e.g., a one-bit UCI or a one-bit scheduling request (SR) provided by a SR configuration) or a multi-bit indicator. For instance, when/if the one or more first indicators correspond to a one-bit indicator, and/or when/if the UE has sent or indicated or transmitted to the network, the one or more first indicators set to ‘1’ or ‘positive’ or ‘on’ or etc., the UE could indicate to the network that (early) CSI measurement and/or reporting is triggered. Furthermore, the one or more first channels/signals in Mode-B could correspond to or could be associated/specific to one or more of Alt-1, Alt-2, . . . , Alt-10 as specified/defined herein in the present disclosure for the one or more first channels/signals for Mode-A. Furthermore, the UE could determine or identify resource configuration(s) for the one or more first channels/signals in Mode-B as or according to or based on the resource configuration(s) for the one or more first channels/signals in Mode-A as specified/defined herein in the present disclosure. For Mode-B, the UE could determine or identify the one or more second channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the second channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more second indicators could correspond to or comprise, or could be in form/terms of one or more of:
A message indicating ACK or NACK in response to the first indicator(s) transmitted/sent in the first channel(s)/signal(s); for instance, the message could be a one-bit indicator with ‘1’ (or ‘0’) indicating ACK in response to the first indicator(s) transmitted/sent in the first channel(s)/signal(s), and ‘0’ (or ‘1’) indicating NACK in response to the first indicator(s) transmitted/sent in the first channel(s)/signal(s)
UL resource(s) or resource allocation(s)/indication(s) as in (a-2) for the third channel(s)/signal(s) to carry or convey the measurement result(s)

The one or more second indicators could be present or absent in their corresponding second channel(s)/signal(s) according to network's configuration or indication (e.g., via RRC signaling(s)/configuration(s)). For instance, the UE could be provided or indicated or configured by the network a higher layer parameter/signaling denoted by earlyCSIRa_PresentInDCI. In this case, when/if the higher layer parameter/signaling earlyCSIRa_PresentInDCI is provided/configured and/or set to ‘enabled’ or ‘on’, the second indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSIRa_PresentInDCI is not provided/configured and/or set to ‘disabled’ or ‘off’, the second indicator(s) as specified/defined herein in the present disclosure may not be present or could be absent in the corresponding DCI format(s) as specified/defined in Option-1 according to those specified herein in the present disclosure.

Furthermore, for Mode-B, after the UE has detected/received the second indicator(s) transmitted/sent from the network in the second channel(s)/signal(s), the UE could transmit, in one or more third channels/signals, the measurement result(s). According to those specified herein in the present disclosure, the UE could determine or identify the one or more third channels/signals to transmit or send the measurement result(s) based on or according to one or more of Alt-A, Alt-B, Alt-C, Alt-D, Alt-E, Alt-F and Alt-G as specified/defined for the one or more third channels/signals as in Mode-A in the present disclosure. The UE could determine or identify UL resource(s) or resource allocation(s) for the one or more third channels/signals in Mode-B according to or based on network's (dynamic) indication of UL resource(s) or resource allocation(s) as in (a-2), provided/indicated by the second indicator(s) transmitted or sent in the second channel(s)/signal(s) as mentioned herein in Mode-B.

For Mode-B, the UE could expect to receive from the network, in/by/via the second channel(s)/signal(s), the second indicator(s) to provide or indicate UL resource(s) or resource allocation(s) for transmitting or sending the measurement result(s) according to or based on one or more of the followings.
In one example, the UE could expect to receive from the network, in/by/via the second channel(s)/signal(s), the second indicator(s) to provide or indicate UL resource(s) or resource allocation(s) for transmitting or sending the measurement result(s) a minimum time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the CSI measurement and/or reporting could be at or after a time T_2 from the end (or start) of the first channel(s)/signal(s).
In another example, the symbol or slot or subframe or frame for the UE to expect to receive from the network, in/by/via the second channel(s)/signal(s), the second indicator(s) for the (early) triggering of the CSI measurement and/or reporting could be that first symbol or slot or subframe or frame that starts at or after a time T_2 from the end (or start) of the first channel(s)/signal(s) and optionally based on a time offset/gap.

The time T_2 and/or the time offset/gap could be in number of symbol(s), slot(s), subframe(s), frame(s) and/or etc. Furthermore, the UE could determine or identify the value(s) of the time T and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_2 and/or the time offset/gap could be indicated or provided by/in the DCI format(s) that trigger(s) the CSI measurement and/or reporting—as in Option-1 in the present disclosure.
For example, one or more new DCI fields in the DCI format(s) could indicate or provide the value(s) of the time T_2 and/or the time offset/gap.
For another example, one or more existing DCI fields in the DCI format(s) could be repurposed to indicate or provide the value(s) of the time T_2 and/or the time offset/gap.

The value(s) of the time T_2 and/or the time offset/gap could be present or absent in their corresponding first channel(s)/signal(s) according to network's configuration or indication (e.g., via RRC signaling(s)/configuration(s)). For instance, the UE could be provided or indicated or configured by the network a higher layer parameter/signaling denoted by timeIndicationCSITrigger_PresentInDCI. In this case, when/if the higher layer parameter/signaling timeIndicationCSITrigger_PresentInDCI is provided/configured and/or set to ‘enabled’ or ‘on’, the value(s) of the time T_2 and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationCSITrigger_PresentInDCI is not provided/configured and/or set to ‘disabled’ or ‘off’, the value(s) of the time T_2 and/or the time offset/gap as specified/defined herein in the present disclosure may not be present or could be absent in the corresponding DCI format(s) as specified/defined in Option-1 according to those specified herein in the present disclosure. When/if the UE does not from the network, in/by/via the second channel(s)/signal(s), the second indicator(s) to trigger the (early) CSI measurement and/or reporting according to or based on the timeline(s) or timing relation(s) mentioned herein, the UE could (re-)transmit or (re-)send to the network, in/via/by one or more first channels/signals, one or more first indicators to request the (early) triggering of the CSI measurement and/or reporting, wherein here the UE could determine or identify the one or more first channels/signals including the corresponding UL resource(s) and/or resource allocation(s) and/or the one or more first indicator(s) according to or following those specified herein in the present disclosure.

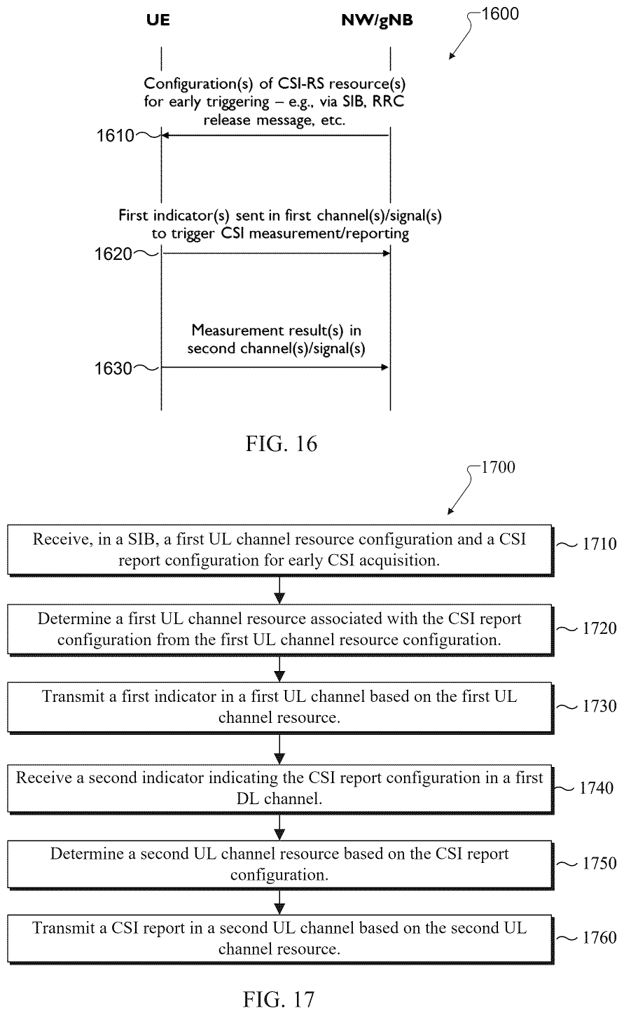

FIG. 16 illustrates a signal flow of an example procedure 1600 for early triggering of CSI measurement and reporting according to embodiments of the present disclosure. For example, procedure 1600 can be performed by the UE 116 and the gNB 102 and/or network 130 in the wireless network 100 of FIG. 1. This example is for illustration only and other embodiments can be used without departing from the scope of the present disclosure.

The procedure begins in 1610, a NW/gNB transmits configuration(s) of CSI-RS resource(s) to a UE for early triggering—e.g., via SIB, RRC release message, etc. In 1620, the UE transmits first indicator(s) sent in first channel(s)/signal(s) to the NW/gNB to trigger CSI measurement/reporting. In 1630, the UE transmits measurement result(s) in second channel(s)/signal(s) to the NW/gNB.

In one example (Mode-C), after a UE has received from the network the CSI-RS resource configuration(s) for the early triggering of the CSI measurement and/or reporting according to or following those specified herein in the present disclosure, the UE could send or indicate or transmit to the network, via/in/by one or more first channels/signals, a first indicator to trigger (early) CSI measurement and/or reporting. For this design example, the UE could determine or identify, based on or according to the CSI-RS resource configuration(s) and allocation(s), the CSI-RS(s) along with the corresponding parameter(s)/setting(s) to receive and measure. In this case, the UE could then transmit or send to the network, in/via/by one or more second channels/signals, the measurement result(s). In FIG. 16, an example signaling flow between a UE and a gNB/network for Mode-C is presented.

For Mode-C, the one or more first indicators could correspond to a one-bit indicator (e.g., a one-bit UCI or a one-bit scheduling request (SR) provided by a SR configuration) or a multi-bit indicator. For instance, when/if the one or more first indicators correspond to a one-bit indicator, and/or when/if the UE has sent or indicated or transmitted to the network, the one or more first indicators set to ‘1’ or ‘positive’ or ‘on’ or etc., the UE could indicate to the network that (early) CSI measurement and/or reporting is triggered. Furthermore, the one or more first channels/signals in Mode-C could correspond to or could be associated/specific to one or more of Alt-1, Alt-2, . . . , Alt-10 as specified/defined herein in the present disclosure for the one or more first channels/signals for Mode-A. Furthermore, the UE could determine or identify resource configuration(s) for the one or more first channels/signals in Mode-C as or according to or based on the resource configuration(s) for the one or more first channels/signals in Mode-A as specified/defined herein in the present disclosure.

Furthermore, for Mode-C, after the UE has transmitted or sent to the network, in/via/by the first channel(s)/signal(s), the first indicator(s) to trigger the (early) CSI measurement and/or reporting, the UE could then transmit, in one or more second channels/signals, the measurement result(s). According to those specified herein in the present disclosure, the UE could determine or identify the one or more second channels/signals to transmit or send the measurement result(s) based on or according to one or more of Alt-A, Alt-B, Alt-C, Alt-D, Alt-E, Alt-F and Alt-G as specified/defined for the one or more third channels/signals as in Mode-A in the present disclosure. The UE could determine or identify UL resource(s) or resource allocation(s) for the one or more second channels/signals in Mode-C according to or based on (pre-)configured UL resource(s) and/or (pre-)configuration of UL resource(s) or resource allocation(s) as specified, described or discussed in (a-1), and/or UE's autonomous determination or selection of UL resource(s) or resource allocation(s) as in (a-3), which could be sent to the network via various UL channels/signals.

For Mode-C, the UE could transmit or send or indicate to the network, in/by/via the second channel(s)/signal(s), the measurement result(s) according to or based on one or more of the followings.
In one example, the UE could transmit or send or indicate to the network the second channel(s)/signal(s) carrying or conveying the measurement result(s) using or via a/the most recent in time and/or available UL resource(s) a minimum time T_3 from the end (or start) of the first triggering channel(s)/signal(s).
In another example, the symbol or slot or subframe or frame used by a UE to transmit the measurement result(s) could be a/the most recent in time and/or available UL resource(s) at or after a time T_3 from the end (or start) of the first triggering channel(s)/signal(s).
In another example, the symbol or slot or subframe or frame used by a UE to transmit the measurement result(s) could be that first symbol or slot or subframe or frame that starts at or after a time T_3 from the end (or start) of the first triggering channel(s)/signal(s) and optionally based on a time offset/gap.

The time T_3 and/or the time offset/gap could be in number of symbol(s), slot(s), subframe(s), frame(s) and/or etc. Furthermore, the UE could determine or identify the value(s) of the time T_3 and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_3 and/or the time offset/gap could be indicated or provided by/in a DCI format.
For example, one or more new DCI fields in the DCI format could indicate or provide the value(s) of the time T_3 and/or the time offset/gap.
For another example, one or more existing DCI fields in the DCI format could be repurposed to indicate or provide the value(s) of the time T_3 and/or the time offset/gap.

The value(s) of the time T_3 and/or the time offset/gap could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationCSI_PresentInDCI. In this case, when/if the higher layer parameter/signaling timeIndicationCSI_PresentInDCI is provided/configured and/or set to ‘enabled’ or ‘on’, the value(s) of the time T_3 and/or the time offset/gap as specified/defined herein in the present disclosure could be present in the corresponding DCI format(s); otherwise, i.e., when/if the higher layer parameter/signaling timeIndicationCSI_PresentInDCI is not provided/configured and/or set to ‘disabled’ or ‘off’, the value(s) of the time T_3 and/or the time offset/gap as specified/defined herein in the present disclosure may not be present or could be absent in the corresponding DCI format(s).

When the design procedure(s), option(s) and example(s) in (a-1), (a-2) and/or (a-3) apply to Mode-C, the third channel(s)/signal(s)—used to carry or convey the measurement result(s) for Mode-A/B—in (a-1), (a-2) and/or (a-3) could correspond to or could be replaced by or could be equivalent to the second channel(s)—used to carry or convey the measurement result(s) for Mode-C.

The UE could indicate or send or transmit to the network, e.g., in their corresponding capability signaling(s), whether they are capable of supporting Mode-A, Mode-B and/or Mode-C. For instance, the corresponding capability signaling(s) could comprise one or more and/or a combination of one or more of the following components, wherein Component-1, Component-2 and/or Component-3 could be basic UE's capability/feature:
Component-1: support of Mode-A
Component-2: support of Mode-B
Component-3: support of Mode-C

In this case, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of Mode-A, Mode-B and Mode-C is enabled for the UE to transmit measurement result(s). For instance, when/if a UE is provided by a higher layer parameter enableModeAforEarlyCSIRS and/or set to ‘enabled’, the UE could follow those specified/defined in Mode-A in the present disclosure for the (early) triggering of the CSI measurement and/or reporting. When/if a UE is provided by a higher layer parameter enableModeACforEarlyCSIRS and/or set to ‘enabled’, the UE could follow those specified/defined in Mode-A and/or Mode-C in the present disclosure for the (early) triggering of the CSI measurement and/or reporting.

The UE could indicate or send or transmit to the network, e.g., in their corresponding capability signaling(s), whether they are capable of supporting (i) dynamic scheduling/indication of (second) UL resource(s) or resource configuration(s) to transmit the measurement result(s) and/or (ii) (pre-)configuration of (second) UL resource(s) or resource configuration(s) to transmit the measurement result(s). For instance, the corresponding capability signaling(s) could comprise one or more and/or a combination of one or more of the following components, wherein Component-A, Component-B could be basic UE's capability/feature:
Component-A: support of dynamic scheduling/indication of (second) UL resource(s) or resource configuration(s) to transmit the measurement result(s)—or equivalently, Mode-A and/or Mode-B
Component-B: support of (pre-)configuration of (second) UL resource(s) or resource configuration(s) to transmit the measurement result(s)—or equivalently, Mode-A and/or Mode-C

In this case, the UE (e.g., the UE 116) could be indicated or configured or provided by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of (i) and (ii) as specified/described herein is enabled for the UE to transmit measurement result(s). For instance, when/if a UE is provided by a higher layer parameter enableDynamicSchedulingforEarlyCSIRS and/or set to ‘enabled’, the UE could follow those specified/defined in Mode-A and/or Mode-B in the present disclosure for the (early) triggering of the CSI measurement and/or reporting. When/if a UE is provided by a higher layer parameter enablePreConfigurationforEarlyCSIRS and/or set to ‘enabled’, the UE could follow those specified/defined in Mode-A and/or Mode-C in the present disclosure for the (early) triggering of the CSI measurement and/or reporting.

As specified/defined herein in the present disclosure, for Mode-A and Mode-B, a UE could be indicated, provided or configured by the network, e.g., via higher layer RRC signaling(s)/parameter(s) and/or MAC CE command(s) and/or dynamic DCI based L1 signaling(s) based on or according to a corresponding UE's capability or capability signaling, UL resource(s) or resource allocation(s)—as in (a-2) in the present disclosure—for the measurement result(s) obtained according to the (early) triggered CSI-RS(s). For instance, the UE could receive from the network, in/via/by one or more first resource allocation/indication channels/signals, one or more first resource indicators to indicate or provide UL resource(s) or resource allocation(s)—as in (a-2) in the present disclosure—for the measurement result(s) obtained according to the (early) triggered CSI-RS(s).

For Mode-A, the UE could additionally receive from the network, in/via/by one or more fourth channels/signals, one or more third indicators to indicate or provide UL resource(s) or resource allocation(s) for the measurement result(s) obtained according to the (early) triggered CSI-RS(s). The UE could determine or identify the one or more fourth channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the fourth channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more third indicators could be present or absent in their corresponding fourth channel(s)/signal(s) according to network's configuration or indication (e.g., via RRC signaling(s)/configuration(s)). For instance, the UE could be provided or indicated or configured by the network a higher layer parameter/signaling denoted by earlyCSIRa_PresentInDCI. In this case, when/if the higher layer parameter/signaling earlyCSIRa_PresentInDCI is provided/configured and/or set to ‘enabled’ or ‘on’, the third indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSIRa_PresentInDCI is not provided/configured and/or set to ‘disabled’ or ‘off’, the third indicator(s) as specified/defined herein in the present disclosure may not be present or could be absent in the corresponding DCI format(s) as specified/defined in Option-1 according to those specified herein in the present disclosure. The one or more fourth channels/signals could be the same as or identical to the one or more second channels/signals in Mode-A; optionally, the one or more fourth channels/signals could be different or separate from the one or more second channels/signals in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more fourth channels/signals are the same as or identical to the one or more second channels/signals in Mode-A, the one or more third indicators could be the same as or identical to the one or more second indicators in Mode-A; optionally, the one or more third indicators could be different or separate from the one or more second indicators in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In this case (Mode-A), the one or more fourth channels/signals (or the one or more second channels/signals when/if the one or more fourth channels/signals are the same as or identical to the one or more second channels/signals) could correspond to the one or more first resource allocation/indication channels/signals, and the one or more third indicators (or the one or more second indicators when/if the one or more third indicators are the same as or identical to the one or more second indicators) could correspond to the one or more first resource indicators.

For Mode-B, the one or more second channels/signals could correspond to the one or more first resource allocation/indication channels/signals, and the one or more second indicators could correspond to the one or more first resource indicators.

Hence, for both Mode-A and Mode-B,
For Option-1 specified/defined herein in the present disclosure, the one or more first resource indicators could correspond to or could be provided/indicated in/by one or more new DCI fields in the DCI format(s), or one or more existing DCI fields (e.g., CSI request field in DCI format 0_1/0_2) in the DCI format(s) repurposed for indicating or providing resource allocation(s) for the measurement result(s) obtained according to the (early) triggered CSI-RS(s).
For Option-2 specified/defined herein in the present disclosure, the higher layer message could carry, convey, include or comprise the one or more first resource indicators as specified/defined herein in the present disclosure.
For Option-3 specified/defined herein in the present disclosure, the PO(s)/PEI could comprise, contain, include, convey or carry the one or more first resource indicators as specified/defined herein in the present disclosure.
For Option-4 specified/defined herein in the present disclosure, the RAR (e.g., Msg2) could also include, comprise, carry or convey the one or more first resource indicators as specified/defined herein in the present disclosure. Optionally, the contention resolution message (e.g., Msg4) could also include, comprise, carry or convey the one or more first resource indicators as specified/defined herein in the present disclosure. Alternatively, the MsgB (or the success RAR or fall back RAR) could include, comprise, carry or convey the one or more first resource indicators as specified/defined herein in the present disclosure.

The one or more first resource indicators could be present or absent in their corresponding first resource allocation/indication channel(s)/signal(s) according to network's configuration or indication (e.g., via RRC signaling(s)/configuration(s)). For instance, the UE could be provided or indicated or configured by the network a higher layer parameter/signaling denoted by earlyCSIRa_PresentInDCI. In this case, when/if the higher layer parameter/signaling earlyCSIRa_PresentInDCI is provided/configured and/or set to ‘enabled’ or ‘on’, the first resource indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSIRa_PresentInDCI is not provided/configured and/or set to ‘disabled’ or ‘off’, the first resource indicator(s) as specified/defined herein in the present disclosure may not be present or could be absent in the corresponding DCI format(s) as specified/defined in Option-1 according to those specified herein in the present disclosure.

In one example, the higher layer parameter(s)/signaling(s) including SIB1, SIB2, RRCRelease-IEs as specified/defined herein could provide or indicate or comprise multiple or more than one (K_early>1) CSI-RS resource configurations for the early triggering of the CSI measurement/reporting, wherein each of the CSI-RS resource configurations could be provided by EarlyCSI-ResourceConfig or EarlyCSI-ReportConfig, and could comprise or provide or include or configure, and/or could be linked/associated/specific to one or more CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more first resource indicators could correspond to or comprise, or could be in form/terms of one or more of:
A bitmap of length K_early with each entry/bit position of the bitmap associated/corresponding/specific to a CSI-RS resource configuration provided by EarlyCSI-ResourceConfig or EarlyCSI-ReportConfig for the early triggering of the CSI measurement/reporting. In this case, when/if an entry/bit position of the bitmap is set to ‘1’ (or ‘0’), the CSI-RS resource configuration associated/corresponding/specific to the entry/bit position could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration provided by EarlyCSI-ReportConfig—to transmit the measurement result(s) obtained according to the (early) triggered CSI-RS(s). For Option-1, the bitmap could be provided or indicated by a new DCI field in the corresponding DCI format(s).
One or more one-bit flag indicators each associated/corresponding/specific to a CSI-RS resource configuration provided by EarlyCSI-ResourceConfig or EarlyCSI-ReportConfig for the early triggering of the CSI measurement/reporting. In this case, when/if a one-bit flag indicator is set to ‘1’ (or ‘0’), the CSI-RS resource configuration associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration provided by EarlyCSI-ReportConfig—to transmit the measurement result(s) obtained according to the (early) triggered CSI-RS(s). For Option-1, the one or more one-bit flag indicators could be provided or indicated by one or more new DCI fields in the corresponding DCI format(s).
A x0-bit indicator with x0=┌log₂(K_early)┐: each codepoint/state of the x0-bit indicator could be associated/corresponding/specific to a CSI-RS resource configuration provided by EarlyCSI-ResourceConfig or EarlyCSI-ReportConfig for the early triggering of the CSI measurement/reporting. In this case, when a codepoint/state of the x0-bit indicator is indicated, the CSI-RS resource configuration associated/corresponding/specific to the codepoint/state of the x0-bit indicator could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration provided by EarlyCSI-ReportConfig—to transmit the measurement result(s) obtained according to the (early) triggered CSI-RS(s). For Option-1, the x0-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=4 CSI-RS resource configurations for the early triggering of the CSI measurement/reporting, wherein each of the CSI-RS resource configurations could be provided by EarlyCSI-ResourceConfig or EarlyCSI-ReportConfig; for this design example, x0=2 with codepoint/state ‘00’ indicating the first CSI-RS resource configuration or the CSI-RS resource configuration with the lowest configuration ID/index value, codepoint/state ‘01’ indicating the second CSI-RS resource configuration or the CSI-RS resource configuration with the second lowest configuration ID/index value, codepoint/state ‘10’ indicating the third CSI-RS resource configuration or the CSI-RS resource configuration with the second highest configuration ID/index value, and codepoint/state ‘11’ indicating the fourth CSI-RS resource configuration or the CSI-RS resource configuration with the highest configuration ID/index value.
One or more CSI-RS resource configuration IDs/ID values. In this case, the CSI-RS resource configuration(s) with or having the one or more CSI-RS resource configuration IDs/ID values could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration(s) provided by EarlyCSI-ReportConfig—to transmit the measurement result(s) obtained according to the (early) triggered CSI-RS(s). For Option-1, the one or more CSI-RS resource configuration IDs/ID values could be provided or indicated by one or more new DCI fields in the corresponding DCI format(s).
One or more indexes or index values denoted by k_1, . . . , k_x with each index or index value belonging to {1, . . . , K_early} or {0, . . . , K_early−1}, i.e., k_1, . . . , k_x∈{1, . . . , K_early} or {0, . . . , K_early−1}. In this case, the k_1-th, . . . , k_x-th CSI-RS resource configuration(s) among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the k_1-th, . . . , k_x-th CSI-RS resource configuration(s) provided by EarlyCSI-ReportConfig—to transmit the measurement result(s) obtained according to the (early) triggered CSI-RS(s). For Option-1, the one or more indexes or index values could be provided or indicated by one or more new DCI fields in the corresponding DCI format(s).
One or more trigger states each pointing/corresponding to an entry in a list of aperiodic CSI trigger states provided by CSI-AperiodicTriggerStateList. In this case, the CSI-RS resource configuration(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration(s) provided by EarlyCSI-ReportConfig—to transmit the measurement result(s) obtained according to the (early) triggered CSI-RS(s). For Option-1, the one or more trigger states could be provided or indicated by one or more CSI request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise K_early>1 groups of PRACH preambles with each group corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , K_early} or {0, . . . , K_early−1}), the x-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the x-th CSI-RS resource configuration provided by EarlyCSI-ReportConfig—to transmit the measurement result(s) obtained according to the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the K_early>1 subgroups of a PO such that each subgroup of the PO could be associated/corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , K_early} or {0, . . . , K_early−1}), the x-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the x-th CSI-RS resource configuration provided by EarlyCSI-ReportConfig—to transmit the measurement result(s) obtained according to the (early) triggered CSI-RS(s). For Option-1, the one or more subgroup indexes of the PO could be provided or indicated by one or more new DCI fields in the corresponding DCI format(s).
Information related to one or more CSI-RS resource configurations. The UE could determine or identify the association(s)/mapping(s) between the information and the one or more CSI-RS resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more CSI-RS resource configurations corresponding/associated/specific to the information could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the one or more CSI-RS resource configurations each provided by EarlyCSI-ReportConfig—to transmit the measurement result(s) obtained according to the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the K_early CSI-RS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early CSI-RS resource configurations, a mapping between the one or more UE IDs and resources used for reception of the PDCCH providing the DCI format as mentioned herein, and the K_early CSI-RS resource configurations and/or etc. For Option-1, the information could be provided or indicated by one or more new DCI fields in the corresponding DCI format(s).

When/if the first resource indicator(s) is absent or not present in the corresponding first resource allocation/indication channel(s)/signal(s) according to or following those specified herein in the present disclosure, the UE could determine the CSI-RS resource configuration(s), and therefore the corresponding CSI-RS resource(s) along with its associated parameter(s)/setting(s), to use/apply for receiving and measuring the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration(s) provided by EarlyCSI-ReportConfig—to transmit the measurement result(s) obtained according to the (early) triggered CSI-RS(s), according to or based on fixed rule(s) in system specification(s) and/or per RRC (re-)configuration/setup. In this case, for example, the K_early CSI-RS resource configurations provided/configured for the early triggering of the CSI measurement/reporting could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the K_early CSI-RS resource configurations each provided by EarlyCSI-ReportConfig—to transmit the measurement result(s) obtained according to the (early) triggered CSI-RS(s); for another example, the first (or last) CSI-RS resource configuration or the CSI-RS resource configuration with the lowest (or highest) configuration ID/index value, e.g., among the K_early CSI-RS resource configurations provided/configured for the early triggering of the CSI measurement/reporting, could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the first (or last) CSI-RS resource configuration provided by EarlyCSI-ReportConfig or the CSI-RS resource configuration provided by EarlyCSI-ReportConfig with the lowest (or highest) configuration ID/index value, e.g., among the K_early CSI-RS resource configurations provided/configured for the early triggering of the CSI measurement/reporting—to transmit the measurement result(s) obtained according to the (early) triggered CSI-RS(s).

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to multiple or more than one (L_early>1) CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more first resource indicators could correspond to or comprise, or could be in form/terms of one or more of:
A bitmap of length L_early with each entry/bit position of the bitmap associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if an entry/bit position of the bitmap is set to ‘1’ (or ‘0’), the CSI resource set associated/corresponding/specific to the entry/bit position could be used/applied (by the UE) for determining or identifying the CSI-RS resource(s) and the corresponding parameter(s)/setting(s) to receive and measure the (early) triggered CSI-RS(s). For Option-1, the bitmap could be provided or indicated by a new DCI field in the corresponding DCI format(s).
One or more one-bit flag indicators each associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if a one-bit flag indicator is set to ‘1’ (or ‘0’), the CSI resource set associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s). For Option-1, the one or more one-bit flag indicators could be provided or indicated by one or more new DCI fields in the corresponding DCI format(s).
A x1-bit indicator with x1=┌log₂(L_early)┐: each codepoint/state of the x1-bit indicator could be associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when a codepoint/state of the x1-bit indicator is indicated, the CSI resource set associated/corresponding/specific to the codepoint/state of the x1-bit indicator could be used/applied (by the UE) for determining or identifying the CSI-RS resource(s) and the corresponding parameter(s)/setting(s) to receive and measure the (early) triggered CSI-RS(s). For Option-1, the x1-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=4 CSI resource sets for the early triggering of the CSI measurement/reporting, wherein each of the CSI resource sets could be provided by EarlyCSI-ResourceSet such as EarlyCSI-SSB-CSI-ResourceSet or EarlyNZP-CSI-RS-ResourceSet; for this design example, x1=2 with codepoint/state ‘00’ indicating the first CSI resource set or the CSI resource set with the lowest set ID/index value, codepoint/state ‘01’ indicating the second CSI resource set or the CSI resource set with the second lowest set ID/index value, codepoint/state ‘10’ indicating the third CSI resource set or the CSI resource set with the second highest set ID/index value, and codepoint/state ‘11’ indicating the fourth CSI resource set or the CSI resource set with the highest set ID/index value.
One or more CSI resource set IDs/ID values. In this case, the CSI resource set(s) with or having the one or more CSI resource set IDs/ID values could be used/applied (by the UE) for determining or identifying the CSI-RS resource(s) and the corresponding parameter(s)/setting(s) to receive and measure the (early) triggered CSI-RS(s). For Option-1, the one or more CSI resource set IDs/ID values could be provided or indicated by one or more new DCI fields in the corresponding DCI format(s).
One or more indexes or index values denoted by l_1, . . . , l_x with each index or index value belonging to {1, . . . , L_early} or {0, . . . , L_early−1}, i.e., l_1, . . . , 1_x∈{1, . . . , L_early} or {0, . . . , L_early−1}. In this case, the l_1-th, . . . , l_x-th CSI resource set(s) among the configured/provided L_early CSI resource sets (e.g., with their resource set IDs/ID values ordered from low to high or from high to low) in the CSI-RS resource configuration could be used/applied (by the UE) for determining or identifying the CSI-RS resource(s) and the corresponding parameter(s)/setting(s) to receive and measure the (early) triggered CSI-RS(s). For Option-1, the one or more indexes or index values could be provided or indicated by one or more new DCI fields in the corresponding DCI format(s).
One or more trigger states each pointing/corresponding to an entry in a list of aperiodic CSI trigger states provided by CSI-AperiodicTriggerStateList. In this case, the CSI resource set(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s). For Option-1, the one or more trigger states could be provided or indicated by one or more CSI request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise L_early>1 groups of PRACH preambles with each group corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , L_early} or {0, . . . , L_early−1}), the x-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the L_early>1 subgroups of a PO such that each subgroup of the PO could be associated/corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , L_early} or {0, . . . , L_early−1}), the x-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more subgroup indexes of the PO could be provided or indicated by one or more new DCI fields in the corresponding DCI format(s).
Information related to one or more CSI resource sets. The UE could determine or identify the association(s)/mapping(s) between the information and the one or more CSI resource sets according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more CSI resource sets corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the L_early CSI resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early CSI resource sets, a mapping between the one or more UE IDs and resources used for reception of the PDCCH providing the DCI format as mentioned herein, and the L_early CSI resource sets and/or etc. For Option-1, the information could be provided or indicated by one or more new DCI fields in the corresponding DCI format(s).

When/if the first resource indicator(s) is absent or not present in the corresponding first resource indication/allocation channel(s)/signal(s) according to or following those specified herein in the present disclosure, the UE (e.g., the UE 116) could determine the CSI resource set(s), and therefore the corresponding CSI-RS resource(s) along with its associated parameter(s)/setting(s), to use/apply for receiving and measuring the (early) triggered CSI-RS(s) according to or based on fixed rule(s) in system specification(s) and/or per RRC (re-)configuration/setup. In this case, for example, the L_early CSI resource sets provided/configured in the CSI-RS resource configuration for the early triggering of the CSI measurement/reporting could be used/applied (by the UE) for determining or identifying the CSI-RS resource(s) and the corresponding parameter(s)/setting(s) to receive and measure the (early) triggered CSI-RS(s); for another example, the first (or last) CSI resource set or the CSI resource set with the lowest (or highest) set ID/index value, e.g., among the L_early CSI resource sets provided/configured for the early triggering of the CSI measurement/reporting, could be used/applied (by the UE) for determining or identifying the CSI-RS resource(s) and the corresponding parameter(s)/setting(s) to receive and measure the (early) triggered CSI-RS(s).

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to one (L_early=1) CSI resource set provided by EarlyCSI-ResourceSet such as EarlyCSI-SSB-CSI-ResourceSet or EarlyNZP-CSI-RS-ResourceSet and comprising, providing or configuring multiple or more than one (N_early>1) CSI-RS resources each provided by EarlySSB-Index or EarlyNZP-CSI-RS-Resource. For this design example, the one or more first resource indicators could correspond to or comprise, or could be in form/terms of one or more of:
A bitmap of length N_early with each entry/bit position of the bitmap associated/corresponding/specific to a CSI-RS resource provided by EarlySSB-Index or EarlyNZP-CSI-RS-Resource for the early triggering of the CSI measurement/reporting. In this case, when/if an entry/bit position of the bitmap is set to ‘1’ (or ‘0’), the CSI-RS resource associated/corresponding/specific to the entry/bit position could be used/applied (by the UE) for determining or identifying the CSI-RS resource(s) and the corresponding parameter(s)/setting(s) to receive and measure the (early) triggered CSI-RS(s). For Option-1, the bitmap could be provided or indicated by a new DCI field in the corresponding DCI format(s).
One or more one-bit flag indicators each associated/corresponding/specific to a CSI-RS resource provided by EarlySSB-Index or EarlyNZP-CSI-RS-Resource for the early triggering of the CSI measurement/reporting. In this case, when/if a one-bit flag indicator is set to ‘1’ (or ‘0’), the CSI-RS resource associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s). For Option-1, the one or more one-bit flag indicators could be provided or indicated by one or more new DCI fields in the corresponding DCI format(s).
A x2-bit indicator with x2=┌log₂(N_early)┐: each codepoint/state of the x2-bit indicator could be associated/corresponding/specific to a CSI-RS resource provided by EarlySSB-Index or EarlyNZP-CSI-RS-Resource for the early triggering of the CSI measurement/reporting. In this case, when a codepoint/state of the x2-bit indicator is indicated, the CSI-RS resource associated/corresponding/specific to the codepoint/state of the x2-bit indicator could be used/applied (by the UE) for determining or identifying the CSI-RS resource(s) and the corresponding parameter(s)/setting(s) to receive and measure the (early) triggered CSI-RS(s). For Option-1, the x2-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=1 CSI resource set comprising or providing or configuring N_early>1 CSI-RS resources for the early triggering of the CSI measurement/reporting, wherein each of the CSI-RS resources could be provided by EarlySSB-Index or EarlyNZP-CSI-RS-Resource; for this design example, x2=2 with codepoint/state ‘00’ indicating the first CSI-RS resource or the CSI-RS resource with the lowest resource ID/index value, codepoint/state ‘01’ indicating the second CSI-RS resource or the CSI-RS resource with the second lowest resource ID/index value, codepoint/state ‘10’ indicating the third CSI-RS resource or the CSI-RS resource with the second highest resource ID/index value, and codepoint/state ‘11’ indicating the fourth CSI-RS resource or the CSI-RS resource with the highest resource ID/index value.
One or more CSI-RS resource IDs/ID values. In this case, the CSI-RS resource(s) with or having the one or more CSI-RS resource IDs/ID values could be used/applied (by the UE) for determining or identifying the CSI-RS resource(s) and the corresponding parameter(s)/setting(s) to receive and measure the (early) triggered CSI-RS(s). For Option-1, the one or more CSI-RS resource IDs/ID values could be provided or indicated by one or more new DCI fields in the corresponding DCI format(s).
One or more indexes or index values denoted by n_1, . . . , n_x with each index or index value belonging to {1, . . . , N_early} or {0, . . . , N_early−1}, i.e., n_1, . . . , n_x∈{1, . . . , N_early} or {0, . . . , N_early−1}. In this case, the n_1-th, . . . , n_x-th CSI-RS resource(s) among the configured/provided N_early CSI-RS resources (e.g., with their resource IDs/ID values ordered from low to high or from high to low) in the CSI resource set/configuration could be used/applied (by the UE) for determining or identifying the CSI-RS resource(s) and the corresponding parameter(s)/setting(s) to receive and measure the (early) triggered CSI-RS(s). For Option-1, the one or more indexes or index values could be provided or indicated by one or more new DCI fields in the corresponding DCI format(s).
One or more trigger states each pointing/corresponding to an entry in a list of aperiodic CSI-RS resource trigger states provided by CSI-AperiodicTriggerStateList. In this case, the CSI-RS resource(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s). For Option-1, the one or more trigger states could be provided or indicated by one or more CSI request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise N_early>1 groups of PRACH preambles with each group corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , N_early} or {0, . . . , N_early−1}), the x-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the N_early>1 subgroups of a PO such that each subgroup of the PO could be associated/corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , N_early} or {0, . . . , N_early−1}), the x-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more subgroup indexes of the PO could be provided or indicated by one or more new DCI fields in the corresponding DCI format(s).
Information related to one or more CSI-RS resources. The UE could determine or identify the association(s)/mapping(s) between the information and the one or more CSI-RS resources according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more CSI-RS resources corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the Nearly CSI-RS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Nearly CSI-RS resources, a mapping between the one or more UE IDs and resources used for reception of the PDCCH providing the DCI format as mentioned herein, and the N_early CSI-RS resources, and/or etc. For Option-1, the information could be provided or indicated by one or more new DCI fields in the corresponding DCI format(s).

When/if the first resource indicator(s) is absent or not present in the corresponding first resource allocation/indication channel(s)/signal(s) according to or following those specified herein in the present disclosure, the UE could determine the CSI-RS resource(s), and therefore the corresponding parameter(s)/setting(s), to use/apply for receiving and measuring the (early) triggered CSI-RS(s) according to or based on fixed rule(s) in system specification(s) and/or per RRC (re-)configuration/setup. In this case, for example, the N_early CSI-RS resources provided/configured in the CSI resource set/configuration for the early triggering of the CSI measurement/reporting could be used/applied (by the UE) for determining or identifying the CSI-RS resource(s) and the corresponding parameter(s)/setting(s) to receive and measure the (early) triggered CSI-RS(s); for another example, the first (or last) CSI-RS resource or the CSI-RS resource with the lowest (or highest) resource ID/index value, e.g., among the N_early CSI-RS resources provided/configured for the early triggering of the CSI measurement/reporting, could be used/applied (by the UE) for determining or identifying the CSI-RS resource(s) and the corresponding parameter(s)/setting(s) to receive and measure the (early) triggered CSI-RS(s).

In one example, the higher layer parameter(s)/signaling(s) including SIB1, SIB2, RRCRelease-IEs as specified/defined herein could provide or indicate or comprise information related to the one or more (e.g., Q_early≥1) second UL resources/resource configurations as specified herein in the present disclosure for transmitting the measurement result(s) in/via/by the third channel(s)/signal(s) as in Mode-A/B or the second channel(s)/signal(s) as in Mode-C. For this design example, the one or more first resource indicators could correspond to or comprise, or could be in form/terms of one or more of:
A bitmap of length Q_early with each entry/bit position of the bitmap associated/corresponding/specific to a configured second UL resource/resource configuration. In this case, when/if an entry/bit position of the bitmap is set to ‘1’ (or ‘0’), the second UL resource/resource configuration associated/corresponding/specific to the entry/bit position could be used/applied (by the UE) to transmit the measurement result(s) obtained according to the (early) triggered CSI-RS(s). For Option-1, the bitmap could be provided or indicated by a new DCI field in the corresponding DCI format(s).
One or more one-bit flag indicators each associated/corresponding/specific to a configured second UL resource/resource configuration. In this case, when/if a one-bit flag indicator is set to ‘1’ (or ‘0’), the second UL resource/resource configuration associated/corresponding/specific to the one-bit flag indicator could be used/applied (by the UE) to transmit the measurement result(s) obtained according to the (early) triggered CSI-RS(s). For Option-1, the one or more one-bit flag indicators could be provided or indicated by one or more new DCI fields in the corresponding DCI format(s).
A x3-bit indicator with x3=┌log₂(Q_early)┐: each codepoint/state of the x3-bit indicator could be associated/corresponding/specific to a configured second UL resource/resource configuration. In this case, when a codepoint/state of the x3-bit indicator is indicated, the second UL resource/resource configuration associated/corresponding/specific to the codepoint/state of the x3-bit indicator could be used/applied (by the UE) to transmit the measurement result(s) obtained according to the (early) triggered CSI-RS(s). For Option-1, the x3-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise Q_early=4 second UL resources/resource configurations for the early triggering of the CSI measurement/reporting; for this design example, x3=2 with codepoint/state ‘00’ indicating the 1-st second UL resource/resource configuration with the lowest resource/resource configuration ID/index value, codepoint/state ‘01’ indicating the 2-nd second UL resource/resource configuration with the second lowest resource/resource configuration ID/index value, codepoint/state ‘10’ indicating the 3-rd second UL resource/resource configuration with the second highest resource/resource configuration ID/index value, and codepoint/state ‘11’ indicating the 4-th second UL resource/resource configuration with the highest resource/resource configuration ID/index value.
One or more second UL resource/resource configuration IDs/ID values. In this case, the second UL resource(s)/resource configuration(s) with or having the one or more second UL resource/resource configuration IDs/ID values could be used/applied (by the UE) to transmit the measurement result(s) obtained according to the (early) triggered CSI-RS(s). For Option-1, the one or more second UL resource/resource configuration IDs/ID values could be provided or indicated by one or more new DCI fields in the corresponding DCI format(s).
One or more indexes or index values denoted by q_1, . . . , q_x with each index or index value belonging to {1, . . . , Q_early} or {0, . . . , Q_early−1}, i.e., q_1, . . . , q_x∈{1, . . . , Q_early} or {0, . . . , Q_early−1}. In this case, the q_1-th, . . . , q_x-th second UL resource(s)/resource configuration(s) among the configured/provided Q_early second UL resources/resource configurations (e.g., with their resource/resource configuration IDs/ID values ordered from low to high or from high to low) could be used/applied (by the UE) to transmit the measurement result(s) obtained according to the (early) triggered CSI-RS(s). For Option-1, the one or more indexes or index values could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise Q_early>1 groups of PRACH preambles with each group corresponding/specific to a second UL resource/resource configuration according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , Q_early} or {0, . . . , Q_early−1}), the x-th second UL resource/resource configuration among the configured/provided Q_early second UL resources/resource configurations (e.g., with their resource/resource configuration IDs/ID values ordered from low to high or from high to low) could be used/applied (by the UE) to transmit the measurement result(s) obtained according to the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the Q_early>1 subgroups of a PO such that each subgroup of the PO could be associated/corresponding/specific to a second UL resource/resource configuration according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , Q_early} or {0, . . . , Q_early−1}), the x-th second UL resource/resource configuration among the configured/provided Q_early second UL resources/resource configurations (e.g., with their resource/resource configuration IDs/ID values ordered from low to high or from high to low) could be used/applied (by the UE) to transmit the measurement result(s) obtained according to the (early) triggered CSI-RS(s). For Option-1, the one or more subgroup indexes of the PO could be provided or indicated by one or more new DCI fields in the corresponding DCI format(s).
Information related to the one or more second UL resources/resource configurations. The UE could determine or identify the association(s)/mapping(s) between the information and the one or more second UL resources/resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s). In this case, the one or more second UL resources/resource configurations corresponding/associated/specific to the information could be used/applied (by the UE) to transmit the measurement result(s) obtained according to the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the Q_early second UL resource(s)/resource configuration(s), a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Q_early second UL resource(s)/resource configuration(s), a mapping between the one or more UE IDs and resources used for reception of the PDCCH providing the DCI format as mentioned herein, and the Q_early second UL resource(s)/resource configuration(s) and/or etc. For Option-1, the information could be provided or indicated by one or more new DCI fields in the corresponding DCI format(s).

When/if the first resource indicator(s) is absent or not present in the corresponding first resource allocation/indication channel(s)/signal(s) according to or following those specified herein in the present disclosure, the UE could determine the second UL resource(s)/resource configuration(s) to transmit the measurement result(s) obtained according to the (early) triggered CSI-RS(s) according to or based on fixed rule(s) in system specification(s) and/or per RRC (re-)configuration/setup. In this case, for example, the Q_early second UL resource(s)/resource configuration(s) provided/configured for the early triggering of the CSI measurement/reporting could be used/applied (by the UE) to transmit the measurement result(s); for another example, the first (or last) second UL resource/resource configuration or the second UL resource/resource configuration with the lowest (or highest) resource/resource configuration ID/index value, e.g., among the Q_early second UL resource(s)/resource configuration(s) provided/configured for the early triggering of the CSI measurement/reporting, could be used/applied (by the UE) to transmit the measurement result(s)—obtained according to the (early) triggered CSI-RS(s)—in the third channel(s)/signal(s) for Mode-A/B or the second channel(s)/signal(s) in Mode-C.

Furthermore, the first resource indicator(s) in the first resource allocation/indication channel(s)/signal(s) could indicate to the UE: (x-1) CSI-RS resource(s) and the corresponding parameter(s)/setting(s) to use/apply for receiving and measuring the (early) triggered CSI-RS(s), (x-2) the second UL resource(s)/resource configuration(s) including PUCCH(s)/PUSCH(s)—e.g., associated/linked/mapped to or provided in one or more CSI-RS resource configurations each provided by EarlyCSI-ReportConfig—to transmit the measurement result(s) obtained according to the (early) triggered CSI-RS(s), or (x-3) both (x-1) and (x-2). The UE could determine or identify which of (x-1), (x-2) and/or (x-3) to follow for receiving/measuring the (early) triggered CSI-RS(s) and/or determining, transmitting/sending the measurement result(s) obtained according to the (early) triggered CSI-RS(s) according to or following those specified herein in the present disclosure based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For example, the UE could receive from the network, e.g., via/in/by the second channel(s)/signal(s) in Mode-A/B and/or the first resource indication/allocation channel(s)/signal(s), a one-bit flag indicator with ‘1’ (or ‘0’) indicating (x-1) (or (x-2) or (x-3)) and ‘0’ (or ‘1’) indicating (x-2) (or (x-1) or (x-3)). For another example, the UE could receive from the network, e.g., via/in/by the second channel(s)/signal(s) in Mode-A/B and/or the first resource indication/allocation channel(s)/signal(s), a two-bit flag indicator with ‘00’ (or ‘01’ or ‘10’ or ‘11’) indicating (x-1) (or (x-2) or (x-3)), ‘01’ (or ‘00’ or ‘10’ or ‘11’) indicating (x-2) (or (x-1) or (x-3)), and ‘01’ (or ‘00’ or ‘10’ or ‘11’) indicating (x-3) (or (x-1) or (x-2)).

As specified/defined herein in the present disclosure, for Mode-A and Mode-C, a UE (e.g., the UE 116) could autonomously determine or identify or select the (second) UL resource(s)/resource configuration(s) to use/apply for transmitting or sending the measurement result(s)—obtained according to the (early) triggered CSI-RS(s)—in the third channel(s)/signal(s) for Mode-A/B or the second channel(s)/signal(s) in Mode-C. The UE could be indicated or provided or configured by the network, e.g., via higher layer RRC signaling(s)/parameter(s) and/or MAC CE command(s) and/or dynamic DCI based L1 signaling(s) based on or according to a corresponding UE's capability or capability signaling, whether or not the UE could autonomously determine, identify or select the (second) UL resource(s)/resource configuration(s) to transmit or send the measurement result(s) obtained according to the (early) triggered CSI-RS(s); for instance, when/if the UE is provided or configured by the network a higher layer parameter ueSelectCSIResource and/or set to ‘enabled’ based on or according to a corresponding UE's capability/capability signaling, the UE could autonomously determine or identify or select the (second) UL resource(s)/resource configuration(s) to transmit or send the measurement result(s) obtained according to the (early) triggered CSI-RS(s) according to or following those specified herein in the present disclosure. Optionally, when/if the first resource indicator(s) as specified/defined herein in the present disclosure is absent or not present in the corresponding first resource allocation/indication channel(s)/signal(s) according to or following those specified herein in the present disclosure, the UE could autonomously determine or identify or select the measurement result(s) obtained according to the (early) triggered CSI-RS(s) according to or following those specified herein in the present disclosure. In this case—as in (a-3) in the present disclosure, for Mode-A and Mode-C, the UE could transmit or send to the network, in/via/by one or more second resource indication channels/signals, one or more second resource indicators to indicate their autonomous determination, identification or selection of the (second) UL resource(s)/resource configuration(s) for transmitting or sending measurement result(s) obtained according to the (early) triggered CSI-RS(s) according to or following those specified herein in the present disclosure.

For Mode-A and/or Mode-C, the UE could additionally transmit or send to the network, in/via/by one or more fifth channels/signals, one or more fourth indicators to indicate or provide (second) UL resource(s) or resource allocation(s) for the measurement result(s). the UE could determine or identify the one or more fifth channels/signals based on or according to one or more of Alt-1, Alt-2, . . . , Alt-10 as specified/defined herein in the present disclosure for Mode-A. The UE could determine or identify which one or more of the Alt-1, Alt-2, . . . , Alt-10 to use or follow or apply to determine or identify the fifth channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, when/if the UE could autonomously determine or identify or select the second UL resource(s)/resource configuration(s) for the measurement result(s) as specified/defined herein in the present disclosure (e.g., enabled by the network and/or based on/according to absence of the first resource indicator(s) in the first resource indication/allocation channel(s)/signal(s)), the UE could transmit or send to the network, in the fifth channel(s)/signal(s), the fourth indicator(s) as specified/defined herein in the present disclosure; otherwise, i.e., when/if the UE may not autonomously determine or identify or select the second UL resource(s)/resource configuration(s) for the measurement result(s) as specified/defined herein in the present disclosure (e.g., not enabled or disabled by the network and/or the first resource indicator(s) is present in the corresponding first resource indication/allocation channel(s)/signal(s)), the fourth indicator(s) as specified/defined herein in the present disclosure may not be present or could be absent in the corresponding fifth channel(s)/signal(s) and/or the fifth channel(s)/signal(s) may not be present or could be absent according to those specified herein in the present disclosure. The one or more fifth channels/signals could be the same as or identical to the one or more first channels/signals in Mode-A/Mode-C; optionally, the one or more fifth channels/signals could be different or separate from the one or more first channels/signals in Mode-A/Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more fifth channels/signals are the same as or identical to the one or more first channels/signals in Mode-A/Mode-C, the one or more fourth indicators could be the same as or identical to the one or more first indicators in Mode-A/Mode-C; optionally, the one or more fourth indicators could be different or separate from the one or more first indicators in Mode-A/Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In this case (Mode-A/Mode-C), the one or more fifth channels/signals (or the one or more first channels/signals when/if the one or more fifth channels/signals are the same as or identical to the one or more first channels/signals) could correspond to the one or more second resource indication channels/signals, and the one or more fourth indicators (or the one or more first indicators when/if the one or more fourth indicators are the same as or identical to the one or more first indicators) could correspond to the one or more second resource indicators.

For Mode-A and/or Mode-C, the UE could additionally transmit or send to the network, in/via/by one or more fifth channels/signals, one or more fourth indicators to indicate or provide (second) UL resource(s) or resource allocation(s) for the measurement result(s). the UE could determine or identify the one or more fifth channels/signals based on or according to one or more of Alt-A, Alt-B, . . . , Alt-G as specified/defined herein in the present disclosure for Mode-A. The UE could determine or identify which one or more of the Alt-A, Alt-B, . . . , Alt-G to use or follow or apply to determine or identify the fifth channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, when/if the UE could autonomously determine or identify or select the second UL resource(s)/resource configuration(s) for the measurement result(s) as specified/defined herein in the present disclosure (e.g., enabled by the network and/or based on/according to absence of the first resource indicator(s) in the first resource indication/allocation channel(s)/signal(s)), the UE could transmit or send to the network, in the fifth channel(s)/signal(s), the fourth indicator(s) as specified/defined herein in the present disclosure; otherwise, i.e., when/if the UE may not autonomously determine or identify or select the second UL resource(s)/resource configuration(s) for the measurement result(s) as specified/defined herein in the present disclosure (e.g., not enabled or disabled by the network and/or the first resource indicator(s) is present in the corresponding first resource indication/allocation channel(s)/signal(s)), the fourth indicator(s) as specified/defined herein in the present disclosure may not be present or could be absent in the corresponding fifth channel(s)/signal(s) and/or the fifth channel(s)/signal(s) may not be present or could be absent according to those specified herein in the present disclosure. The one or more fifth channels/signals could be the same as or identical to the one or more third channels/signals in Mode-A and/or the one or more second channels/signals in Mode-C; optionally, the one or more fifth channels/signals could be different or separate from the one or more third channels/signals in Mode-A and/or the one or more second channels/signals in Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the one or more fourth indicators could be the same as or identical to or could have the same form as the one or more first indicators in Mode-A/Mode-C; optionally, the one or more fourth indicators could be different or separate from the one or more first indicators in Mode-A/Mode-C; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In this case (Mode-A/Mode-C), the one or more fifth channels/signals (or the one or more third channels/signals when/if the one or more fifth channels/signals are the same as or identical to the one or more third channels/signals in Mode-A, or the one or more second channels/signals when/if the one or more fifth channels/signals are the same as or identical to the one or more second channels/signals in Mode-C) could correspond to the one or more second resource indication channels/signals, and the one or more fourth indicators (or the one or more first indicators in Mode-A/Mode-C) could correspond to the one or more second resource indicators.

In one example, the higher layer parameter(s)/signaling(s) including SIB1, SIB2, RRCRelease-IEs as specified/defined herein could provide or indicate or comprise multiple or more than one (K_early>1) CSI-RS resource configurations for the early triggering of the CSI measurement/reporting, wherein each of the CSI-RS resource configurations could be provided by EarlyCSI-ResourceConfig or EarlyCSI-ReportConfig, and could comprise or provide or include or configure, and/or could be linked/associated/specific to one or more CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more second resource indicators could correspond to or comprise, or could be in form/terms of one or more of:
A bitmap of length K_early with each entry/bit position of the bitmap associated/corresponding/specific to a CSI-RS resource configuration provided by EarlyCSI-ResourceConfig or EarlyCSI-ReportConfig for the early triggering of the CSI measurement/reporting. In this case, when/if an entry/bit position of the bitmap is set to ‘1’ (or ‘0’), the UE could indicate to the network that the CSI-RS resource configuration associated/corresponding/specific to the entry/bit position could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration provided by EarlyCSI-ReportConfig—to transmit the measurement result(s) obtained according to the (early) triggered CSI-RS(s).
One or more one-bit flag indicators each associated/corresponding/specific to a CSI-RS resource configuration provided by EarlyCSI-ResourceConfig or EarlyCSI-ReportConfig for the early triggering of the CSI measurement/reporting. In this case, when/if a one-bit flag indicator is set to ‘1’ (or ‘0’), the UE could indicate to the network that the CSI-RS resource configuration associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration provided by EarlyCSI-ReportConfig—to transmit the measurement result(s) obtained according to the (early) triggered CSI-RS(s).
A y0-bit indicator with y0=[log₂(K_early)]: each codepoint/state of the y0-bit indicator could be associated/corresponding/specific to a CSI-RS resource configuration provided by EarlyCSI-ResourceConfig or EarlyCSI-ReportConfig for the early triggering of the CSI measurement/reporting. In this case, when a codepoint/state of the y0-bit indicator is indicated, the UE could indicate to the network that the CSI-RS resource configuration associated/corresponding/specific to the codepoint/state of the y0-bit indicator could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration provided by EarlyCSI-ReportConfig—to transmit the measurement result(s) obtained according to the (early) triggered CSI-RS(s). For instance, the higher layer parameter(s)/signaling(s) including SIB1, SIB2, RRCRelease-IEs as specified/defined herein could provide or indicate or comprise K_early=4 CSI-RS resource configurations for the early triggering of the CSI measurement/reporting, wherein each of the CSI-RS resource configurations could be provided by EarlyCSI-ResourceConfig or EarlyCSI-ReportConfig; for this design example, y0=2 with codepoint/state ‘00’ indicating the first CSI-RS resource configuration or the CSI-RS resource configuration with the lowest configuration ID/index value, codepoint/state ‘01’ indicating the second CSI-RS resource configuration or the CSI-RS resource configuration with the second lowest configuration ID/index value, codepoint/state ‘10’ indicating the third CSI-RS resource configuration or the CSI-RS resource configuration with the second highest configuration ID/index value, and codepoint/state ‘11’ indicating the fourth CSI-RS resource configuration or the CSI-RS resource configuration with the highest configuration ID/index value.
One or more CSI-RS resource configuration IDs/ID values. In this case, the UE could indicate to the network that the CSI-RS resource configuration(s) with or having the one or more CSI-RS resource configuration IDs/ID values could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration(s) provided by EarlyCSI-ReportConfig—to transmit the measurement result(s) obtained according to the (early) triggered CSI-RS(s).
One or more indexes or index values denoted by k_1, . . . , k_y with each index or index value belonging to {1, . . . , K_early} or {0, . . . , K_early−1}, i.e., k_1, . . . , k_y∈{1, . . . , K_early} or {0, . . . , K_early−1}. In this case, the UE could indicate to the network that the k_1-th, . . . , k_y-th CSI-RS resource configuration(s) among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the k_1-th, . . . , k_y-th CSI-RS resource configuration(s) provided by EarlyCSI-ReportConfig—to transmit the measurement result(s) obtained according to the (early) triggered CSI-RS(s).
One or more trigger states each pointing/corresponding to an entry in a list of aperiodic CSI trigger states provided by CSI-AperiodicTriggerStateList. In this case, the UE could indicate to the network that the CSI-RS resource configuration(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the CSI-RS resource configuration(s) provided by EarlyCSI-ReportConfig—to transmit the measurement result(s) obtained according to the (early) triggered CSI-RS(s).
One or more PRACH preambles. In this case, the higher layer parameter(s)/signaling(s) including SIB1, SIB2, RRCRelease-IEs as specified/defined herein could also provide or indicate or comprise K_early>1 groups of PRACH preambles with each group corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , K_early} or {0, . . . , K_early−1}), the UE could indicate to the network that the y-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the y-th CSI-RS resource configuration provided by EarlyCSI-ReportConfig—to transmit the measurement result(s) obtained according to the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the K_early>1 subgroups of a PO such that each subgroup of the PO could be associated/corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , K_early} or {0, . . . , K_early−1}), the UE could indicate to the network that the y-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the y-th CSI-RS resource configuration provided by EarlyCSI-ReportConfig—to transmit the measurement result(s) obtained according to the (early) triggered CSI-RS(s).
Information related to one or more CSI-RS resource configurations. The UE could determine or identify the association(s)/mapping(s) between the information and the one or more CSI-RS resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network (e.g., the network 130) that the one or more CSI-RS resource configurations corresponding/associated/specific to the information could be used/applied (by the UE) for determining or identifying the CSI-RS resource(s) and the corresponding parameter(s)/setting(s) to receive and measure the (early) triggered CSI-RS(s), and/or the corresponding second UL resource(s)/resource configuration(s) including PUCCH(s)/PUSCH(s)—e.g., associated/linked/mapped to or provided in the one or more CSI-RS resource configurations each provided by EarlyCSI-ReportConfig—to transmit the measurement result(s) obtained according to the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the K_early CSI-RS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early CSI-RS resource configurations, a mapping between the one or more UE IDs and resources used for reception of the PDCCH providing the DCI format as mentioned herein, and the K_early CSI-RS resource configurations and/or etc.

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be associated/linked/specific to multiple or more than one (L_early>1) CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more second resource indicators could correspond to or comprise, or could be in form/terms of one or more of:
A bitmap of length L_early with each entry/bit position of the bitmap associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if an entry/bit position of the bitmap is set to ‘1’ (or ‘0’), the UE could indicate to the network that the CSI resource set associated/corresponding/specific to the entry/bit position could be used/applied (by the UE) for determining or identifying the CSI-RS resource(s) and the corresponding parameter(s)/setting(s) to receive and measure the (early) triggered CSI-RS(s).
One or more one-bit flag indicators each associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if a one-bit flag indicator is set to ‘1’ (or ‘0’), the UE could indicate to the network that the CSI resource set associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s).
A y1-bit indicator with y1=┌log₂(L_early)┐: each codepoint/state of the y1-bit indicator could be associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when a codepoint/state of the y1-bit indicator is indicated, the UE could indicate to the network that the CSI resource set associated/corresponding/specific to the codepoint/state of the y1-bit indicator could be used/applied (by the UE) for determining or identifying the CSI-RS resource(s) and the corresponding parameter(s)/setting(s) to receive and measure the (early) triggered CSI-RS(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=4 CSI resource sets for the early triggering of the CSI measurement/reporting, wherein each of the CSI resource sets could be provided by EarlyCSI-ResourceSet such as EarlyCSI-SSB-CSI-ResourceSet or EarlyNZP-CSI-RS-ResourceSet; for this design example, y1=2 with codepoint/state ‘00’ indicating the first CSI resource set or the CSI resource set with the lowest set ID/index value, codepoint/state ‘01’ indicating the second CSI resource set or the CSI resource set with the second lowest set ID/index value, codepoint/state ‘10’ indicating the third CSI resource set or the CSI resource set with the second highest set ID/index value, and codepoint/state ‘11’ indicating the fourth CSI resource set or the CSI resource set with the highest set ID/index value.
One or more CSI resource set IDs/ID values. In this case, the UE could indicate to the network that the CSI resource set(s) with or having the one or more CSI resource set IDs/ID values could be used/applied (by the UE) for determining or identifying the CSI-RS resource(s) and the corresponding parameter(s)/setting(s) to receive and measure the (early) triggered CSI-RS(s).
One or more indexes or index values denoted by l_1, . . . , l_y with each index or index value belonging to {1, . . . , L_early} or {0, . . . , L_early−1}, i.e., l_1, . . . , 1_y∈{1, . . . , L_early} or {0, . . . , L_early−1}. In this case, the UE (e.g., the UE 116) could indicate to the network that the l_1-th, . . . , l_y-th CSI resource set(s) among the configured/provided L_early CSI resource sets (e.g., with their resource set IDs/ID values ordered from low to high or from high to low) in the CSI-RS resource configuration could be used/applied (by the UE) for determining or identifying the CSI-RS resource(s) and the corresponding parameter(s)/setting(s) to receive and measure the (early) triggered CSI-RS(s).
One or more trigger states each pointing/corresponding to an entry in a list of aperiodic CSI-RS resource trigger states provided by aperiodicCSI-RS-ResourceTrigger or aperiodicCSI-RS-ResourceTriggerList. In this case, the UE could indicate to the network that the CSI resource set(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s).
One or more PRACH preambles. In this case, the higher layer parameter(s)/signaling(s) including SIB1, SIB2, RRCRelease-IEs as specified/defined herein could also provide or indicate or comprise L_early>1 groups of PRACH preambles with each group corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , L_early} or {0, . . . , L_early−1}), the UE could indicate to the network that the y-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the L_early>1 subgroups of a PO such that each subgroup of the PO could be associated/corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , L_early} or {0, . . . , L_early−1}), the UE could indicate to the network that the y-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
Information related to one or more CSI resource sets. The UE could determine or identify the association(s)/mapping(s) between the information and the one or more CSI resource sets according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more CSI resource sets corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the L_early CSI resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early CSI resource sets, a mapping between the one or more UE IDs and resources used for reception of the PDCCH providing the DCI format as mentioned herein, and the L_early CSI resource sets and/or etc.

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to one (L_early=1) CSI resource set provided by EarlyCSI-ResourceSet such as EarlyCSI-SSB-CSI-ResourceSet or EarlyNZP-CSI-RS-ResourceSet and comprising, providing or configuring multiple or more than one (N_early>1) CSI-RS resources each provided by EarlySSB-Index or EarlyNZP-CSI-RS-Resource. For this design example, the one or more second resource indicators could correspond to or comprise, or could be in form/terms of one or more of:
A bitmap of length N_early with each entry/bit position of the bitmap associated/corresponding/specific to a CSI-RS resource provided by EarlySSB-Index or EarlyNZP-CSI-RS-Resource for the early triggering of the CSI measurement/reporting. In this case, when/if an entry/bit position of the bitmap is set to ‘1’ (or ‘0’), the UE could indicate to the network that the CSI-RS resource associated/corresponding/specific to the entry/bit position could be used/applied (by the UE) for determining or identifying the CSI-RS resource(s) and the corresponding parameter(s)/setting(s) to receive and measure the (early) triggered CSI-RS(s).
One or more one-bit flag indicators each associated/corresponding/specific to a CSI-RS resource provided by EarlySSB-Index or EarlyNZP-CSI-RS-Resource for the early triggering of the CSI measurement/reporting. In this case, when/if a one-bit flag indicator is set to ‘1’ (or ‘0’), the UE could indicate to the network that the CSI-RS resource associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s).
A y2-bit indicator with y2=┌log₂(N_early)┐: each codepoint/state of the y2-bit indicator could be associated/corresponding/specific to a CSI-RS resource provided by EarlySSB-Index or EarlyNZP-CSI-RS-Resource for the early triggering of the CSI measurement/reporting. In this case, when a codepoint/state of the y2-bit indicator is indicated, the UE could indicate to the network that the CSI-RS resource associated/corresponding/specific to the codepoint/state of the y2-bit indicator could be used/applied (by the UE) for determining or identifying the CSI-RS resource(s) and the corresponding parameter(s)/setting(s) to receive and measure the (early) triggered CSI-RS(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=1 CSI resource set comprising or providing or configuring N_early>1 CSI-RS resources for the early triggering of the CSI measurement/reporting, wherein each of the CSI-RS resources could be provided by EarlySSB-Index or EarlyNZP-CSI-RS-Resource; for this design example, y2=2 with codepoint/state ‘00’ indicating the first CSI-RS resource or the CSI-RS resource with the lowest resource ID/index value, codepoint/state ‘01’ indicating the second CSI-RS resource or the CSI-RS resource with the second lowest resource ID/index value, codepoint/state ‘10’ indicating the third CSI-RS resource or the CSI-RS resource with the second highest resource ID/index value, and codepoint/state ‘11’ indicating the fourth CSI-RS resource or the CSI-RS resource with the highest resource ID/index value.
One or more CSI-RS resource IDs/ID values. In this case, the UE could indicate to the network that the CSI-RS resource(s) with or having the one or more CSI-RS resource IDs/ID values could be used/applied (by the UE) for determining or identifying the CSI-RS resource(s) and the corresponding parameter(s)/setting(s) to receive and measure the (early) triggered CSI-RS(s).
One or more indexes or index values denoted by n_1, . . . , n_y with each index or index value belonging to {1, . . . , N_early} or {0, . . . , N_early−1}, i.e., n_1, . . . , n_y∈{1, . . . , N_early} or {0, . . . , N_early−1}. In this case, the UE could indicate to the network that the n_1-th, . . . , n_y-th CSI-RS resource(s) among the configured/provided N_early CSI-RS resources (e.g., with their resource IDs/ID values ordered from low to high or from high to low) in the CSI resource set/configuration could be used/applied (by the UE) for determining or identifying the CSI-RS resource(s) and the corresponding parameter(s)/setting(s) to receive and measure the (early) triggered CSI-RS(s).
One or more trigger states each pointing/corresponding to an entry in a list of aperiodic CSI trigger states provided by CSI-AperiodicTriggerStateList. In this case, the UE could indicate to the network that the CSI-RS resource(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s).
One or more PRACH preambles. In this case, the higher layer parameter(s)/signaling(s) including SIB1, SIB2, RRCRelease-IEs as specified/defined herein could also provide or indicate or comprise N_early>1 groups of PRACH preambles with each group corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , N_early} or {0, . . . , N_early−1}), the UE could indicate to the network that the y-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the N_early>1 subgroups of a PO such that each subgroup of the PO could be associated/corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , N_early} or {0, . . . , N_early−1}), the UE could indicate to the network that the y-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
Information related to one or more CSI-RS resources. The UE could determine or identify the association(s)/mapping(s) between the information and the one or more CSI-RS resources according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more CSI-RS resources corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the Nearly CSI-RS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Nearly CSI-RS resources, a mapping between the one or more UE IDs and resources used for reception of the PDCCH providing the DCI format as mentioned herein, and the Nearly CSI-RS resources and/or etc.

In one example, the higher layer parameter(s)/signaling(s) including SIB1, SIB2, RRCRelease-IEs as specified/defined herein could provide or indicate or comprise information related to the one or more (e.g., Q_early>1) second UL resources/resource configurations as specified herein in the present disclosure for transmitting the measurement result(s) in/via/by the third channel(s)/signal(s) as in Mode-A/B or the second channel(s)/signal(s) as in Mode-C. For this design example, the one or more second resource indicators could correspond to or comprise, or could be in form/terms of one or more of:
A bitmap of length Q_early with each entry/bit position of the bitmap associated/corresponding/specific to a configured second UL resource/resource configuration. In this case, when/if an entry/bit position of the bitmap is set to ‘1’ (or ‘0’), the UE could indicate to the network that the second UL resource/resource configuration associated/corresponding/specific to the entry/bit position could be used/applied (by the UE) to transmit the measurement result(s) obtained according to the (early) triggered CSI-RS(s).
One or more one-bit flag indicators each associated/corresponding/specific to a configured second UL resource/resource configuration. In this case, when/if a one-bit flag indicator is set to ‘1’ (or ‘0’), the UE could indicate to the network that the second UL resource/resource configuration associated/corresponding/specific to the one-bit flag indicator could be used/applied (by the UE) to transmit the measurement result(s) obtained according to the (early) triggered CSI-RS(s).
A y3-bit indicator with y3=┌log₂(Q_early)┐: each codepoint/state of the y3-bit indicator could be associated/corresponding/specific to a configured second UL resource/resource configuration. In this case, when a codepoint/state of the y3-bit indicator is indicated, the UE could indicate to the network that the second UL resource/resource configuration associated/corresponding/specific to the codepoint/state of the y3-bit indicator could be used/applied (by the UE) to transmit the measurement result(s) obtained according to the (early) triggered CSI-RS(s). For instance, the higher layer parameter(s)/signaling(s) including SIB1, SIB2, RRCRelease-IEs as specified/defined herein could provide or indicate or comprise Q_early=4 second UL resources/resource configurations for the early triggering of the CSI measurement/reporting; for this design example, y3=2 with codepoint/state ‘00’ indicating the 1-st second UL resource/resource configuration with the lowest resource/resource configuration ID/index value, codepoint/state ‘01’ indicating the 2-nd second UL resource/resource configuration with the second lowest resource/resource configuration ID/index value, codepoint/state ‘10’ indicating the 3-rd second UL resource/resource configuration with the second highest resource/resource configuration ID/index value, and codepoint/state ‘11’ indicating the 4-th second UL resource/resource configuration with the highest resource/resource configuration ID/index value.
One or more second UL resource/resource configuration IDs/ID values. In this case, the UE could indicate to the network that the second UL resource(s)/resource configuration(s) with or having the one or more second UL resource/resource configuration IDs/ID values could be used/applied (by the UE) to transmit the measurement result(s) obtained according to the (early) triggered CSI-RS(s).
One or more indexes or index values denoted by q_1, . . . , q_x with each index or index value belonging to {1, . . . , Q_early} or {0, . . . , Q_early−1}, i.e., q_1, . . . , q_x∈{1, . . . , Q_early} or {0, . . . , Q_early−1}. In this case, the UE could indicate to the network that the q_1-th, . . . , q_x-th second UL resource(s)/resource configuration(s) among the configured/provided Q_early second UL resources/resource configurations (e.g., with their resource/resource configuration IDs/ID values ordered from low to high or from high to low) could be used/applied (by the UE) to transmit the measurement result(s) obtained according to the (early) triggered CSI-RS(s).
One or more PRACH preamble indexes. In this case, the higher layer parameter(s)/signaling(s) including SIB1, SIB2, RRCRelease-IEs as specified/defined herein could also provide or indicate or comprise Q_early>1 groups of PRACH preambles with each group corresponding/specific to a second UL resource/resource configuration according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , Q_early} or {0, . . . , Q_early−1}), the UE could indicate to the network (e.g., the network 130) that the x-th second UL resource/resource configuration among the configured/provided Q_early second UL resources/resource configurations (e.g., with their resource/resource configuration IDs/ID values ordered from low to high or from high to low) could be used/applied (by the UE) to transmit the measurement result(s) obtained according to the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the Q_early>1 subgroups of a PO such that each subgroup of the PO could be associated/corresponding/specific to a second UL resource/resource configuration according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , Q_early} or {0, . . . , Q_early−1}), the UE could indicate to the x-th second UL resource/resource configuration among the configured/provided Q_early second UL resources/resource configurations (e.g., with their resource/resource configuration IDs/ID values ordered from low to high or from high to low) could be used/applied (by the UE) to transmit the measurement result(s) obtained according to the (early) triggered CSI-RS(s).
Information related to the one or more second UL resources/resource configurations. The UE could determine or identify the association(s)/mapping(s) between the information and the one or more second UL resources/resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more second UL resources/resource configurations corresponding/associated/specific to the information could be used/applied (by the UE) to transmit the measurement result(s) obtained according to the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the Q_early second UL resource(s)/resource configuration(s), a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Q_early second UL resource(s)/resource configuration(s), a mapping between the one or more UE IDs and resources used for reception of the PDCCH providing the DCI format as mentioned herein, and the Q_early second UL resource(s)/resource configuration(s) and/or etc.

After the UE has transmitted or sent to the network, via/in/by the one or more second resource indication channels/signals, the one or more second resource indicators according to or following those specified herein in the present disclosure, the UE may expect to receive from the network, via/in/by one or more first response channels/signals, one or more first response indicators to the one or more second resource indicators. The UE could determine or identify the one or more first response channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the first response channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more first response indicators could be present or absent in their corresponding first response channel(s)/signal(s) according to network's configuration or indication (e.g., via RRC signaling(s)/configuration(s)). For instance, the UE could be provided or indicated or configured by the network a higher layer parameter/signaling denoted by earlyCSIRaResponse_PresentInDCI. In this case, when/if the higher layer parameter/signaling earlyCSIRaResponse_PresentInDCI is provided/configured and/or set to ‘enabled’ or ‘on’, the first response indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSIRaResponse_PresentInDCI is not provided/configured and/or set to ‘disabled’ or ‘off’, the first response indicator(s) as specified/defined herein in the present disclosure may not be present or could be absent in the corresponding DCI format(s) as specified/defined in Option-1 according to those specified herein in the present disclosure. The one or more first response channels/signals could be the same as or identical to the one or more second channels/signals in Mode-A; optionally, the one or more first response channels/signals could be different or separate from the one or more second channels/signals in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more first response channels/signals are the same as or identical to the one or more second channels/signals in Mode-A, the one or more first response indicators could be the same as or identical to the one or more second indicators in Mode-A; optionally, the one or more first response indicators could be different or separate from the one or more second indicators in Mode-A; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In particular, the one or more first response indicators could correspond to or comprise, or could be in form/terms of one or more of:
A message indicating ACK or NACK in response to the second resource indicator(s) transmitted/sent in the second resource indication channel(s)/signal(s) as specified/defined herein in the present disclosure; for instance, the message could be a one-bit indicator with ‘1’ (or ‘0’) indicating ACK in response to the second resource indicator(s) transmitted/sent in the second resource indication channel(s)/signal(s), and ‘0’ (or ‘1’) indicating NACK in response to the second resource indicator(s) transmitted/sent in the second resource indication channel(s)/signal(s)
UL resource(s) or resource allocation(s)/indication(s) as in (a-2) for the third channel(s)/signal(s) in Mode-A and/or the second channel(s)/signal(s) in Mode-C to carry or convey the measurement result(s) obtained according to the (early) triggered CSI-RS(s)

Furthermore, the UE could expect to receive from the network the first response indicator(s)—in/via/by the first response channel(s)/signal(s)—within a time offset/gap/window delta_T starting from the last (or first) symbol/slot of transmitting the second resource indicator(s)—in/via/by the second resource indication channel(s)/signal(s), wherein the time offset/gap/window delta_T could be in form/terms of number of slots, symbols, etc. The UE (e.g., the UE 116) could determine or identify the value(s) of the delta_T according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the delta_T could be indicated or provided by/in a DCI format.
For example, one or more new DCI fields in the DCI format could indicate or provide the value(s) of the delta_T.
For another example, one or more existing DCI fields in the DCI format could be repurposed to indicate or provide the value(s) of the delta_T.

The value(s) of the delta_T could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationResponseToCSIRi_PresentInDCI. In this case, when/if the higher layer parameter/signaling timeIndicationResponseToCSIRi_PresentInDCI is provided/configured and/or set to ‘enabled’ or ‘on’, the value(s) of the delta_T as specified/defined herein in the present disclosure could be present in the corresponding DCI format(s); otherwise, i.e., when/if the higher layer parameter/signaling timeIndicationResponseToCSIRi_PresentInDCI is not provided/configured and/or set to ‘disabled’ or ‘off’, the value(s) of the time offset/gap/window delta_T as specified/defined herein in the present disclosure may not be present or could be absent in the corresponding DCI format(s). In this case, when/if the UE does not from the network the first response indicator(s)—in/via/by the first response channel(s)/signal(s)—within the time offset/gap/window delta_T starting from the last (or first) symbol/slot of transmitting the second resource indicator(s)—in/via/by the second resource indication channel(s)/signal(s)—according to or following those specified herein in the present disclosure, the UE could (re-)transmit or (re-)send to the network, in the one or more second resource indication channels/signals, the one or more second resource indicators. When/if the UE has (re-)transmitted or (re-)sent the same second resource indicator(s)—via/by/in the second resource indication channel(s)/signal(s)—a number of times, denoted by maxNumReTxRi, within a time window/period, denoted by timeWindowMaxNumReTxRi, (b-1) the UE could stop or terminate sending or transmitting the second resource indicator(s) via/by/in the second resource indication channel(s)/signal(s), and/or (b-2) the UE could stop or terminate the process of (early) triggering of CSI measurement/reporting. The UE could determine or identify the value(s) of the maxNumReTxRi and/or timeWindowMaxNumReTxRi according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, the UE could indicate to the network, e.g., via/in various UL channels/signals including beam/CSI report and/or UE's capability signaling(s), information (e.g., one-bit flag indicator(s)) to indicate the occurrence(s) of (b-1) and/or (b-2) as specified/defined herein.

Furthermore, the second resource indicator(s) in the second resource allocation/indication channel(s)/signal(s) could indicate to the network: (y-1) CSI-RS resource(s) and the corresponding parameter(s)/setting(s) the UE could use/apply for receiving and measuring the (early) triggered CSI-RS(s), (y-2) the second UL resource(s)/resource configuration(s) including PUCCH(s)/PUSCH(s)—e.g., associated/linked/mapped to or provided in one or more CSI-RS resource configurations each provided by EarlyCSI-ReportConfig—the UE could use/apply for transmitting the measurement result(s) obtained according to the (early) triggered CSI-RS(s), or (y-3) both (y-1) and (y-2). The UE could determine or identify which of (y-1), (y-2) and/or (y-3) to follow for receiving/measuring the (early) triggered CSI-RS(s) and/or determining, transmitting/sending the measurement result(s) obtained according to the (early) triggered CSI-RS(s) according to or following those specified herein in the present disclosure based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For example, the UE could receive from the network, e.g., via/in/by the second channel(s)/signal(s) in Mode-A/B and/or the first resource indication/allocation channel(s)/signal(s), a one-bit flag indicator with ‘1’ (or ‘0’) indicating (y-1) (or (y-2) or (y-3)) and ‘0’ (or ‘1’) indicating (y-2) (or (y-1) or (y-3)). For another example, the UE could receive from the network, e.g., via/in/by the second channel(s)/signal(s) in Mode-A/B and/or the first resource indication/allocation channel(s)/signal(s), a two-bit flag indicator with ‘00’ (or ‘01’ or ‘10’ or ‘11’) indicating (y-1) (or (y-2) or (y-3)), ‘01’ (or ‘00’ or ‘10’ or ‘11’) indicating (y-2) (or (y-1) or (y-3)), and ‘01’ (or ‘00’ or ‘10’ or ‘11’) indicating (y-3) (or (y-1) or (y-2)).

For Mode-A and/or Mode-C, the UE could determine or identify or select which one or more of the configured/provided CSI-RS resource configurations (and therefore, the corresponding/linked/associated CSI resource set(s)/CSI-RS resource(s), e.g., provided/configured therein) for the early triggering of the CSI measurement/reporting as specified/defined herein in the present disclosure, which one or more of the configured/provided CSI resource sets (and therefore, the corresponding CSI-RS resource(s) provided/configured therein) for the early triggering of the CSI measurement/reporting as specified/defined herein in the present disclosure, and/or which one or more of the configured/provided CSI-RS resources for the early triggering of the CSI measurement/reporting as specified/defined herein in the present disclosure, to use/apply for determining or identifying the CSI-RS resource(s) and the corresponding parameter(s)/setting(s) to receive and measure the (early) triggered CSI-RS(s) and/or the corresponding second UL resource(s)/resource configuration(s) including PUCCH(s)/PUSCH(s)—e.g., associated/linked/mapped to or provided in the CSI-RS resource configuration(s) provided by EarlyCSI-ReportConfig—to transmit the measurement result(s) obtained according to the (early) triggered CSI-RS(s) according to or based on fixed mapping rule(s) in system specification(s) and/or per RRC (re-)configuration/setup.
In one example, when/if the higher layer parameter(s)/signaling(s) including SIB1, SIB2, RRCRelease-IEs as specified/defined herein provides or indicates or comprises multiple or more than one (K_early>1) CSI-RS resource configurations for the early triggering of the CSI measurement/reporting, wherein each of the CSI-RS resource configurations could be provided by EarlyCSI-ResourceConfig or EarlyCSI-ReportConfig, and could comprise or provide or include or configure, and/or could be linked/associated/specific to one or more CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource, the fixed mapping rule(s) could correspond to or could comprise a mapping between the one or more UE IDs and the K_early CSI-RS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early CSI-RS resource configurations, a mapping between the one or more UE IDs and resources used for reception of the PDCCH providing the DCI format as mentioned herein, and the K_early CSI-RS resource configurations and/or etc.
In another example, when/if the higher layer parameter(s)/signaling(s) including SIB1, SIB2, RRCRelease-IEs as specified/defined herein provides or indicates or comprises one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to multiple or more than one (L_early>1) CSI resource sets each provided by EarlyCSI-ResourceSet such as EarlyCSI-SSB-CSI-ResourceSet or EarlyNZP-CSI-RS-Resource Set and comprising, providing or configuring one or more CSI-RS resources each provided by EarlySSB-Index or EarlyNZP-CSI-RS-Resource, the fixed mapping rule(s) could correspond to or could comprise a mapping between the one or more UE IDs and the L_early CSI resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early CSI resource sets, a mapping between the one or more UE IDs and resources used for reception of the PDCCH providing the DCI format as mentioned herein, and the L_early CSI resource sets and/or etc.
In another example, when/if the higher layer parameter(s)/signaling(s) including SIB1, SIB2, RRCRelease-IEs as specified/defined herein provides or indicates or comprises one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to one (L_early=1) CSI resource set provided by EarlyCSI-ResourceSet such as EarlyCSI-SSB-CSI-ResourceSet or EarlyNZP-CSI-RS-ResourceSet and comprising, providing or configuring multiple or more than one (N_early>1) CSI-RS resources each provided by EarlySSB-Index or EarlyNZP-CSI-RS-Resource, the fixed mapping rule(s) could correspond to or could comprise a mapping between the one or more UE IDs and the N_early CSI-RS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Nearly CSI-RS resources, a mapping between the one or more UE IDs and resources used for reception of the PDCCH providing the DCI format as mentioned herein, and the Nearly CSI-RS resources, and/or etc.

As specified herein in the present disclosure, a UE could be first configured or provided or indicated by the network, e.g., via higher layer RRC signaling(s)/parameter(s) including SIB1, SIB2 and RRCRelease-IEs and/or MAC CE command(s) and/or dynamic DCI based L1 signaling(s)/parameter(s) based on or according to a corresponding UE's capability or capability signaling, one or more CSI-RS resource configurations (or one or more CSI resource sets or one or more CSI-RS resources) for the early triggering of the CSI measurement/reporting. The one or more CSI-RS resource configurations (or one or more CSI resource sets or one or more CSI-RS resources) could be (e.g., one-to-one or many-to-one) mapped/linked/associated to one or more first UL resources/resource configurations for the first channel(s)/signal(s) used to carry or convey the first indicator(s) as in Mode-A, Mode-B and/or Mode-C specified/described herein in the present disclosure. Here, the UE could determine or identify the mapping/linkage/association between the one or more first UL resources/resource configurations and the one or more CSI-RS resource configurations (or one or more CSI resource sets or one or more CSI-RS resources) according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, for Mode-A and/or Mode-C, when/if the UE transmits or sends to the network, in the first channel(s)/signal(s) via a first UL resource/resource configuration, the first indicator(s) to trigger the (early) CSI measurement and/or reporting, the UE could determine or identify, based on or according to the mapping(s)/linkage(s)/association(s) as specified/defined herein, the CSI-RS resource configuration(s) (or the CSI resource set(s) or the CSI-RS resource(s)) mapped/linked/associated to the first UL resource/resource configuration. When applicable, the UE could receive and measure the corresponding (early) triggered CSI-RS(s) according to the determined or identified CSI-RS resource configuration(s) (or the CSI resource set(s) or the CSI-RS resource(s)), and/or determine or identify (second) UL resource(s)/resource configuration(s) according to the determined/identified CSI-RS resource configuration(s) (or the CSI resource set(s) or the CSI-RS resource(s)) to transmit or send the measurement result(s) obtained according to the (early) triggered CSI-RS(s) as specified/defined herein in the present disclosure.

Furthermore, for Mode-A and/or Mode-C, the UE could determine or identify or select (second) UL resource(s)/resource configuration(s) as specified/defined herein in the present disclosure to use/apply to transmit the measurement result(s) obtained according to the (early) triggered CSI-RS(s) according to or based on fixed mapping rule(s) in system specification(s) and/or per RRC (re-)configuration/setup. For instance, when/if the higher layer parameter(s)/signaling(s) including SIB1, SIB2, RRCRelease-IEs as specified/defined herein provides or indicates or comprises one or more (Q_early≥1) second UL resource(s)/resource configuration(s) for the early triggering of the CSI measurement/reporting, the fixed mapping rule(s) could correspond to or could comprise a mapping between the one or more UE IDs and the Q_early second UL resource(s)/resource configuration(s), a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the Q_early second UL resource(s)/resource configuration(s), a mapping between the one or more UE IDs and resources used for reception of the PDCCH providing the DCI format as mentioned herein, and the Q_early second UL resource(s)/resource configuration(s) and/or etc.

As specified herein in the present disclosure, a UE could be first configured or provided or indicated by the network, e.g., via higher layer RRC signaling(s)/parameter(s) including SIB1, SIB2 and RRCRelease-IEs and/or MAC CE command(s) and/or dynamic DCI based L1 signaling(s)/parameter(s) based on or according to a corresponding UE's capability or capability signaling, one or more second UL resources or resource configurations for the early triggering of the CSI measurement/reporting, i.e., for transmitting the measurement result(s)—obtained according to the (early) triggered CSI-RS(s)—in the third channel(s)/signal(s)—as in Mode-A/B, or in the second channel(s)/signal(s)—as in Mode-C. The one or more second UL resources/resource configurations could be (e.g., one-to-one or many-to-one) mapped/linked/associated to one or more first UL resources/resource configurations for the first channel(s)/signal(s) used to carry or convey the first indicator(s) as in Mode-A, Mode-B and/or Mode-C specified/described herein in the present disclosure. Here, the UE could determine or identify the mapping/linkage/association between the one or more first UL resources/resource configurations and the one or more second UL resources/resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, for Mode-A and/or Mode-C, when/if the UE transmits or sends to the network, in the first channel(s)/signal(s) via a first UL resource/resource configuration, the first indicator(s) to trigger the (early) CSI measurement and/or reporting, the UE could determine or identify, based on or according to the mapping(s)/linkage(s)/association(s) as specified/defined herein, a second UL resource/resource configuration mapped/linked/associated to the first UL resource/resource configuration. When applicable, the UE could send or transmit to the network, in the third channel(s)/signal(s) for Mode-A and/or second channel(s)/signal(s) for Mode-C via the determined/identified second UL resource/resource configuration, the measurement result(s) obtained according to the (early) triggered CSI-RS(s) as specified/defined herein in the present disclosure.

As specified/defined herein in the present disclosure, for Mode-C, the UE could transmit or send or indicate to the network (e.g., the network 130), in/by/via the second channel(s)/signal(s), the measurement result(s) according to or based on one or more of the followings.
In one example, the UE could transmit or send or indicate to the network the second channel(s)/signal(s) carrying or conveying the measurement result(s) using or via a/the most recent in time and/or available UL resource(s) a minimum time T_3 from the end (or start) of the first triggering channel(s)/signal(s).
In another example, the symbol or slot or subframe or frame used by a UE to transmit the CSI/beam measurement result(s) could be a/the most recent in time and/or available UL resource(s) at or after a time T_3 from the end (or start) of the first triggering channel(s)/signal(s).
In another example, the symbol or slot or subframe or frame used by a UE to transmit the measurement result(s) obtained according to the (early) triggered CSI-RS(s) could be that first symbol or slot or subframe or frame that starts at or after a time T_3 from the end (or start) of the first triggering channel(s)/signal(s) and optionally based on a time offset/gap.

The time T_3 and/or the time offset/gap could be in number of symbol(s), slot(s), subframe(s), frame(s) and/or etc. Furthermore, the UE could determine or identify the value(s) of the time T_3 and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_3 and/or the time offset/gap could be indicated or provided by/in a DCI format.
For example, one or more new DCI fields in the DCI format could indicate or provide the value(s) of the time T_3 and/or the time offset/gap.
For another example, one or more existing DCI fields in the DCI format could be repurposed to indicate or provide the value(s) of the time T_3 and/or the time offset/gap.

The value(s) of the time T_3 and/or the time offset/gap could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationCSI_PresentInDCI. In this case, when/if the higher layer parameter/signaling timeIndicationCSI_PresentInDCI is provided/configured and/or set to ‘enabled’ or ‘on’, the value(s) of the time T_3 and/or the time offset/gap as specified/defined herein in the present disclosure could be present in the corresponding DCI format(s); otherwise, i.e., when/if the higher layer parameter/signaling timeIndicationCSI_PresentInDCI is not provided/configured and/or set to ‘disabled’ or ‘off’, the value(s) of the time T_3 and/or the time offset/gap as specified/defined herein in the present disclosure may not be present or could be absent in the corresponding DCI format(s).

Optionally, for Mode-A, the UE could transmit or send or indicate to the network, in/by/via the third channel(s)/signal(s), the measurement result(s) according to or based on one or more of the followings.
In one example, the UE could transmit or send or indicate to the network the third channel(s)/signal(s) carrying or conveying the measurement result(s) obtained according to the (early) triggered CSI-RS(s) using or via a/the most recent in time and/or available UL resource(s) a minimum time T_3′ from the end (or start) of the first triggering channel(s)/signal(s).
In another example, the symbol or slot or subframe or frame used by a UE to transmit the measurement result(s) obtained according to the (early) triggered CSI-RS(s) could be a/the most recent in time and/or available UL resource(s) at or after a time T_3′ from the end (or start) of the first triggering channel(s)/signal(s).
In another example, the symbol or slot or subframe or frame used by a UE to transmit the measurement result(s) obtained according to the (early) triggered CSI-RS(s) could be that first symbol or slot or subframe or frame that starts at or after a time T_3′ from the end (or start) of the first triggering channel(s)/signal(s) and optionally based on a time offset/gap.
In another example, the UE could transmit or send or indicate to the network the third channel(s)/signal(s) carrying or conveying the measurement result(s) obtained according to the (early) triggered CSI-RS(s) using or via a/the most recent in time and/or available UL resource(s) a minimum time T_3′ from the end (or start) of the second triggering channel(s)/signal(s). For instance, for Option-1, the second triggering channel(s)/signal(s) as mentioned herein could correspond to a PDCCH reception providing the DCI format(s) triggering the CSI measurement and/or reporting.
In another example, the symbol or slot or subframe or frame used by a UE to transmit the measurement result(s) obtained according to the (early) triggered CSI-RS(s) could be a/the most recent in time and/or available UL resource(s) at or after a time T_3′ from the end (or start) of the second triggering channel(s)/signal(s). For instance, for Option-1, the second triggering channel(s)/signal(s) as mentioned herein could correspond to a PDCCH reception providing the DCI format(s) triggering the CSI measurement/reporting.
In another example, the symbol or slot or subframe or frame used by a UE to transmit the measurement result(s) obtained according to the (early) triggered CSI-RS(s) could be that first symbol or slot or subframe or frame that starts at or after a time T_3′ from the end (or start) of the second triggering channel(s)/signal(s) and optionally based on a time offset/gap. For instance, for Option-1, the second triggering channel(s)/signal(s) as mentioned herein could correspond to a PDCCH reception providing the DCI format(s) triggering the CSI measurement and/or reporting.

The time T_3′ and/or the time offset/gap could be in number of symbol(s), slot(s), subframe(s), frame(s) and/or etc. Furthermore, the UE could determine or identify the value(s) of the time T_3′ and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T_3′ and/or the time offset/gap could be indicated or provided by/in a DCI format.
For example, one or more new DCI fields in the DCI format could indicate or provide the value(s) of the time T_3′ and/or the time offset/gap.
For another example, one or more existing DCI fields in the DCI format could be repurposed to indicate or provide the value(s) of the time T_3′ and/or the time offset/gap.

The value(s) of the time T_3′ and/or the time offset/gap could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationCSI_PresentInDCI. In this case, when/if the higher layer parameter/signaling timeIndicationCSI_PresentInDCI is provided/configured and/or set to ‘enabled’ or ‘on’, the value(s) of the time T_3′ and/or the time offset/gap as specified/defined herein in the present disclosure could be present in the corresponding DCI format(s); otherwise, i.e., when/if the higher layer parameter/signaling timeIndicationCSI_PresentInDCI is not provided/configured and/or set to ‘disabled’ or ‘off’, the value(s) of the time T_3′ and/or the time offset/gap as specified/defined herein in the present disclosure may not be present or could be absent in the corresponding DCI format(s).

The UE (e.g., the UE 116) could indicate or send or transmit to the network, e.g., in their corresponding capability signaling(s), whether they are capable of supporting (a-1), (a-2) and/or (a-3) as specified/defined herein in the present disclosure to determine or identify UL resource(s) or resource allocation(s) for transmitting or sending the CSI/beam measurement result(s) obtained according to the (early) triggered CSI-RS(s). For instance, the corresponding capability signaling(s) could comprise one or more and/or a combination of one or more of the following components, wherein Component-I, Component-II or Component-III could be basic UE's capability/feature:
Component-I: support of (a-1) as specified/defined herein in the present disclosure to determine or identify UL resource(s) or resource allocation(s) for transmitting or sending the measurement result(s) obtained according to the (early) triggered CSI-RS(s)
Component-IL: support of (a-2) as specified/defined herein in the present disclosure to determine or identify UL resource(s) or resource allocation(s) for transmitting or sending the measurement result(s) obtained according to the (early) triggered CSI-RS(s)
Component-III: support of (a-3) as specified/defined herein in the present disclosure to determine or identify UL resource(s) or resource allocation(s) for transmitting or sending the measurement result(s) obtained according to the (early) triggered CSI-RS(s)

In this case, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of (a-1), (a-2) and (a-3) as specified/described herein is enabled for the UE to determine or identify UL resource(s) or resource allocation(s) for transmitting or sending the CSI/beam measurement result(s) obtained according to the (early) triggered CSI-RS(s). For instance, when/if a UE is provided by a higher layer parameter enablePreConfigurationforEarlyCSI and/or set to ‘enabled’, the UE could follow those specified/defined in (a-1) in the present disclosure to determine or identify UL resource(s) or resource allocation(s) for transmitting or sending the measurement result(s) obtained according to the (early) triggered CSI-RS(s). When/if a UE is provided by a higher layer parameter enableNwIndicationforEarlyCSI and/or set to ‘enabled’, the UE could follow those specified/defined in (a-2) in the present disclosure to determine or identify UL resource(s) or resource allocation(s) for transmitting or sending the measurement result(s) obtained according to the (early) triggered CSI-RS(s). When/if a UE is provided by a higher layer parameter enableUeIndicationforEarlyCSI and/or set to ‘enabled’, the UE could follow those specified/defined in (a-3) in the present disclosure to determine or identify UL resource(s) or resource allocation(s) for transmitting or sending the measurement result(s) obtained according to the (early) triggered CSI-RS(s).

The UE could indicate or send or transmit to the network, e.g., in their corresponding capability signaling(s), whether they are capable of supporting (a-1), (a-2) and/or (a-3) as specified/defined herein in the present disclosure to determine or identify CSI-RS resource(s) for receiving and measuring the corresponding (early) triggered CSI-RS(s). For instance, the corresponding capability signaling(s) could comprise one or more and/or a combination of one or more of the following components, wherein Component-i, Component-ii or Component-iii could be basic UE's capability/feature:
Component-i: support of (a-1) as specified/defined herein in the present disclosure to determine or identify CSI-RS resource(s) for receiving and measuring the corresponding (early) triggered CSI-RS(s)
Component-ii: support of (a-2) as specified/defined herein in the present disclosure to determine or identify CSI-RS resource(s) for receiving and measuring the corresponding (early) triggered CSI-RS(s)
Component-III: support of (a-3) as specified/defined herein in the present disclosure to determine or identify CSI-RS resource(s) for receiving and measuring the corresponding (early) triggered CSI-RS(s)

In this case, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of or which combination(s) of (a-1), (a-2) and (a-3) as specified/described herein is enabled for the UE to determine or identify CSI-RS resource(s) for receiving and measuring the corresponding (early) triggered CSI-RS(s). For instance, when/if a UE is provided by a higher layer parameter enablePreConfigurationforEarlyCSIm and/or set to ‘enabled’, the UE could follow those specified/defined in (a-1) in the present disclosure to determine or identify CSI-RS resource(s) for receiving and measuring the corresponding (early) triggered CSI-RS(s). When/if a UE is provided by a higher layer parameter enableNwIndicationforEarlyCSIm and/or set to ‘enabled’, the UE could follow those specified/defined in (a-2) in the present disclosure to determine or identify CSI-RS resource(s) for receiving and measuring the corresponding (early) triggered CSI-RS(s). When/if a UE is provided by a higher layer parameter enableUeIndicationforEarlyCSIm and/or set to ‘enabled’, the UE could follow those specified/defined in (a-3) in the present disclosure to determine or identify CSI-RS resource(s) for receiving and measuring the corresponding (early) triggered CSI-RS(s).

After the UE has transmitted or sent to the network, via/in/by the one or more third channels/signals in Mode-A/B and/or the one or more second channels/signals in Mode-C, the measurement result(s) obtained according to the (early) triggered CSI-RS(s) according to or following those specified herein in the present disclosure, the UE may expect to receive from the network, via/in/by one or more second response channels/signals, one or more second response indicators to the measurement result(s) obtained according to the (early) triggered CSI-RS(s). The UE could determine or identify the one or more second response channels/signals based on or according to one or more of Option-1, Option-2, Option-3 and Option-4 as specified/defined herein in the present disclosure for Mode-A. The UE could determine or identify which one or more of the Option-1, Option-2, Option-3 and Option-4 to use or follow or apply to determine or identify the second response channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more second response indicators could be present or absent in their corresponding second response channel(s)/signal(s) according to network's configuration or indication (e.g., via RRC signaling(s)/configuration(s)). For instance, the UE could be provided or indicated or configured by the network a higher layer parameter/signaling denoted by earlyCSIResponse_PresentInDCI. In this case, when/if the higher layer parameter/signaling earlyCSIResponse_PresentInDCI is provided/configured and/or set to ‘enabled’ or ‘on’, the second response indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSIResponse_PresentInDCI is not provided/configured and/or set to ‘disabled’ or ‘off’, the second response indicator(s) as specified/defined herein in the present disclosure may not be present or could be absent in the corresponding DCI format(s) as specified/defined in Option-1 according to those specified herein in the present disclosure. The one or more second response channels/signals could be the same as or identical to the one or more second channels/signals in Mode-A; optionally, the one or more second response channels/signals could be different or separate from the one or more second channels/signals in Mode-A/B; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, when/if the one or more second response channels/signals are the same as or identical to the one or more second channels/signals in Mode-A/B, the one or more second response indicators could be the same as or identical to the one or more second indicators in Mode-A/B; optionally, the one or more second response indicators could be different or separate from the one or more second indicators in Mode-A/B; the herein could be based on or according to: (i) fixed rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). In particular, the one or more second response indicators could correspond to or comprise, or could be in form/terms of one or more of:
A message indicating ACK or NACK in response to the measurement result(s)—obtained according to the (early) triggered CSI-RS(s)—transmitted/sent in the third channel(s)/signal(s) for Mode-A/B or the second channel(s)/signal(s) for Mode-C as specified/defined herein in the present disclosure; for instance, the message could be a one-bit indicator with ‘1’ (or ‘0’) indicating ACK in response to the measurement result(s)—obtained according to the (early) triggered CSI-RS(s)—transmitted/sent in the third channel(s)/signal(s) for Mode-A/B or the second channel(s)/signal(s) for Mode-C, and ‘0’ (or ‘1’) indicating NACK in response to the measurement result(s)—obtained according to the (early) triggered CSI-RS(s)—transmitted/sent in the third channel(s)/signal(s) for Mode-A/B or the second channel(s)/signal(s) for Mode-C
UL resource(s) or resource allocation(s)/indication(s) as in (a-2) for the third channel(s)/signal(s) in Mode-A and/or the second channel(s)/signal(s) in Mode-C to carry or convey the measurement result(s) obtained according to the (early) triggered CSI-RS(s)

Furthermore, the UE could expect to receive from the network the second response indicator(s)—in/via/by the second response channel(s)/signal(s)—within a time offset/gap/window delta_T′ starting from the last (or first) symbol/slot of transmitting the measurement result(s) obtained according to the (early) triggered CSI-RS(s)—in/via/by the third channel(s)/signal(s) for Mode-A/B or the second channel(s)/signal(s) for Mode-C, wherein the time offset/gap/window delta_T′ could be in form/terms of number of slots, symbols, etc. The UE could determine or identify the value(s) of the delta_T′ according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the delta_T′ could be indicated or provided by/in a DCI format.
For example, one or more new DCI fields in the DCI format could indicate or provide the value(s) of the delta_T′.
For another example, one or more existing DCI fields in the DCI format could be repurposed to indicate or provide the value(s) of the delta_T′.

The value(s) of the delta_T′ could be present or absent in their corresponding DCI format(s) according to network's configuration or indication (e.g., via RRC signaling(s)/configuration(s)). For instance, the UE could be provided or indicated or configured by the network a higher layer parameter/signaling denoted by timeIndicationResponseToCSI_PresentInDCI. In this case, when/if the higher layer parameter/signaling timeIndicationResponseToCSI_PresentInDCI is provided/configured and/or set to ‘enabled’ or ‘on’, the value(s) of the delta_T′ as specified/defined herein in the present disclosure could be present in the corresponding DCI format(s); otherwise, i.e., when/if the higher layer parameter/signaling timeIndicationResponseToCSI_PresentInDCI is not provided/configured and/or set to ‘disabled’ or ‘off’, the value(s) of the time offset/gap/window delta_T′ as specified/defined herein in the present disclosure may not be present or could be absent in the corresponding DCI format(s). In this case, when/if the UE does not from the network the second response indicator(s)—in/via/by the second response channel(s)/signal(s)—within the time offset/gap/window delta_T′ starting from the last (or first) symbol/slot of transmitting the CSI/beam measurement result(s)—in/via/by the third channel(s)/signal(s) for Mode-A/B or the second channel(s)/signal(s) for Mode-C—according to or following those specified herein in the present disclosure, the UE could (re-)transmit or (re-)send to the network, in/via/by the third channel(s)/signal(s) for Mode-A/B or the second channel(s)/signal(s) for Mode-C, the beam/CSI measurement result(s) as specified/defined herein in the present disclosure. When/if the UE has (re-)transmitted or (re-)sent the same beam/CSI measurement result(s)—in/via/by the third channel(s)/signal(s) for Mode-A/B or the second channel(s)/signal(s) for Mode-C—a number of times, denoted by maxNumReTx, within a time window/period, denoted by timeWindowMaxNumReTx, (c-1) the UE could stop or terminate the process of early triggering of CSI measurement and/or reporting. The UE could determine or identify the value(s) of the maxNumReTx and/or timeWindowMaxNumReTx according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). Furthermore, the UE could indicate to the network, e.g., via/in various UL channels/signals including beam/CSI report and/or UE's capability signaling(s), information (e.g., one-bit flag indicator(s)) to indicate the occurrence(s) of (c-1) as specified/defined herein.

Throughout the present disclosure, a CSI reporting configuration is equivalent to a CSI reporting setting, and a CSI resource configuration is equivalent to a CSI resource setting; furthermore, a CSI-RS resource configuration is equivalent to or could correspond to a CSI reporting configuration/setting provided by EarlyCSI-ReportConfig, or a CSI resource configuration/setting provided by EarlyCSI-ResrouceConfig as specified/defined herein in the present disclosure. Furthermore, the design examples/procedures and the corresponding signalling methods, UE behaviours/assumptions and/or etc. specified/defined herein in the present disclosure for a given carrier or component carrier (CC) or a cell could be extended/applied to multiple carriers/CCs/cells when/if a multi-carrier or multi-CC or multi-cell system or setting is configured or enabled. Furthermore, as specified/defined herein in the present disclosure, the measurement result(s) could correspond to one or more beam/CSI reports each comprising one or more report quantities including SSBRI(s)/CRI(s), L1-RSRP(s)/L1-SINR(s), CQI(s), RI(s), PMI(s) and/or etc. based on or according to network's configuration(s)/indication(s).

FIG. 17 illustrates an example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving, in a SIB, a first UL channel resource configuration and a CSI report configuration for early CSI acquisition (1710). The UE then determines a first UL channel resource associated with the CSI report configuration from the first UL channel resource configuration (1720).

The UE then transmits a first indicator in a first UL channel based on the first UL channel resource (1730). In various embodiments, the first UL channel corresponds to a PUCCH, and the first indicator is a one-bit UCI indicator. In various embodiments, the first UL channel corresponds to a PRACH, and the first indicator is a PRACH preamble of Msg1 for a random access procedure. The UE then receives a second indicator indicating the CSI report configuration in a first DL channel (1740). In various embodiments, the first DL channel corresponds to a PDCCH, and the second indicator corresponds to a codepoint of a CSI request field in a DCI. In various embodiments, the first DL channel corresponds to a PDSCH, and the second indicator corresponds to a RAR of Msg2 for a random access procedure.

The UE then determines a second UL channel resource based on the CSI report configuration (1750). In various embodiments, the second UL channel corresponds to a PUSCH, and reception of the second indicator is within a configured time interval starting from transmission of the first indicator. The UE then transmits a CSI report in a second UL channel based on the second UL channel resource (1760). In various embodiments, the SIB provides a PUSCH resource configuration, the UE determines, from the PUSCH resource configuration, a PUSCH resource associated with the second UL channel resource, and the CSI report is transmitted based on the PUSCH resource.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive, in a system information block (SIB), a first uplink (UL) channel resource configuration and a channel state information (CSI) report configuration for early CSI acquisition; and
a processor operably coupled with the transceiver, the processor configured to determine, from the first UL channel resource configuration, a first UL channel resource associated with the CSI report configuration,
wherein the transceiver is further configured to:
transmit, in a first UL channel based on the first UL channel resource, a first indicator; and
receive, in a first downlink (DL) channel, a second indicator indicating the CSI report configuration,
wherein the processor is further configured to determine a second UL channel resource based on the CSI report configuration, and
wherein the transceiver is further configured to transmit, in a second UL channel based on the second UL channel resource, a CSI report.

2. The UE of claim 1, wherein:
the first UL channel corresponds to a physical uplink control channel (PUCCH); and
the first indicator is a one-bit uplink control information (UCI) indicator.

3. The UE of claim 1, wherein:
the first DL channel corresponds to a physical downlink control channel (PDCCH); and
the second indicator corresponds to a codepoint of a CSI request field in a downlink control information (DCI).

4. The UE of claim 1, wherein:
the first UL channel corresponds to a physical random access channel (PRACH); and
the first indicator is a PRACH preamble of Message 1 (Msg1) for a random access procedure.

5. The UE of claim 1, wherein:
the first DL channel corresponds to a physical downlink shared channel (PDSCH); and
the second indicator corresponds to a random access response (RAR) of Message 2 (Msg2) for a random access procedure.

6. The UE of claim 1, wherein:
the second UL channel corresponds to a physical uplink shared channel (PUSCH); and
reception of the second indicator is within a configured time interval starting from transmission of the first indicator.

7. The UE of claim 1, wherein:
the SIB provides a physical uplink shared channel (PUSCH) resource configuration;
the processor is further configured to determine, from the PUSCH resource configuration, a PUSCH resource associated with the second UL channel resource; and
the CSI report is transmitted based on the PUSCH resource.

8. A base station (BS), comprising:
a transceiver configured to transmit, in a system information block (SIB), a first uplink (UL) channel resource configuration and a channel state information (CSI) report configuration for early CSI acquisition; and
a processor operably coupled with the transceiver, the processor configured to determine, based on the first UL channel resource configuration, a first UL channel resource associated with the CSI report configuration,
wherein the transceiver is further configured to:
receive, in a first UL channel based on the first UL channel resource, a first indicator; and
transmit, in a first downlink (DL) channel, a second indicator indicating the CSI report configuration,
wherein the processor is further configured to determine a second UL channel resource based on the CSI report configuration, and
wherein the transceiver is further configured to receive, in a second UL channel based on the second UL channel resource, a CSI report.

9. The BS of claim 8, wherein:
the first UL channel corresponds to a physical uplink control channel (PUCCH); and
the first indicator is a one-bit uplink control information (UCI) indicator.

10. The BS of claim 8, wherein:
the first DL channel corresponds to a physical downlink control channel (PDCCH); and
the second indicator corresponds to a codepoint of a CSI request field in a downlink control information (DCI).

11. The BS of claim 8, wherein:
the first UL channel corresponds to a physical random access channel (PRACH); and
the first indicator is a PRACH preamble of Message 1 (Msg1) for a random access procedure.

12. The BS of claim 8, wherein:
the first DL channel corresponds to a physical downlink shared channel (PDSCH); and
the second indicator corresponds to a random access response (RAR) of Message 2 (Msg2) for a random access procedure.

13. The BS of claim 8, wherein:
the second UL channel corresponds to a physical uplink shared channel (PUSCH); and
transmission of the second indicator is within a configured time interval starting from reception of the first indicator.

14. The BS of claim 8, wherein:
the SIB provides a physical uplink shared channel (PUSCH) resource configuration;
the processor is further configured to determine, from the PUSCH resource configuration, a PUSCH resource associated with the second UL channel resource; and
the CSI report is received based on the PUSCH resource.

15. A method performed by a user equipment (UE), the method comprising:
receiving, in a system information block (SIB), a first uplink (UL) channel resource configuration and a channel state information (CSI) report configuration for early CSI acquisition;
determining, from the first UL channel resource configuration, a first UL channel resource associated with the CSI report configuration;
transmitting, in a first UL channel based on the first UL channel resource, a first indicator;
receiving, in a first downlink (DL) channel, a second indicator indicating the CSI report configuration;
determining a second UL channel resource based on the CSI report configuration; and
transmitting, in a second UL channel based on the second UL channel resource, a CSI report.

16. The method of claim 15, wherein:
the first UL channel corresponds to a physical uplink control channel (PUCCH); and
the first indicator is a one-bit uplink control information (UCI) indicator.

17. The method of claim 15, wherein:
the first DL channel corresponds to a physical downlink control channel (PDCCH); and
the second indicator corresponds to a codepoint of a CSI request field in a downlink control information (DCI).

18. The method of claim 15, wherein:
the first UL channel corresponds to a physical random access channel (PRACH); and
the first indicator is a PRACH preamble of Message 1 (Msg1) for a random access procedure.

19. The method of claim 15, wherein:
the first DL channel corresponds to a physical downlink shared channel (PDSCH); and
the second indicator corresponds to a random access response (RAR) of Message 2 (Msg2) for a random access procedure.

20. The method of claim 15, wherein:
the second UL channel corresponds to a physical uplink shared channel (PUSCH); and
reception of the second indicator is within a configured time interval starting from transmission of the first indicator.
